(19) United States
(12) Patent Application Publication
(10) Pub. No.: US 2012/0178641 A1
(43) Pub. Date: Jul. 12, 2012

(54) GLOBAL MAPPING OF PROTEIN-DNA INTERACTION BY DIGITAL GENOMIC FOOTPRINTING

(76) Inventor: John A. Stamatoyannopoulos, Seattle, WA (US)

(21) Appl. No.: 13/257,954

(22) PCT Filed: Mar. 19, 2010
(86) PCT No.: PCT/US2010/028049

§ 371 Date: Mar. 20, 2012

Related U.S. Application Data
(60) Provisional application No. 61/162,205, filed on Mar. 20, 2009.

(51) Int. Cl. C40B 30/04; C40B 40/06

(52) U.S. Cl. 506/9; 506/16

(57) ABSTRACT

The present invention provides a method for globally mapping a genome for its protein-binding pattern. A computer system useful for this purpose is also described.

### CROSS-REFERENCES TO RELATED APPLICATIONS

This application claims benefit of U.S. Provisional Application Ser. No. 61/162,205 filed on Mar. 20, 2009, the disclosure of which is incorporated herein by reference in its entirety.

### STATEMENT AS TO RIGHTS TO INVENTIONS MADE UNDER FEDERALLY SPONSORED RESEARCH AND DEVELOPMENT

This work was supported in part by the National Institutes of Health grants R01GM071923 and U54HG00459 and the Government has certain rights to this invention.

### BACKGROUND OF THE INVENTION

The binding of transcriptional regulators to specific sites on DNA provides the fundamental mechanism for actuating genomic programs of gene expression, DNA replication, environmental response and other basic cellular processes. Delineation of the complete set of genomic sites bound in vivo by these proteins is therefore essential for an understanding of genome function. The discovery more than 35 years ago that regulatory proteins protect their underlying DNA sequences from nuclease attack^{1,2} has been widely exploited to define cis-regulatory elements in diverse organisms. Although conceptually simple, classical DNase I ‘footprinting’³, which reveals a DNA sequence protected from nuclease cleavage relative to flanking exposed nucleotides, is laborious in practice and particularly challenging to apply systematically to the study of in vivo protein binding in the context of native chromatin. Current genomic approaches for localizing sites of regulatory factor-DNA interaction in vivo such as chromatin immunoprecipitation coupled to DNA microarrays⁴ or to high-throughput DNA sequencing^{5,6}, while more readily executed on a large scale, require both prior knowledge of binding factors and factor-specific reagents, yet do not provide nucleotide-level resolution.

Regulatory factor binding to DNA in place of canonical nucleosomes results in markedly increased accessibility of the DNA template both immediately surrounding the factor binding regions, and over neighboring chromatin. This accessibility is manifest as DNase I hypersensitive sites in chromatin, which comprise a structural signature of the regulatory regions of eukaryotic genes from yeast to humans⁷. Within hypersensitive sites, cleavages accumulate at nucleotides that are not protected by protein binding. The present inventor therefore reasoned that these binding sites could be detected systematically provided sufficiently dense local sampling of DNase I cleavage sites. This application presents an analysis of binding sites on yeast DNA based on over 23 million DNA sequence reads mapped back to the genome.

The present inventor coupled DNase I digestion of intact nuclei with massively parallel sequencing and computational analysis of nucleotide-level patterns to disclose the in vivo occupancy sites of DNA-binding proteins genome-wide. The resulting maps provide gene-by-gene views of transcription factor binding and related cis-regulatory phenomena at the resolution of individual factor binding sites. This level of detail is sufficient to define regulatory factor binding motifs de novo, and to correlate factor occupancy patterns with higher-level features such as chromatin remodeling, gene expression, and chromatin modifications.

### BRIEF SUMMARY OF THE INVENTION

In the first aspect, the present invention provides a method for determining protein-binding pattern of a genomic DNA of known or unknown sequence. The method comprises the following steps: (1) digesting the genomic DNA in the presence of its binding proteins with a DNA-cleaving agent to generate a plurality of DNA fragments; (2) determining the nucleotide sequence of at least some of the plurality of DNA fragments, the nucleotides at the ends of the DNA fragments indicating the DNA cleavage sites in the genomic DNA; and (3) determining the frequency of DNA cleavage throughout the length of the genomic DNA sequence, a segment of the genomic DNA sequence having lower than average frequency indicating a protein-binding site, thereby determining protein-binding pattern of the genomic DNA. Typically, the cleavage fragments are sequenced at random from all fragments but constitute a substantial percentage of all fragments. Often, the protein-binding sites are determined as a segment of the genomic DNA sequence not only having lower than average frequency but also having higher than average frequency in segment's immediate flanking regions.

The method of this invention can be performed in vivo, e.g., digesting the genomic DNA in vivo as the DNA remains in the nucleus of a cell. In some cases, such as in the case of a prokaryotic cell, the digestion step can be performed when the entire cell is permeated with the DNA-cleaving agent. In some embodiments, the genome is a partial genome or whole genome or chromosome. In some further embodiments, the partial genome is analyzed by array capture or solution hybridization. In some embodiments, the partial genome to be digested for digital genomic footprinting is at least 1, 10, 100, 1000, 10000, 100,000 kilobases in length. In other embodiments, the digital genomic footprints throughout a genomic DNA of at least those lengths is provided. In some further embodiments of the above, the genome is haploid or diploid.

In some embodiments of the claimed method, the plurality of DNA fragments are no more than 500 nucleotides in length, e.g., no more than 300 nucleotides in length, 200 nucleotides in length or 100 nucleotides in length. In other embodiments, the segment of the genomic DNA is 50 nucleotides in length. As examples, the plurality of DNA fragments may comprise at least 10⁷ fragments, and the nucleotide sequence of at least 10⁶ fragments is determined in step (2). In yet other embodiments, the fragments are predominantly from 25 to 500 nucleotides in length, 25 to 100 nucleotides in length, 40 to 400 nucleotides in length, or from 50 to 500 nucleotides in length.

The number of base pairs/fragment to be sequenced depends in part on the size of the genome. At minimum, about 10, 20, 30, or 40 base pairs may need to be sequenced. For instance, a larger genome, such as the human, may require at least 20, 25 base pair, or more preferably at least 27 or still more preferably at least 36 base pairs to be sequenced (e.g., 27 to 40 basepairs).

In a second aspect, the present invention provides a computer program product comprising a computer readable medium encoded with a plurality of instructions for controlling a computing system to perform an operation for determining protein-binding pattern of a genomic DNA of known sequence, the operation comprising the steps of: receiving data from sequencing reactions a plurality of DNA fragments generated from DNase digestion of the genomic DNA in the presence of its binding proteins, wherein the data comprise the identity of all nucleotides in at least some of the plurality of DNA fragments; locating the first and last nucleotide of each DNA fragment sequenced in the genomic DNA sequence; and calculating the frequency of the first or last nucleotide appearing in consecutive segments of the genomic DNA sequence, thereby deriving a map of protein-binding for the genomic DNA.

In a third aspect, this invention provides a DNA microarray comprising a plurality of DNA sequences immobilized on a solid support, and each of plurality of DNA sequences comprises the nucleotide sequence of a unique protein-binding site in a genomic DNA as determined by the method described above.

In a fourth aspect, the invention provides a method determining the cis regulatory lexicon of an organism, tissue, and/or disease state and also of conducting comparative studies of the cis-regulatory lexicon profiles and foot print nucleic acid sequences for different traits, treatments, factor, individuals, species, tissues, and/or disease states. In some embodiments, the annotated footprints of genotype are provided by determining the cis-regulatory lexicons of subjects according to the methods of the invention and identifying differences in their lexicons which are associated with a factor of interest (e.g., species of origin, tissue of origin, associated disease state, experimental or control treatment, health state, age, diet, and the like). In some embodiments, the invention provides methods of identifying genomic polymorphisms (e.g., single nucleotide polymorphisms, deletions, insertions, substitutions of nucleic acids) of a regulatory footprint and associating them with changes in the binding or functionality of a regulatory factor which binds the footprint and in levels of gene expression. In some such embodiments, the invention identifies regulatory factors associated with a particular footprint and or gene. In some embodiments, the identified differences can then be used in turn in diagnosis or in determining whether a sample belongs to a particular trait, treatments, factor, individuals, species, tissues, and/or disease states.

In some embodiments, accordingly, the invention provides a method of quantifying regulatory factor occupancy by performing a digital genomic footprinting (DGF) and mapping the cleavage counts to the genome of a subject or cell of interest. Optionally, the hotspot regions can be identified. In some further embodiments, a regulatory factor with a known motif or for any given motif regardless of whether the cognate regulatory factor is known, the footprint discovery statistic is computed over all instances of a regulatory factor motif within DNaseI hotspots and the motif instances are ranked by footprint discovery statistic (low→high=high affinity→low affinity) as a shown in FIG. 18.

In some other embodiments, the invention provides a method of determining the genomic protein:DNA contacts for a protein by performing a digital genomic footprinting according to the invention, optionally, identifying the hotspot regions, and computing the mean per nucleotide cleavage over all instances of the cognate sequence motif of that protein. The degree of nucleotide protection provides a quantitative measure of protein:DNA contact for each nucleotide within the contact region (see, for instance, FIG. 3).

In yet other embodiments, the invention provides a method of producing a regulatory factor signature by performing a digital genomic footprint according to the invention, optionally identifying the hotspot regions, and for any given regulatory factor with a known motif (or for any given motif regardless of whether the cognate regulatory factor is known), computing the mean per nucleotide cleavage over a representative number, or randomly selected number, or all instances of the cognate sequence motif of that protein. Preferably, the computing begins upstream (5, 10, or even 25 bp) of the first nucleotide of the motif-matching sequence, and continues downstream of the motif for the same distance. In some further embodiments, the invention provides a database or library of regulatory signatures which can be obtained by the method and further provides methods of using the database to identify a specific regulatory factor by comparing its signature to known signatures. FIG. 19 illustrates the regulatory signature factor observed for 5 known regulatory factors and three as yet unidentified factors.

In still more embodiments, the invention provides a method of identifying the structural class of a regulatory factor by comparing its signature to one or more archetypes for known structural classes.

In yet other embodiments, the invention provides a method of determining the regulatory factors that regulate a gene by performing a DGF according to the invention and analyzing all the DHSs within an entire locus containing the gene (where locus may be tens or hundreds of Kb, or even megabases; or is otherwise understood to encompass all DHSs that interact with a gene). In some still further embodiments, differentially regulated footprints can be identified.

The invention also provides methods of deriving cis-regulatory catalogues of a cell type, tissue type, or organism comprising steps of performing a DGF according to the invention, performing de novo motif discovery on footprint sequences, and organizing the results into motif models

The invention also provides a method of profiling functional genetic variation by performing the digital genomic footprinting at a high coverage depth and taking advantage of the high coverage depth to identify functional/occupancy variants within the footprints. For instance, functional variants occurring within footprints and affecting chromatin structure in an allelic fashion can be determined by skewed recovery of heterozygous SNPS, e.g., 20:80 vs. the expected 50:50

In embodiments, the invention also provides a method of determining the effect of a treatment (e.g., drug or chemical or environmental agent) on the binding of regulatory factors to genomic DNA by determining the effect of the treatment on the digital genomic footprint profiling, of an organism, tissue, or cell with drug or exposure and monitoring for qualitative and/or quantitative changes in the footprint. This can be accomplished by comparing the digital genomic profiles (e.g., occupancy, footprints) of control and experimental groups, or of a sample before and during exposures to a treatment or before a treatment and after a treatment has ended.

In any of the above aspects and embodiments, the genomic DNA can be that of any living species (e.g., an animal, a bacteria, a yeast, a plant, a fish, a bird, a mammal, a primate, and a human) and/or tissues thereof.

### BRIEF DESCRIPTION OF THE DRAWINGS

FIG. 1: Digital DNase I analysis of yeast chromatin structure from chromosomal to nucleotide resolution. (a) Per-nucleotide DNase I cleavage density across an exemplary 100-kilobase region of chromosome 10 (chr10:625,000-725,000) containing ˜50 open reading frames (ORFs). The vertical axis is thresholded at a maximum of 75 observed cleavages per nucleotide. DNase I cleavage density is maximal in the proximal intergenic regions; however, peak cleavage intensity varies considerably between different genes. (b) Magnification of exemplary ˜2.5 kb regions containing RSM17/YJR115W and ECM17/IML1 intergenic intervals. (c) Further magnification showing positions of individual DNase I cleavage events (stacked vertical black tick marks), revealing short regions protected from DNase I cleavage (DNase I “footprints”). (d) Resolution of individual DNase I footprints (shading) with known motifs for yeast regulatory factors Rap1, Reb1, Abf1 and Cbf1. The dashed black line indicates the average level of DNase I cleavage throughout the genome (avg. ˜2 cleavages per bp).

FIG. 2: Detection of footprints and corresponding sequence motifs. (a) Visualization of DNase I protection (footprinting) at a subset of computationally-predicted Reb1 sites. The heat-map shows DNase I cleavages surrounding 907 computationally-predicted Reb1 motifs within yeast intergenic regions. Individual heat map rows show levels of DNase I cleavage 25 bp up- and downstream of each motif instance. Rows are sorted by the ratio of mean cleavage over flanking regions to that within the motif itself Ticks (at left) indicate motif instances (n=580) that coincide with footprints (FDR=0.05) containing de novo-derived Reb1 motifs. Ticks (right) indicate motif instances (n=151) coinciding with those identified by ChIP¹⁰. All motif instances in the figure are uniquely mappable within the yeast genome. (b) Mean per nucleotide DNase I cleavage and evolutionary conservation (Phastcons) calculated for 678 footprints that match Reb1 motifs (subpanel vertical axes). Significance of observed conservation patterns (see Methods) is shown. Extent of consensus motifs derived from the footprinted region is shown in green shading, with motifs derived from ChIP and footprinting below. Venn diagrams depict the overlap of motifs derived from and mapping to footprints (darker) vs. ChIP (lighter). (c) Three additional factors (Abf1, Rap1 and Hsf1) evaluated as in panel b.

FIG. 3: Mean nucleotide-level accessibility parallels protein:DNA interactions. (a) Structure of Mcm1 bound to a single DNA recognition site¹⁷ (adjacent Matα2 was removed for clarity). Indicated DNA bases correspond to positions within the footprint-derived Mcm1 motif (below), and DNA backbone shading reflects the extent of observed DNase I cleavage across 88 Mcm1 sites (darker trace in subpanel). Mean nucleotide-level conservation by PhastCons¹¹ is shown in parallel (lighter trace in subpanel; P<10⁻⁵). (b) Structure of the human homolog of CBF1¹⁸ is shown relative to the mean nucleotide level cleavage and conservation (P<10⁻³) across 243 Cbf1 sites.

FIG. 4: Individual yeast regulatory regions and factor binding sites. Shown in each panel is per nucleotide DNase I cleavage, detected footprints (red boxes) and assigned motifs (pink boxes), binding sites inferred from ChIP experiments (blue boxes), and evolutionary conservation (dark blue, Phastcons, bottom). (a) Footprints identified upstream of RPS6A (chr16:378,775-378,874) support the binding of Rap1 to two adjacent binding sites also predicted from ChIP experiments. (b) Footprinting supports the binding of Reb1 to a canonical site upstream of TUF1 (chr15:683,707-683,806). However, an adjacent non-canonical site upstream inferred from ChIP data does not evince a footprint. (c) An Mcm1 site upstream of MFA1 (chr4:1,384,893-1,384,993) exhibits characteristic hypersensitive nucleotides illustrated in FIG. 3a. (d) An Hsf1 site identified by ChIP in BTN2 promoter (chr7:772,068-772,167) is identified as a footprint. (e) Two Reb1 binding sites in the REB1 promoter (chr2:336,885-337,084) are identified as footprints; a Cbf1 site predicted by ChIP is footprinted, and an Rpn4 site defined by ChIP is not footprinted. (f) Two Pdr3 sites in the PDR5 promoter (chr15:619,227-619,476) are identified as footprints, in addition to an evolutionarily conserved region further upstream. (g) Adjacent Abf1 and Cbf1 sites predicted by ChIP in the IML1 promoter (chr10:684,056-684,155) are supported by footprinting. (h) A footprint overlaps a Leu3 site predicted by ChIP in the LEU1 promoter (chr7:478,803-478,902). (i) A footprint overlaps a Hap4 site predicted by ChIP in the ATP15 promoter region (chr16:29,891-29,990). (j) A footprint overlaps a Sut1 site predicted by ChIP in the promoter of YPL230W (chr16:114,469-114,568).

FIG. 5: Higher-order patterns of DNA accessibility. (a) Mapped DNase I cleavages relative to 5,006 TSSs³⁰. Four major clusters are exposed by k-means analysis (red, blue, green and purple bars, respectively). In the red cluster, maximal DNase I cleavage occurs in a stereotypic ˜50 bp band ˜100 bp upstream of the TSS (grey arrowhead, top). Moving out from this central band, ˜175 bp periodicity in DNase I cleavage density is evident, consistent with the presence of phased nucleosome arrays. In the blue, green and purple clusters, the extent and intensity of DNase I cleavage upstream of the TSS widens to the −1, −2, and −3 nucleosomes (respectively). (b) Spatial restriction of footprints near TSSs. Distribution of footprints matching Reb1, Abf1, Rap1, Mcm1, Pdr3, Cbf1 and Hsf1 relative to the TSSs (dashed black lines) and start codons of 1,260 genes sorted by the length of the 5′UTR. Sites for all factors except Hsf1 are significantly enriched within a ˜50 bp region centered ˜100 bp upstream of the TSS (dashed red lines). (c) DNase I cleavage profiles aligned relative to Reb1, Abf1, Rap1 and Mcm1 footprints. Phased nucleosomes (arrows) are evident relative to Reb1 and Abf1 footprints, but only very weakly so relative to Rap1 and Mcm1. (d) mRNA abundance for genes found in each of the four clusters correlates with the accessibility of the promoters of those genes (colors as in a; median expression denoted by a black bar).

FIG. 6: (a) Digital genomic footprinting strategy. Nuclei were isolated from yeast arrested by alpha-factor and treated with DNase I to release short fragments. These fragments were isolated, ligated to sequencing adapters and sequenced using the Illumina 1G. Filtering of reads for quality and mappability resulted in the identification of a total of 23.8 million DNase I cleavages. A computational algorithm was then applied to identify short regions protected from DNase I digestion (“footprints”). (b) Details of a target enrichment strategy for capture footprinting and steps through library construction. (c) details of steps from library construction through to sequencing; and (d) details of steps in sequencing targeted regions using array-based capture.

FIG. 7: Correction of in vivo DNase I cleavage data for sequence bias. (a) Two regions from FIG. 1 are shown, comparing uncorrected (blue) and corrected (red) DNase I cleavages. Cleavages within and surrounding identified footprints do not change substantially upon correction. (b) Aggregate cut-count profiles for Reb1, Abf1, Rap1 and Mcm1 comparing uncorrected (blue line) and corrected (red line) data. Profiles for Reb1, Abf1 and Rap1 do not change substantially, whereas the profile for Mcm1 is altered slightly in the flanking regions.

FIG. 8: Motif-specific ROC curves for the top motifs detected in Table S4. FDR=0.05 Footprints and the yeast intergenic regions were scanned respectively against the ChIPdefined motifs11 at a p value threshold of 10-5. For each motif, all mappable sequences in yeast intergenic regions were considered. Each motif instance was labeled “true” or “false”, and ranked sites by their q-value (i.e. FDR threshold).

FIG. 9: Information content vs. DNase I cleavages within putative transcription factor motifs. Mean DNase I cleavages found within 117 previously computed factor motifs were calculated and plotted versus the motif information content of the factor motifs. DNase I cleavages within motifs were anticorrelated with motif information content (Pearson r=−0.125; P<10⁻⁶).

FIG. 10: Aggregate DNase I cleavage and conservation patterns for diverse transcription factors. Aggregate (mean) DNase I cleavage per nucleotide (red) and PhastCons conservation per nucleotide (blue) are shown for 13 factors. Data for each factor are aggregated across all genomic binding sites from reference 11. (a) Three major regulators (Abf1, Reb1 and Hsf1) with monophasic average cleavage profiles (see FIG. 3). (b) Examples of more compact central cleavage protection profiles for three factors (Gcr1, Tec1 and Hap1). (c) Examples of complex polyphasic aggregate cleavage profiles for six factors (Mcm1, Pdr3, Sut1, Pho4, Msn2 and Ash1).

FIG. 11: Individual yeast regulatory regions and factor binding sites. Shown in each panel is per nucleotide DNase I cleavage, detected footprints (red boxes) and assigned motifs (pink boxes), binding sites inferred from ChIP experiments (blue boxes), and evolutionary conservation (dark blue, Phastcons, bottom). (a) Adjacent Abf1 and Cbf1 sites predicted by ChIP in the IML1 promoter (chr10:684,056-684,155) are supported by footprinting. (b) A footprint overlaps a Leu3 site predicted by ChIP in the LEU1 promoter (chr7:478,803-478,902). (c) A footprint overlaps a Hap4 site predicted by ChIP in the ATP15 promoter region (chr16:29,891-29,990). (d) A footprint overlaps a Sut1 site predicted by ChIP in the promoter of YPL230W (chr16:14,469-114,568).

FIG. 12: High chromatin accessibility and footprinting within a hypothetical ORF. Shown in each panel is per nucleotide DNase I cleavage, detected footprints (red boxes), binding sites inferred from ChIP experiments (blue boxes), and evolutionary conservation (dark blue, Phastcons, bottom). A Rap1 footprint identified within a hypothetical (but poorly conserved) gene model FYV12. The DNase I cleavage pattern suggests this region is in fact the extended promoter of RPS30B.

FIG. 13: Schema for digesting and fractionating genomic DNA for use in footprinting genomic DNA.

FIG. 14: Schema for systemic production pipeline for determining the regulatory protein footprints of genomic DNA.

FIG. 15: Exemplification of capture vs deep sequencing foot printing for K562 cells at chr16:342,763-343,100 (FIMO xfac) SP1 Q1

FIG. 16: Motifs which match to a TRANSFAC database entry; and of those left over, motifs which match to a JASPAR-CORE database entry; and of those left over, how many have a match to a UniPROBE database entry; and of those left over, motifs at this point which are considered NOVEL; and of those NOVEL motifs, how many have a match to an entry in either Kellis database (Require at least 5 non-trivial base matches (to our 8-mer), or fewer if matches all of a db's non-trivial bases (complete 4-mer match, for example)) with a min(zscore) cutoff of 14.)

FIG. 17: Merged and overlapping footprint accounting across cell types. Footprints were merged across cell types to come up with the No. of Distinct FPs (require 80% overlap in either direction A->B or B->A to merge) for 17(a,b) five human cell types (TH1, SKnSH, K562, HepG2, and GM06990) at two FDRs (0.05, 0.001), respectively, and for 17(c,d) three core human cell types (TH1, SKnSH, K562) at two FDR's (0.05, 0.001), respectively.

FIG. 18: Footprinting is a quantitative measure of protein occupancy. Shown is relationship between measurement of CTCF factor occupancy at CTCF motifs using chromatin immunoprecipitation-sequencing (ChIP-seq) vs. the footprint discovery statistic score, which provides (in addition to statistical rigor) a quantitative measure of the prominence or ‘depth’ of the footprint. Vertical axis: ChIP-seq tag density at 7,964 randomly sampled CTCF motifs within DNaseI hotspots. Horizontal axis: Footprint discovery statistic score calculated over the same 7,964 CTCF motifs. Occupancy by ChIP-seq is closely correlated with footprint significance, affirming the latter as a quantitative measure of occupancy.

FIG. 19: Stereotypical cleavage signatures of known regulators and novel motifs identified in footprints. Shown is per-nucleotide cleavage (white=high, black=low) of known and novel regulatory motifs within DNaseI hotspots, with each heatmap pixel row depicting data from an individual distinct motif instance; approximately 5-10,000 rows/motif instances are shown within each heatmap. Cleavge patterns are both highly stereotyped across the instances of a given regulatory factor (ie largely independent of genomic context), and each factor gives a characteristic cleavage signature.

FIG. 20: Differential regulation of digital DNaseI footprints associated with gene expression. (a) Shown is a close-up of digital genomic footprinting data at the VGF (nerve growth factor) promoter for five cell types (primary Th1 T-cells, SKnSH neuronal cells, GM06990 B-lymphoblastoid cells, HepG2 hepatic cells, and K562 erythroid cells). Data are from genome-wide deep sequencing, with read depths ranging from 150-200 million uniquely mapping reads. Vertical axis shows per nucleotide DNaseI cleavage. Note the presence of prominent footprints coinciding with known regulatory factors. Note specifically that the footprint for NRSF (neuron-restricted silencer factor), a repressor of neural genes in non-neural cell types, is present overlying the transcriptional start site in all cell types except neuronal cells. Evacuation of the NRSF repressor site in neuronal cells is accompanied by activation of gene expression (see panel b), appearance upstream of a USF footprint and increased occupancy at an SP1 footprint, plus appearance of a novel footprint. (b) Shown are gene expression data obtained from each cell type using an Affymetrix Human Exon array 1.0. Array probes cover all a substantial portion of this region. Shown is relative expression, in which values from each probe are divided by the mean value of all other probes (from other cell types) at that position. Note the dramatic upregulation of VGF expression coincident with the relief of NRSF repression and the appearance of neuronal-specific digital footprints upstream of the transcriptional start site.

FIG. 21: Cell-type specific regulatory factors have footprints which are enriched according to cell-type.

FIG. 22: Different modes of zinc finger binding have distinct footprints.

FIG. 23: Shown are the effects of a single nucleotide polymorphism within the binding motif for CTCF. The G→T change completely abrogates CTCF binding, in a heritable fashion. The height of the peak represents the aggregate DNaseI sensitivity (tag density) from both alleles. Analogous changes are evident at the level of the DNaseI footprint.

### DETAILED DESCRIPTION OF THE INVENTION

It is noted here that as used in this specification and the appended claims, the singular forms “a,” “an,” and “the” include plural reference unless the context clearly dictates otherwise.

The orchestrated binding of transcriptional activators and repressors to specific DNA sequences in the context of chromatin defines the regulatory program of eukaryotic genomes. The present inventor developed a digital approach to assay regulatory protein occupancy on genomic DNA in vivo by dense mapping of individual DNase I cleavages from intact nuclei using massively parallel DNA sequencing. Analysis of >23 million cleavages across the Saccharomyces cerevisiae genome revealed thousands of protected regulatory protein footprints, enabling de novo derivation of factor binding motifs as well as the identification of hundreds of novel binding sites for major regulators. Striking correspondence was observed between nucleotide-level DNase I cleavage patterns and protein-DNA interactions determined by crystallography. The data also yielded a detailed view of larger chromatin features including positioned nucleosomes flanking factor binding regions. Digital genomic footprinting provides a powerful approach to delineate the cis-regulatory framework of any organism with an available genome sequence.

The method has been successfully applied to the human, E. coli, zebrafish, mouse and drosophila genomes. Deep sequencing exposes the footprints of the regulatory DNA binding proteins as the high concentration of tags within DHS's enables recognition of footprints in the human and other genomes. The identified footprints may be constitutive or cell-specific. The number of footprints increases almost linearly with tag depth; currently not sampling the entire space We have found that the known regulatory factor motifs are concentrated in footprints and that different regulatory factors have characteristic accessibility signatures. Essentially all DNase I hypersensitive sites detected have been found to contain one or more regulatory factor footprints. Our results indicate that regulatory factor binding has been imprinted on the human genome sequence. Footprints are generally evolutionarily conserved, even though are not trivially recognizable from conservation data.

DNase I footprinting has long been used in an in vitro context to interrogate protein-DNA interactions. However, application of this approach to the study of in vivo interactions has proven difficult, and only a handful of studies have been reported for highly targeted loci such as individual cis-regulatory elements²⁹. By coupling DNase I digestion of intact nuclei with massively parallel sequencing and computational analysis of nucleotide-level patterns, the digital genomic footprinting approach now described enables genome-scale detection of the in vivo occupancy of genomic sites by DNA-binding proteins over hundreds of loci or the entire genome. Although detection of individual binding events is dependent on the depth of sequence coverage at a given position, the approach takes advantage of the concentration of cleavages within DNase I hypersensitive regions. In the case of mammalian genomes, DNase I cleavage is highly targeted to DNase I hypersensitive sites, which comprise only 1-2% of the genome in each cell type. As such, although the human genome is ˜250-fold larger than the yeast genome, the collective span of human DNase I hypersensitive sites is only 1-2% of the genome, and therefore addressable with only modest scale-up.

To date, genome-scale localization of regulatory factor binding sites has largely relied on a top-down approach centered on chromatin immunoprecipitation. Several limitations of this approach are addressed by digital genomic footprinting. Whereas ChIP requires prior knowledge of each DNA-binding protein to be interrogated by genome-wide location analysis, and can be carried out on only one protein at a time, DNase I footprinting addresses all factors simultaneously in their native state, and detects regions of direct binding at nucleotide precision vs. inference based on motif enrichment analysis. However, many regulatory factors share common binding sequences, and ChIP offers definitive identification of the protein of interest. The joint application of digital genomic footprinting with ChIP should therefore provide particularly rich information concerning the fine-scale architecture of cis-regulatory circuitry. However, DGF need not be applied in conjuction with ChIP.

Digital genomic footprinting also provides a powerful tool for annotation of the genomes of diverse organisms about which little is known beyond the genome sequence itself. In these contexts, top-down approaches to regulatory factor binding site localization are limited. By contrast, digital genomic footprinting can be applied to develop rapidly both a gene-by-gene map and a lexicon of major regulatory motifs.

Cis-regulatory alterations accompanying different growth, conditions or cell differentiation and cycling impact multiple regulators simultaneously and are difficult to study. The approach described herein is readily extensible to the analysis of such changes across the genome by sampling sequential time points to visualize cis-regulatory dynamics. Digital genomic footprinting therefore has the potential to expose and probe the cis-regulatory regulatory framework of virtually any sequenced organism in a single experiment, regardless of its prior level of functional characterization.

The present invention provides a method for determining protein-binding pattern of a genomic DNA of known, partially known, or unknown sequence. The method comprises the following steps: (1) digesting the genomic DNA in the presence of its binding proteins with a DNA-cleaving agent to generate a plurality of DNA fragments; (2) determining the nucleotide sequence of at least some of the plurality of DNA fragments, the nucleotides at the ends of the DNA fragments indicating the DNA cleavage sites in the genomic DNA; and (3) determining the frequency of DNA cleavage throughout the length of the genomic DNA sequence, a segment of the genomic DNA sequence having lower than average frequency indicating a protein-binding site, thereby determining protein-binding pattern of the genomic DNA. Typically, the cleavage fragments are sequenced at random from all fragments but constitute a substantial percentage of all fragments. Often, the protein-binding sites are determined as a segment of the genomic DNA sequence not only having lower than average frequency but also having higher than average frequency in segment's immediate flanking regions.

In other embodiments, the genomic DNA is the entire genome of a species, such as a viruses, yeast, bacteria, animals, and plants. The genomic DNA may be from still higher life forms, e.g., it may be human genomic DNA. In other embodiments, the genomic DNA comprises one or more chromatid fibers, or at least 25%, 50%, 75%, 80%, 90%, 95%, or 98% of the genomic DNA of the species. In some embodiments, the genomic DNA is obtained from a biological sample includes cell cultures and also sections of tissues such as biopsy and autopsy samples, and frozen sections taken for histologic purposes. Such samples include blood and blood fractions or products, sputum, tissue, cultured cells, e.g., primary cultures, explants, and transformed cells. A biological sample is typically obtained from a virus, a procaryotic or eukaryotic organism, and most preferably a plant or a mammal such as a primate e.g., chimpanzee or human; cow; dog; cat; a rodent, e.g., guinea pig, rat, Mouse; rabbit; or a bird; reptile; or fish.

In some embodiments, the DNA-cleaving agent is a nuclease, such as a DNase. DNase I is often used for this purpose. In preferred embodiments, the nuclease is a nuclease which makes single strand cuts under the reaction conditions employed. For example, the nuclease can be DNase I under reaction conditions known to favor single strand cuts (suitable concentrations of Mg⁺⁺ and Ca⁺⁺). In order to achieve a double strand cleavage under these single strand cleaving conditions, the DNase I must make nick a double-stranded DNA twice in close proximity on opposite strands of the DNA. The requirement for this “double-hit” greatly increases the method's selectivity for those portions of the genome which are bound to a regulatory factor and thus most accessible to the nuclease. Selecting DNA fragments of a suitable length and having a double-hit at both ends further increases the selectivity of the method. A variety of nucleases can be used, including non-sequence-specific endonucleases such as DNase I, S1 nuclease, mung bean nuclease, etc. Sequence-specific nucleases may also by used such as restriction enzymes. Of course, reaction conditions may need to be adjusted for different agents, but are readily ascertained by examining the cleavage products, e.g. on a gel. In addition, in some embodiments, Chemical probes capable of cleaving DNA can also be used (e.g., hydroxyl MPE (methidiumpropyl-EDTA), piperidine, iron, potassium permanganate).

Preferably, a trial DNA sequencing is performed to ascertain enrichment of a sample. A sample sequence is obtained and enrichment is calculated. The amount of sequence obtained is instrument dependent, but preferably, for the human genome, at least 5 million sequence reads that map uniquely to the genome will have been obtained for the trial. Smaller numbers can also be used, and correspondingly lower numbers will be required for smaller genomes. The enrichment can be calculated by identifying statistically significant sequence tag clusters, and then computing the proportion of all uniquely mapping tags that fall within clusters. In a preferred embodiment, identification of significant clusters is performed using a scan statistic algorithm to delineate DNase I ‘hotspots’. The ‘percent of tags in hotspots’ (PTIH) is then calculated. Samples with PTIH<30 or <40% are considered to have low enrichment and are not optimal candidates for digital genomic footprinting. In a preferred embodiment, only samples with PTIH>40, 50, 60, or 70% are advanced to deep sequencing.

The selected enriched samples are then subjected to deep sequencing. The number of reads required will vary considerably by organism, and is related to the number of DNase I hypersensitive sites (DHS) within the genome, or, in the case of organisms that lack DNase I hypersensitive sites such as bacteria, the total size of the genome. For the human genome, more than 200 million uniquely mapping reads are preferably required, and complete footprinting of all DHSs may not be obtained until many more hundreds of millions or even billions of reads are obtained. The reads are processed in order to determine the total cleavages that have been observed for every nucleotide within the genome. The reads may be single-end (in which case only one end of each fragment will be sequenced) or paired-end (both fragments ends sequenced and providing information on the cleavage at both ends). These are preferably visualized using a bar plot, with the vertical axis denoting the number of cleavages mapped to each nucleotide at the particular sequencing depth of the data set. The greater the number of nucleotide cleavages per nucleotide in hot spots or the footprint, the greater the resolution of the method. Typically, mean nucleotide cleavages per nucleotide over a footprint are at least 4, 5, 6, or 7, or, more preferably still, at least 10, 20, or 30. The intensity of the deep sequencing is reflected in the total average number of nucleotide cleavages counted per nucleotide over a footprint.

In an optional, though desirable, step, per-nucleotide DNase I cleavage may be corrected for the intrinsic sequence preferences of the cleavage method (e.g., DNase I).

Though commonly regarded as a non-specific endonuclease, DNase I exhibits some sequence preference that may vary widely over different combinations of nucleotides. The enzyme engages 6 bp of DNA (3 on each side of the cleavage site).

Deep sequencing exposes footprints as the high concentration of tags or number of cleavage sites per nucleotides within DHS's enables recognition of footprints in a genome. The sequencing of the footprint can also provide a method of identifying polymorphisms within the footprint where an entire footprint or portions thereof is sequenced. Footprints may be constitutive or cell-specific and can also provide a quantitative measure of occupancy (and may thus replace current measures).

In other embodiments, the invention provides a method of targeted genomic footprinting by performing digital genomic footprinting according to the invention, upon captured fragments corresponding to subset of genome. Fragments corresponding to subset of genome are captured by reagents or probes.

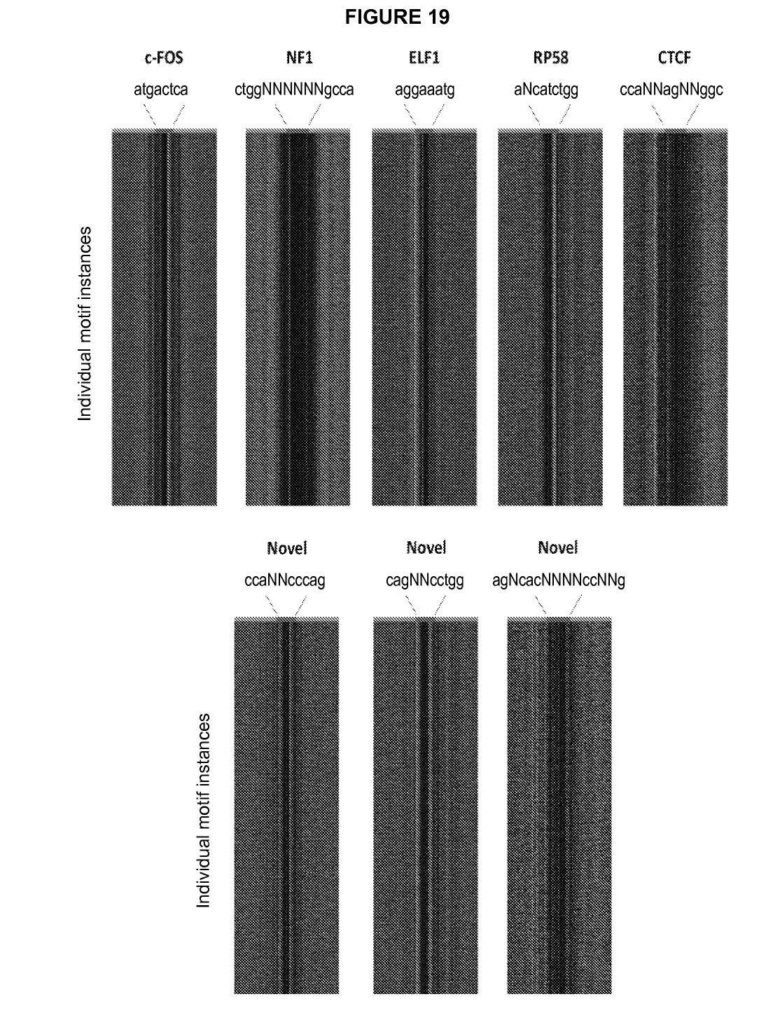

In some embodiments, the invention provides a method of quantifying regulatory factor occupancy by performing a digital genomic footprinting (DGF) and mapping the cleavage counts per nucleotide to the genome. Optionally, also, the hotspot regions can be identified. In some further embodiments, for a regulatory factor with a known motif or for any given motif regardless of whether the cognate regulatory factor is known, the footprint discovery statistic is computed over all instances of the regulatory factor motif within DNaseI hotspots and the motif instances are ranked by footprint discovery statistic (low→high=high affinity low affinity) as a shown in FIG. 19. In some further embodiments, the invention provides a method of targeted genomic footprinting by performing digital genomic footprinting according to the invention upon captured fragments corresponding to a subset of genome.

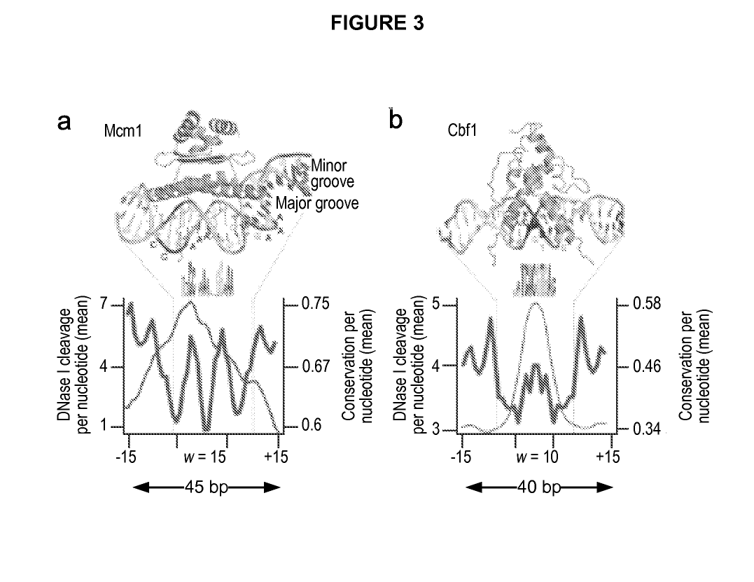

In some other embodiments, the invention provides a method of determining the genomic protein:DNA contacts for a protein by performing a digital genomic footprinting according to the invention, optionally, identifying the hotspot regions, and computing the mean per nucleotide cleavage over all instances of the cognate sequence motif of that protein. The degree of nucleotide protection provides a quantitative measure of protein:DNA contact for each nucleotide within the contact region (see, for instance, FIG. 3). In some further embodiments, the invention provides a method of targeted genomic footprinting by performing digital genomic footprinting according to the invention, and capturing fragments corresponding to a subset of genome.

In yet other embodiments, the invention provides a method of producing a regulatory factor signature by performing a digital genomic footprint according to the invention, optionally identifying the hotspot regions, and for any given regulatory factor with a known motif (or for any given motif regardless of whether the cognate regulatory factor is known), computing the mean per nucleotide cleavage over a representative number, or randomly selected number, or all instances of the cognate sequence motif of that protein. Preferably, the computing begins upstream (5, 10, or even 25 bp) of the first nucleotide of the motif-matching sequence, and continues downstream of the motif for the same distance. In some further embodiments, the invention provides a database or library of regulatory signatures which can be obtained by the method and further provides methods of using the database to identify a specific regulatory factor by comparing its signature to known signatures. FIG. 19 illustrates the regulatory signature factor observed for five known regulatory factors and three as yet unidentified factors. In some further embodiments, the invention provides a method of targeted genomic footprinting by performing digital genomic footprinting according to the invention, and capturing fragments corresponding to a subset of genome.

In still more embodiments, the invention provides a method of identifying the structural class of a regulatory factor by comparing its signature to archetypes from each structural class. In some further embodiments, the invention provides a method of targeted genomic footprinting by performing digital genomic footprinting according to the invention upon captured genomic fragments corresponding to a subset of genome.

In yet other embodiments, the invention provides a method of determining the regulatory factors that regulate a gene by performing a DGF according to the invention and analyzing all the DHSs within an entire locus containing the gene (where locus may be tens or hundreds of Kb, or even megabases; or is otherwise understood to encompass all DHSs that interact with a gene). In some still further embodiments, differentially regulated footprints can be identified. In some further embodiments, the invention provides a method of targeted genomic footprinting by performing digital genomic footprinting according to the invention upon captured fragments corresponding to a subset of genome.

The invention also provides methods of deriving cis-regulatory catalogues of a cell type, tissue type, or organism comprising steps of performing a DGF according to the invention, performing de novo motif discovery on footprint sequences, and organizing the results into motif models. In some further embodiments, the invention provides a method of targeted genomic footprinting by performing digital genomic footprinting according to the invention, and capturing fragments corresponding to a subset of genome.

The invention also provides a method of profiling functional genetic variation by performing the digital genomic footprinting at a high coverage depth and taking advantage of the high coverage depth to identify functional/occupancy variants within the footprints. For instance, functional variants occurring within footprints and affecting chromatin structure in an allelic fashion can be determined by skewed recovery of heterozygous SNPS, e.g., 20:80 vs. the expected 50:50.

The invention also provides a method of determining the effect of a treatment (e.g., drug, diet, activity, chemical or infectious agent, radiation, or another environmental agent) on regulatory factor binding or activity by determining the effect of the treatment on the digital genomic footprint profiling, before and after treatment or with and without the treatment, of an organism, tissue, or cell with drug or exposure and monitoring for qualitative and/or quantitative changes in the footprint. In some further embodiments, the digital genomic footprinting is targeted to portions of the genome by capturing fragments corresponding to a subset of genome. In some embodiments, differences in the occupancy of a regulatory protein footprint is qualitatively or quantitatively determined.

Accordingly, in some embodiments the invention contemplates the use of digital genomic footprinting to 1) identify the structural class of a regulatory factor by determining a footprint signature for the factor according to the method and comparing the footprint signature of the regulatory factor to one or more archetype signatures also determined according to the method; 2) to identify all the regulatory factor footprints within an entire locus of agene; 3) to identify functional genetic variations within the nucleic acid sequence of a genome which alter the functionality/occupancy of a footprint by a regulatory factor; or 4) to determine the effect of a treatment on protein binding to a nucleic acid by administering the treatment to a cell or other subject and determining the digital genomic footprint for the treated cell or subject according to the method and comparing the determined genomic footprint for the treated cell or subject to a genomic digital footprint obtained by the method for an untreated or control cell or subject.

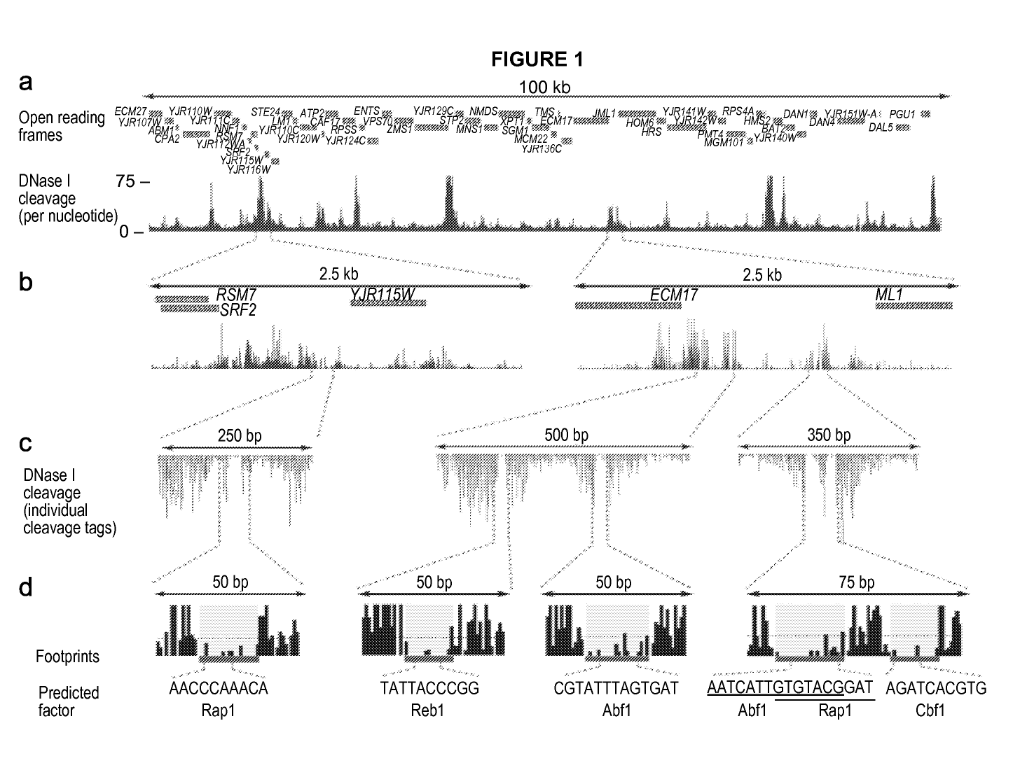

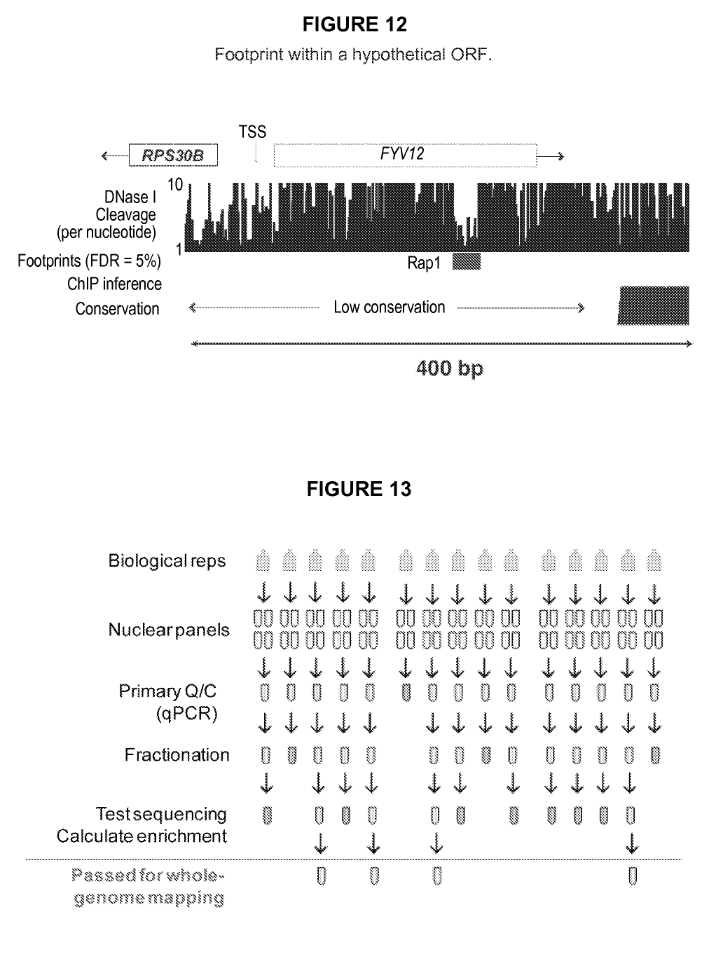

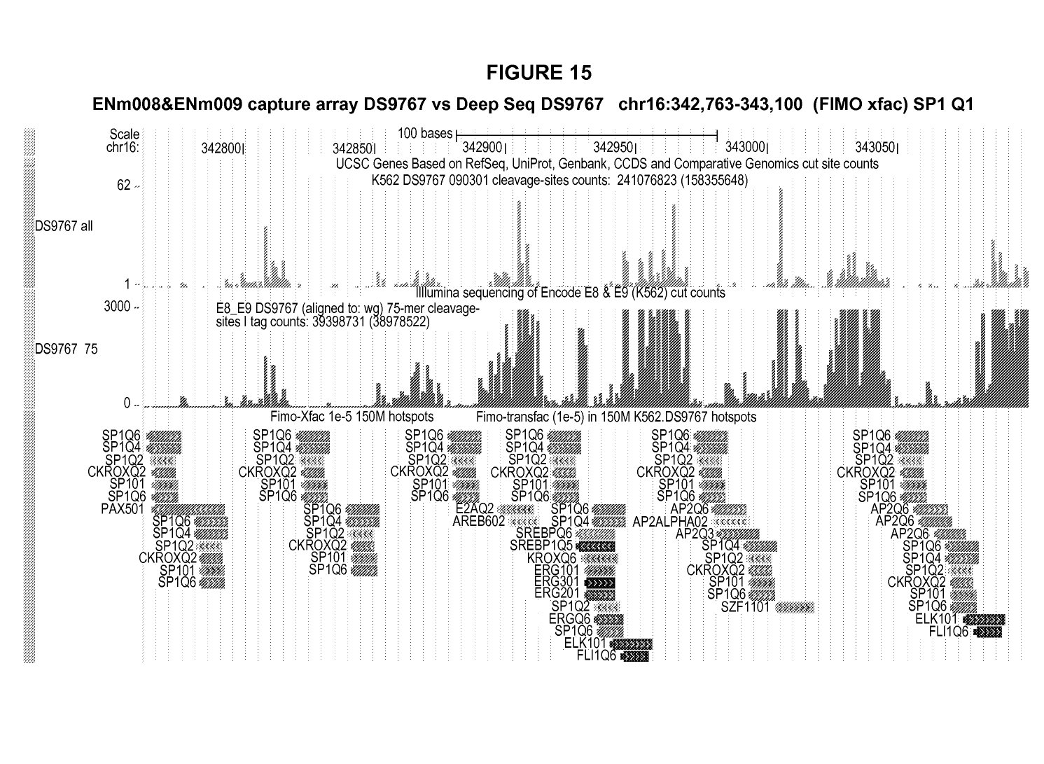

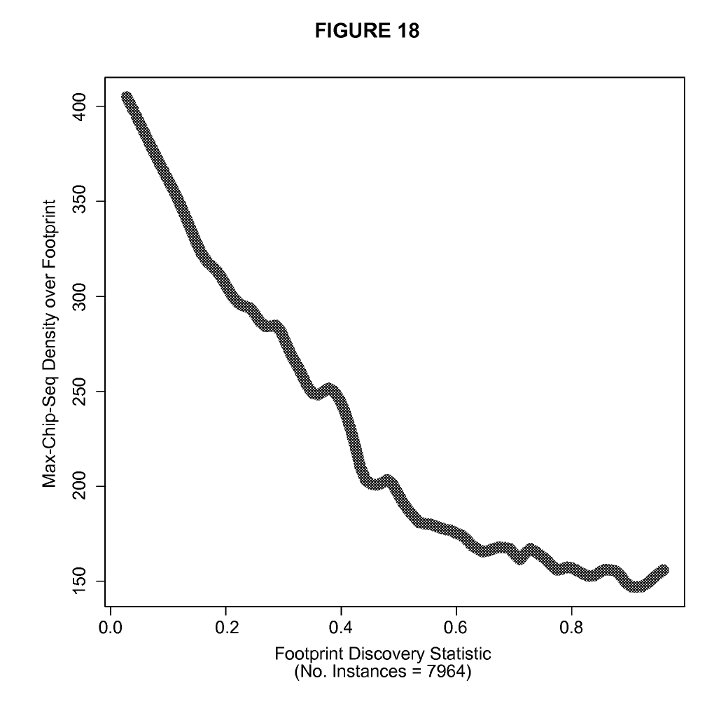

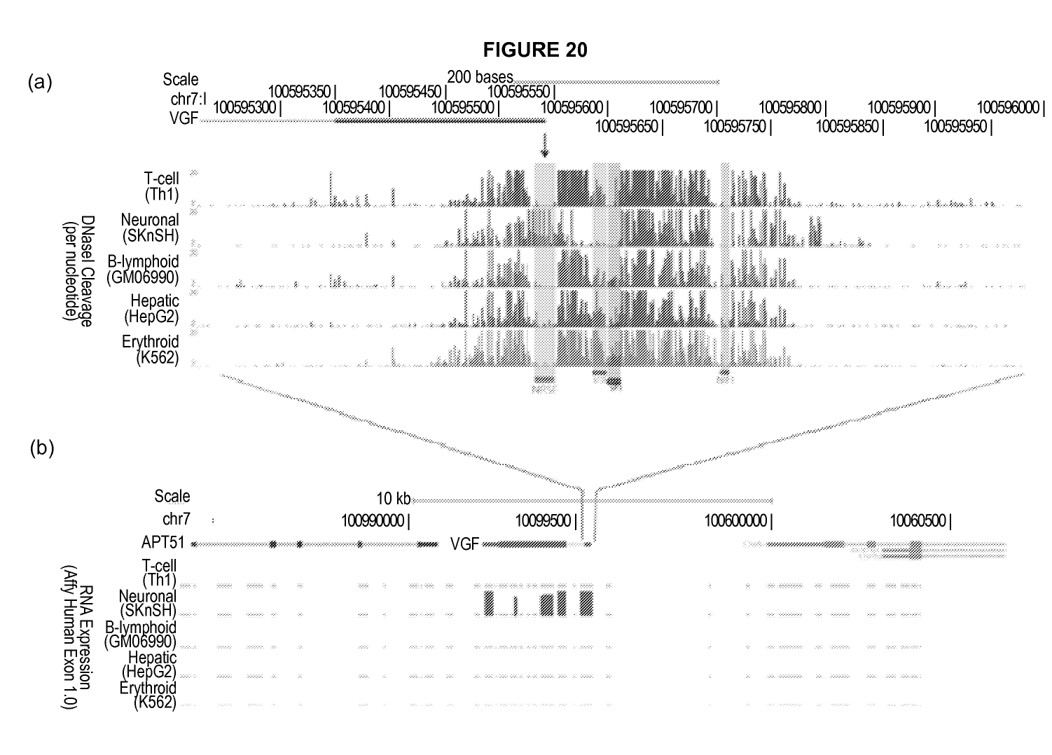

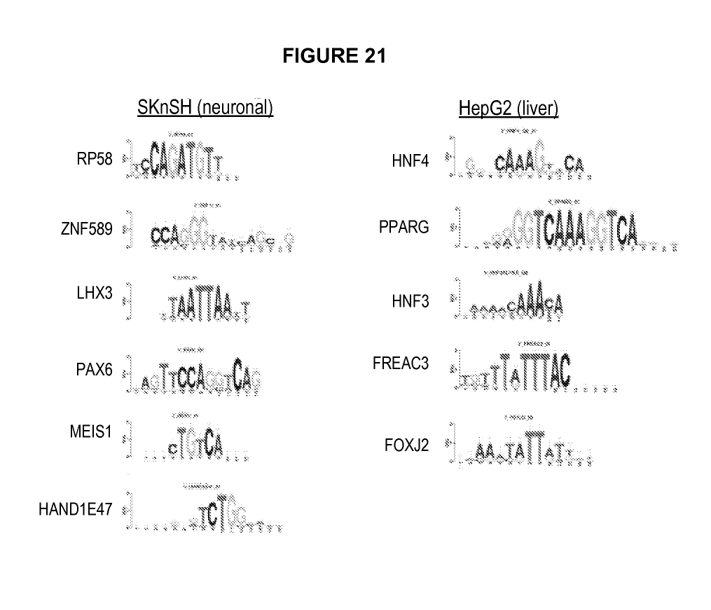

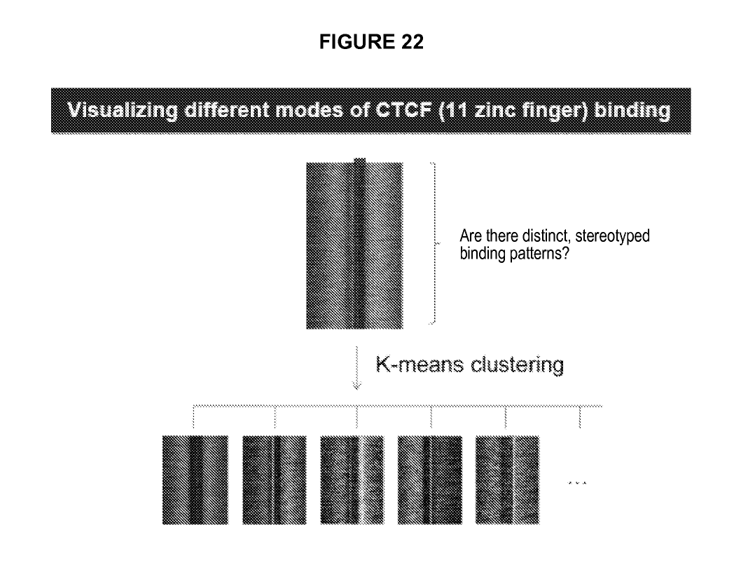

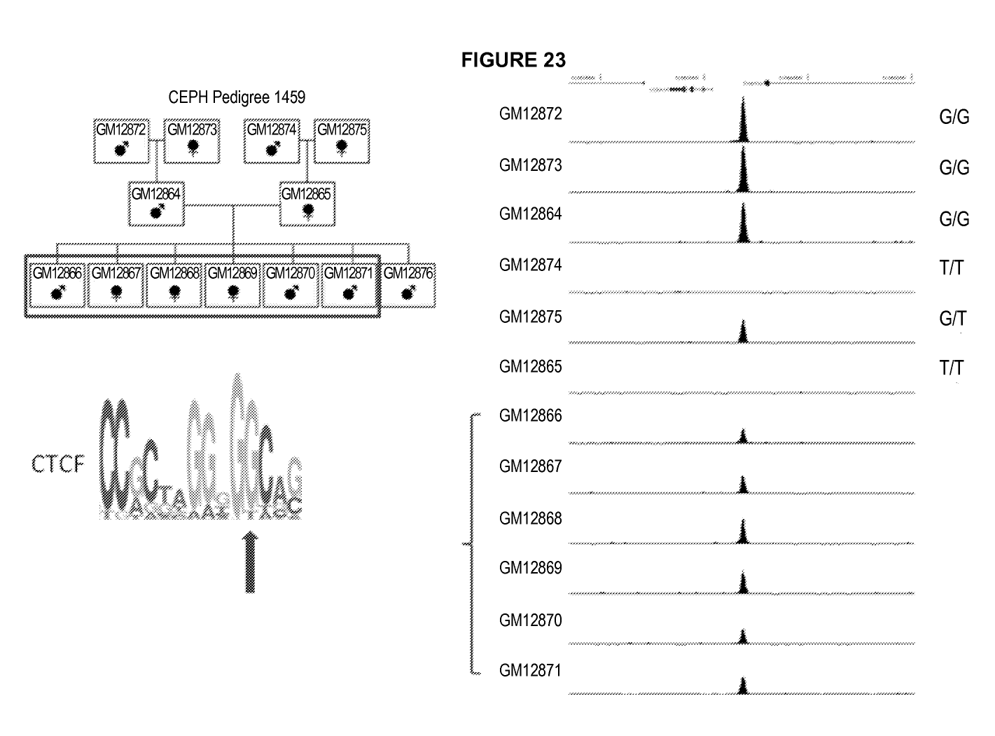

In any of the above aspects and embodiments, the genomic DNA, cell or subject, can be that of any living species (e.g., an animal, a virus, a bacteria, a yeast, a plant, a fish, a bird, a mammal, a primate, and a human) and/or tissues thereof. In some instances, the genomic DNA comprises viral and genomic DNA as when a cell is infected with a virus. FIGS. 1 to 22 further illustrate the diverse applications and utility of digital genomic footprinting according to the invention.

In any of the above aspects and embodiments, the capture reagents or probes used in targeting the genomic nucleic acid may be in the form of an array or in solution. The capture reagent may be a nucleic acid (e.g., RNA, DNA), peptide nucleic acid (PNA), a locked nucleic acid (LNA), or a protein.

### Digital Genomic Footprinting

The Digital Genomic Footprinting method can be performed as follows:
1) First the nucleic acids in a sample are digested using a nuclease or nuclease/reaction conditions which preferably makes single stranded nicks with each cut (e.g, DNase I digestion methods disclosed herein). The digestion may be performed on nuclei or on whole cells, preferably, isolated nuclei. Permeabilization of nuclei or whole cells is preferred to increase access of the nucleic acid is preferred. 5 million cells (or more) are typically used, although the method has been performed with as few as 200,000 cells. The number of cells depends on the methods used. Microfluidic methods enable the method to be practiced on as few as 10,000 cells. Theoretically, the process can be performed on as few cells as needed to provide the contemplated number of nucleotide cleavages/nucleotide in a footprint.
2) The DNA is then purified; and
3) The relative digestion is preferably quantified. Samples that show either comparatively inadequate digestion within known DNase I hypersensitive sites (DHSs) or that show comparatively excess digestion within the reference regions are discarded. This step can be accomplished by examining the digestion in known DHSs vs. reference non-DHS regions using real-time PCR.
4) The DNA is then fractionated by size to isolate the small (<500 bp) DNase I double-hit fragments (DDHFs). Size fractionation is preferably performed using sucrose gradient ultracentrifugation, as gel fractionation results in higher background (due to fracture of longer DNA fragments, presumably and single-stranded nick sites, yielding spurious short fragments that increase background).
5) The DDHFs are then assembled into sequencing libraries. An advantage of DDHFs is that each end represents an in vivo cleavage site so orientation is not important. Libraries may be single-end (in which case only one end of each fragment will be sequenced) or paired-end (in which case both ends will be sequenced). For efficiency, the preferred embodiment is single end sequencing.
   Steps 4-5 are illustrated in FIG. 13.
6) Enrichment of the samples is then ascertained by trial DNA sequencing. In this step, sample sequences are obtained and their enrichment calculated. The amount of sequence obtained is instrument dependent, but preferably, for the human genome, at least 1 or 5 million sequence reads that map uniquely to the genome will be used to calculate the sample enrichment. Smaller numbers can also be used, and correspondingly lower numbers will be required for smaller genomes. The enrichment can be calculated by identifying statistically significant sequence tag clusters, and then computing the proportion of all uniquely mapping tags that fall within clusters. In a preferred embodiment, identification of significant clusters is performed using a scan statistic algorithm to delineate DNase I ‘hotspots’. The ‘percent of tags in hotspots’ (PTIH) is then calculated. Typically, samples with PTIH<40% are considered to have low enrichment and are not optimal candidates for digital genomic footprinting. In a preferred embodiment, only samples with PTIH>50% are advanced to deep sequencing.

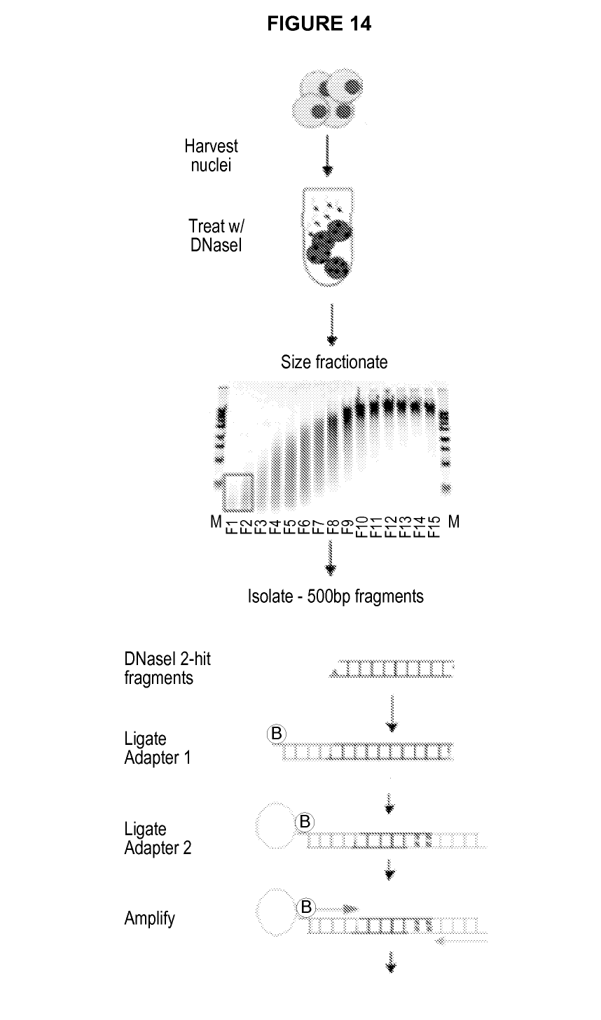

The above steps 1-6 are preferably incorporated into a systematic production pipeline as illustrated in FIG. 14.
7) Suitably enriched samples are then subjected to deep sequencing. The number of reads required will vary considerably by organism, and is related to the number of DNase I hypersensitive sites within the genome, or, in the case of organisms that lack DNase I hypersensitive sites such as bacteria, the total size of the genome. For the human genome, more than 200 million uniquely mapping reads are preferably required, and complete footprinting of all DHSs may not be obtained until many more hundreds of millions or even billions of reads are obtained. Such numbers can be achieved quite readily in the laboratory.
8) The reads are processed in order to determine the total cleavages that have been observed for nucleotides within the genome. These are preferably visualized using a bar plot, with the vertical axis denoting the number of cleavages mapped to each nucleotide at the particular sequencing depth of the data set.
9) In an optional, though desirable, step, per-nucleotide nuclease cleavage may be corrected for the intrinsic sequence preferences of the nuclease used (e.g. DNase I). Though commonly regarded as a non-specific endonuclease, DNase I exhibits some sequence preference that may vary widely over different combinations of nucleotides. The enzyme engages 6 bp of DNA (3 on each side of the cleavage site). The cleavage may be corrected using an empirical model derived from treating naked DNA with DNase I, sequencing the cleavage sites, and then computing the relative cleavage rates of either tetranucleotide or hexanucleotide combinations staddling the cleavage sites. The observed genomic cleavages performed in the context of chromatin may then be attenuated or accentuated, as dictated by the intrinsic cleavage propensity of the surrounding 4 (+/−2) or 6 (+/−3) nucleotides.
10) DNase I footprints within the per-nucleotide cleavage data are then identified. A number of algorithms may be employed, including segmentation approaches such as hidden Markov models; classification approaches such as support vector machines; or heuristics based on the expected distribution of cleavages surrounding protein binding sites. In a preferred embodiment, DNase I footprints are calculated using a footprint discovery statistic described below. The preferred footprint discovery statistic described is highly advantageous because it serves as a quantitative measure of occupancy. Footprints may optimally be assigned a statistical significance, and thresholding applied to identify only those footprints that meet a certain significance cutoff. Significance may be expressed as a False Discovery Rate (FDR), which may be calculated using a number of approaches. A preferred approach to foot print detection is described below.

In some embodiments, the average occupancy of a given footprint site by a given regulatory factor can be expressed as the footprint discovery statistic, which may be used in place of other measures of occupancy such as chromatin immunoprecipitation.

In some embodiments, identification of the regulatory factors binding at a specific location is readily accomplished by matching known sequence binding motifs (or their position weight matrices) with the footprint sequences, using any of a variety of established algorithms such as FIMO.

In still other embodiments, the footprints may be analyzed to derive, de novo, the cis-regulatory lexicon and footprints of an organism. This is accomplished by performing de novo sequence motif discovery on the footprint sequences. A number of algorithms may be employed, though in practice an algorithm will need to be able to scale to millions of sites. A preferred algorithm for performing de novo motif discovery is provided below.

In still other embodiments, sequence variants within footprints may be readily identified by examining the individual sequence reads overlying the footprint. Homozygous variants that differ from the reference sequence are readily recognized, as are heterozygous variants.

In yet other embodiments, allelic variation in actuation of the footprint, or actuation of the composite regulatory element of which the footprint is a part, may also be recognized when heterozygous sequence variants are available. This is accomplished by determining the presence of statistically significant deviation from a 1:1 ratio of each allele.

In additional further embodiments of any of the above, functional variants that impact regulatory factor binding are identified. Alternatively, such variants may be identified by combining sequence variants associated with disease or phenotypic traits with the footprint or motif information obtained according to the above methods and embodiments.

### Footprint Detection

Each base of the genome can be given an integer score equal to the number of uniquely-mappable tags whose 5′ ends map to that location. Genomic regions, ranging from hundreds to over a thousand base-pairs, whose clustered scores are statistically higher than expected can be identified and labeled as hotpot regions. Hotspot regions at the 0.5% false discovery rate (FDR) level can be genomically expanded by 100 base-pairs in the 3′ direction of the forward strand and scanned for footprints.

A footprint is comprised of 3 components: a central component with a flanking component to each side. The central (or core) component of a footprint shows the shadow of one or more bound proteins while its flanking regions show active cutting by the DNase I enzyme. The more contrast between a central component's score and its flanking components' scores, the stronger the evidence of a bound protein(s) to DNA. The level of evidence can be quantified using the formula:

fp-score=(C+1)/L+(C+1)/R, where
C=the average number of tags in the central component of the footprint,
L=the average number of tags in the left flanking component of the footprint, and
R=the average number of tags in the right flanking component of the footprint.

In embodiments, the flanking components of a footprint can be from 3 to 15 or 3 to 20. A preferred footprint detection algorithm searches for footprints with central components between 6 and 40 base-pairs in length and flanking components with lengths of 3 to 10 base-pairs, inclusively. In this method, the output of the algorithm is the set of footprints that optimize the fp-score, subject to the criteria that L and R must both be greater than C, and all central components must be disjoint. As defined, a lower fp-score is deemed more significant than a higher one.

When two or more potential footprints have overlapping central components, the footprint with the lowest fp-score is selected for output. The entire local region around the selected footprint is scanned again, given the knowledge of the first footprint. No newly identified potential footprint will have a central component that overlaps a previously selected footprint's central component. This process is performed as many times as necessary until no new potential footprint is identified within the local area.

Some attention must be given to genomic locations that are not uniquely-mappable as they have scores of zero by definition. Any footprint whose central component consists of bases that are not uniquely-mappable over at least 20% of its length can be thrown out. The proportion thrown out is typically much less than 1% of all footprints called.

### Calculation of False Discovery Rate

The hypothesis that the evidence for footprinting is no stronger than one would expect by random chance can be tested. To do this, one can randomly assign the same number of tags found within a hotspot region to uniquely-mappable locations within that region. Each base is then given an integer score equal to the number of tags whose 5′ ends map to that location.

The false discovery rate (FDR) is the expected value of the quantity defined by the number of truly null features called significant divided by the total number of features called significant. The FDR is closely approximated by the expected number of truly null features called significant divided by the expected number of total features called significant.

One can estimate the expected number of truly null features called significant as the number of footprints found with a fp-score at or below a chosen threshold in the randomized data. One can estimate the expected number of all features called significant analogously as the number of footprints found with a fp-score at or below the same threshold level in the observed data. Typically, one can find the fp-score such that the FDR is estimated at 1%, and apply that threshold score to the observed data for final footprint output reporting. Other fp-score cutoff can be selected.

Once can buffer each hotspot by 100 base-pairs in the 3′ direction of the forward strand in the observed case. Since this extra buffer is not part of the actual hotspot, one does not do the same in the random case. Instead, one simply ignores all such footprints in the observed case when calculating false discovery rates. The proportion of footprints ignored is typically less than 1% of the total and is considered negligible for such estimates.

One can look to the identical locations for the random case that one derived in the observed case's output. In this way, one can start with the same number of footprints in both cases during FDR calculations. If the average number of tags in either flanking region is zero in the random case, one can assign an arbitrarily large value for that fp-score.

### Computational Identification of Regions of Tag Enrichment—Hotspots

### Hotspot Algorithm

The purpose of the hotspot algorithm is to identify regions of local enrichment of short-read 27-mer sequence tags mapped to the genome. Enrichment is gauged in a small window (250 bp) relative to a local background model based on the binomial distribution, using the observed tags in a 50 kb surrounding window. Each mapped tag gets a z-score (explained below) for the 250 bp and 50 kb windows centered on the tag. A hotspot is defined as a succession of neighboring tags within a 250 bp window, each of whose z-score is greater than 2. Once a hotspot is identified, the hotspot itself is assigned a z-score relative to the 250 bp and 50 kb windows centered on the average position of the tags forming the hotspot.

Z-score calculation. Suppose n observed tags fall in the 250 bp window, and N total tags fall in the 50 kb surrounding background window (N≧n). Each tag in the background window is considered an “experiment,” with favorable outcome if it falls in the smaller window. Assuming each base in the 50 kb window is equally likely, the probability of success for each tag is therefore

$$p = \frac{250}{50000} .$$

Not all bases in the 50 kb window may be uniquely mappable by 27-mers, however, sop is adjusted to account for the number of uniquely mappable bases for that window. Under these assumptions, the binomial distribution applies, and the expected number of tags falling in the smaller window is μ=Np. The standard deviation of this expected value is σ=\sqrt{Np(1−p)}. Finally, the z-score for the observed number of tags in the smaller window is

$$z = \frac{n - μ}{σ} .$$

Two-pass hotspots. A problem occurs with hotspot scoring in regions of very high enrichment. These “monster hotspots” inflate the background for neighboring regions, and deflate neighboring z-scores. The effect is that regions of otherwise high enrichment can be shadowed by the monster. To address this problem, we implement a two-pass hotspot scheme. After the first round of hotspot detection, we delete all tags falling in the first-pass hotspots. We then compute a second round of hotspots with this deleted background. The hotspots from the first and second passes are then combined, and all are re-scored using the deleted background: the number of tags in each hotspot is computed using all tags, but 50 kb background windows use only the deleted background.

Hotspot peaks. We resolve hotspots into 150 bp DNaseI hypersensitive sites (DHSs), using peak-finding. We compute a sliding window tag density (tiled every 20 bp in 150 bp windows), and then perform peak-finding of the density in each hotspot region. Each 150 bp peak is assigned the z-score from the hotspot that contains it.

FDR calculations using random tags. We assign FDR (false discovery rate) z-score thresholds to a given hotspot peak set using random data. As a null model, we computationally generate tags uniformly over the uniquely mappable bases of the genome. We use the same number of tags for observed and random data. The random data also coalesce into hotspots, which we identify, score, and resolve into peaks using the same technique as for the observed data. For a given z-score threshold T, the FDR for the observed hotspot peaks with z-score greater than T is estimated as

$$FDR ( T ) = \frac{\# of random peaks with z \geq T}{\# of observed peaks with z \geq T} .$$

Since the numerator, which is calculated on a dataset that is entirely null, likely overestimates the number of false positives in the observed data, this is likely a conservative estimate of the FDR.

de novo discovery of footprints While a variety of statistical methods can be used for the de novo discovery of footprints, two competing approaches to denovo discovery are particularly contemplated. a zero-or-one-per-sequence (ZOOPS) method and an any-number (ANR) method. Both methods look for overrepresented subsequences in target sequences relative to background expectation. The differences are the backgrounds used and the philosophies of ZOOPS and ANR methods. For a given nucleotide sequence, the ZOOPS approach counts a particular subsequence at most once toward the observed or background frequency counts, while the ANR approach uses all instances found toward the counts.

A ZOOPS background can be generated by shuffling all bases in each target region with no regard to potential di-nucleotide or higher order structure (a nucleotide independence assumption can be used). A shuffle of a target region only includes the bases within that target region. The number of times every 8-mer occurs across all regions following each shuffle, subject to the ZOOPS constraint can then be counted. A background mean and variance can be generated for each 8-mer. These are used in the calculation of observed motif z-scores. An ordered list of all motifs with a z-score of at least 10 is kept in which one can later cluster to provide a non-redundant list of results. Entries can be kept in descending z-score order.

An ANR background can be generated by counting how many times a motif subsequence occurs in the genome. Similarly, the many times a motif subsequence occurs within the target sequences is counted. An a,c,g or t is assigned at random with equal probability to any unknown base prior to background generation. A p-value can be calculated for each observed motif utilizing the hypergeometric distribution and keep an ordered list of all motifs with an uncorrected p-value less than 0.01, which can later be clustered to provide non-redundant results. Entries can be kept in ascending p-value order.

All 8-mers with 0 to 8 intervening N's in target sequences are searched for. Two examples are aNcNgNtNaNNNNcgt and acgtacgt. The generated motif list can often be large and contain many variants of relatively few motifs. Heuristics can be used to filter and cluster the list, described below, to obtain a non-redundant motif set.

A key item in generating the overrepresented motif list for the ZOOPS approach is that the 8-mer background mean and variance even for motifs with intervening N's be used. Since these statistics are generated from shuffled bases, a conservative and good estimate for motifs with intervening N's is to directly use the same backgrounds and variances calculated for 8-mers.

The ANR approach differs in that all motif instances throughout the genome are directly counted. The first filter simply compares the ordered consensus sequences with no alignment attempt. The highest z-score (lowest p-value) motif is added to the output list. Each subsequent motif is compared to each entry in the output list. If a similar entry is found, the motif is discarded. If no motif in the output list provides a good match, the new motif is added to the bottom of the output list. For two consensus sequences, X and Y, the first character of X is compared to the first character of Y and so on. The number of exact matches, not including matching N's, is accumulated. When two consensus sequences are the same length and their N placeholders are all in the same positions, 1 difference can be allowed to declare similarity. This is in contrast to the 2 differences typically allowed otherwise.

After reversing all motifs in the output list the same ordered filtering is performed to reduce the size of the list further. Motifs passing through this step are reversed once more to create the output. No reverse complements are computed and compared during the initial filtering step. In spite of its simplicity, the initial filter step often helps to reduce the input list's size by orders of magnitude.

The second filtering step also utilizes the consensus sequence representations of the motifs. The sequences are clustered as follows: a list of all consensus sequences analyzed are kept in a comparison list. The topmost motifs consensus sequence are outputted and also added to the comparison list. Each subsequent consensus sequence is compared to each entry in the list as described below. If a similar sequence is found in the list, the consensus sequence under consideration is simply added to the bottom of the comparison list. Otherwise, one adds the consensus sequence to the output, and then add it to the bottom of the comparison list.

During consensus sequence comparisons, all alignment possibilities and reverse complement combinations are considered. Simply count the number of nucleotides that agree in the pairwise comparisons, not including aligning N's. When two consensus sequences are the same length and their N placeholders are all in the same positions when the first bases are aligned, matches are required to declare similarity. Otherwise, one can require 6 matches to declare similarity.

A positional weight matrix (pwm) is constructed for each remaining motifs consensus sequence. Pwms are clusterd as follows: two lists are maintained—an output list and a clustered list. One can add the topmost motifs pwm to the output list. Each subsequent pwm is compared to each entry in the output list as described below. If a similar pwm is found, the pwm under consideration is added to bottom of the clustered list. Otherwise, the pwm is also compared to each entry of the clustered list. Again, if a similar pwm exists, the pwm under consideration is added to the bottom of the list. Otherwise, the pwm is added to the bottom of the output list and passes to the next stage of the process.

During pwm comparisons, all alignment possibilities and reverse complement combinations are considered. Pearson correlation coefficients are calculated, and if any correlation reaches 0.75 or beyond, the pwms are considered similar. Pearson correlation requires equal size pwms so they are padded with samples from the background nucleotide frequency distribution and renormalized as needed. Such padding is not part of the output from this stage of the process. All motif outputs are reverted to their consensus sequence forms.

All work up to this point is with exact matches. Build a pwm for each motif again and allow up to one nucleotide difference from the consensus sequence representation. Again perform pwm clustering comparisons as before. Produce the final list of pwms as the output of the de novo discovery tool.

Although the above is illustrated with DNase I, persons of ordinary skill in the art would appreciate that other nucleases capable of making single strand nicks could be substituted.

Isolation of double hit DNase I fragments can be carried out through a sucrose step gradient set up by a Biomek (Beckman Coulter, Inc.). 9 mls of a 40% sucrose solution (20 mm Tris-Cl (ph 8.0), 5 mM EDTA, 1 M NaCl) was dispensed slowly (˜9.7 ul/s) into the bottom of the tube, followed by 9 mls of a 30, 20 and 10% sucrose solution for each successive layer in a 25×89 mm Beckman, Ultra-Clear Tubes (Beckman Coulter Inc.,).

In vivo DNase I treated K562 DNA (8 million nuclei) can be layered onto the sucrose step gradient and ultracentrifuged for 24 h at 25,000 r.p.m. at 16° C. in a SW21 swinging bucket rotor Beckman LE-80 Ultracentrifuge 77,002 g. Fractionation was performed using a Biomek. Successive 1 ml fractions were removed from the top at ˜9.7 ul/s and dispensed into a 96 deep well plate. DNA fragment size in the fraction was determine by combining 8 ul from each fraction with 2 ul of loading dye and 2 ul of a 1:1,000 dilution of SYBR Green (Invitrogen, Carlsbad, Calif.) and loaded on to a 1% Tris acetate EDTA (TAE) agarose gel, and run at 5 V/cm for 60 minutes. The gel was placed on to a Typhoon 9200 imager (Amersham Biosciences) and imaged. Fractions that contained fragments less than 500 bp were pooled and cleaned using Microcon column according to the manufacturer's protocol (Millipore Corp., Billericar, Mass.). Samples were eluted in 15 ul and quantified using a Qubit following manufacture recommendations (Invitrogen).

### Library Construction

Libraries can be constructed following Ilumina's protocol excepting a few minor modifications. Pooled fragments ranging, for instance, from 100-350 bp can be combined with 1× T4 DNA ligase buffer (0.1 mM ATP) (NEB, New England Biolabs, Ipswich, Mass.), 0.4 mM dNTP mix, 5 U E coli DNA polymerase I Kenow fragment (NEB), and 50 U T4 polynucleotide kinase (NEB). To repair blunt and phosphorylate the ends the reaction can be incubated and DNA was recovered using a micro spin column (Qiagen Inc., Valencia, Calif.). The repaired DNA fragments can, for instance, be adenylated by adding non-templated adenines to the 3′ ends using 1 mM dATP (Sigma) and 5 U klenow fragment (3′-5′ exo-) (NEB) and incubated for a suitable time. After eluting the adenylated DNA through a MinElute column, Illumina adapters can be ligated to the ends of the fragments in a 50 uL reactions comprising of 25 ul 2× Quick DNA ligase buffer (NEB), 17.5 ul adenylated DNA fragments, 2.5 ul adapter oligo mix (Illumina, Hayward, Calif.) and 5 ul Quick DNA ligase (NEB). Ligated Fragments can then be eluted from a MinElute column (Qiagen) after 15 minute incubation at 20 C.

The adapter-ligated DNA can be PCR enriched in a 50 ul reaction containing 15 ul adapter-ligated DNA, 25 ul 2× Phusion High-Fidelity PCR Master Mix (NEB), 8 ul of nuclease free water (Ambion, Austin, Tex.), and the addition of 1 ul of each Illumina primers 1.1 and 1.2 (Illumina, Hayward, Calif.). Several reactions can be performed in parallel under the following thermal cycle profile: 98 C for 30 seconds, 9 cycles of 98 C for 15 seconds, 65 C for 30 seconds and 72 C for 30 seconds followed by 72 C with an extension of 5 minutes. Enriched libraries were quantified using a Qubit (Invitrogen) after purification with a MiniElute micro spin column (Qiagen).

### Hybridization and Elution

Samples can be hybridized to an Agilent 244K custom microarray following Agilent aCGH protocol with several modifications. For instance, 7.5 ug of sample can be dried down in conjunction with 10 ug of Cot-1 DNA (mgl/ml) (Invitrogen) in a speedVac, 30 ul of 2× Agilent aCGH/Chip HI-RPM Hybridization Buffer (Agilent, Santa Clara), 7.5 ul of 10× aCGH Blocking Buffer (Agilent, Santa Clara), 12.0 ul Formamide (Sigma-Aldrich, St. Louis, Mo.) and the addition of 1 ul Illumina blocking oligonucleotides (IDT, Coralville, Iowa.) (400 uM\1 ul) and 23.5 ul molecular grade water (Ambion).

The hybridization mixture can be denatured and transferred and loaded onto a MAUI LC Mixer following Biomicro manufacture protocol (Biomicro). The LC mixer-slide assembly with hybridization mixture was incubated at 55 C for 50 hours on a MAUI Hybridization Station (Biomicro). After hybridization the LC mixer-slide assembly can be immediately dissembled and washed for 5 minutes at 20 C in CGH Buffer #1 (Agilent, Santa Clara) and then further washed in a CGH Wash Buffer #2 (24 hour pre-warmed at 37 C) (Agilent, Santa Clara). Slides can then be dried by centrifugation for 30 seconds and Secure-Seal SA2260 (GRACE Bio-Labs, Bend, Oreg.) secured to the active side of the array following Secure-Seal recommendation (GRACE Bio-Labs,). The Slide-Secure-Seal assembly can be incubated with 850 ul nuclease-free water (Ambion) for 5 minutes at 95 C in a Nimblgen elution station and eluted. The 5 minute incubation and elution can be repeated one more time followed by an additional 1 minute incubation and elution. Eluted samples can be dried in a speedVac and resuspended in 10 ul of nuclease-free water (Ambion).

The array eluted material can be amplified in about 50 ul reactions comprising of 20 ul eluted material, 25 ul 2× Phusion High-Fidelity PCR Master Mix (NEB), 3 ul of nuclease free water, and the addition of 1 ul of each Illumina primers 1.1 and 1.2 (Illumina, Hayward, Calif.). Reactions were performed under the following thermal cycle profile: 98 C for 30 seconds, 12 cycles of 98 C for 15 seconds, 65 C for 30 seconds and 72 C for 30 seconds followed by 72 C with an extension of 5 minutes. Enriched libraries can then be quantified using a qubit (Invitrogen) after purification with a MiniElute micro spin column (Qiagen).

For the Illumina sequencer (preferred instrument, currently) libraries are loaded onto a flow cell using an Illumina cluster station. The process is described in any number of publications, including Quail, M A et al., Nat. Methods. 2008 December; 5(12):1005-10, which is incorporated by reference with respect to such sequencing methods and systems. solution hybridization procedures, these can also be found in the Agilent SureSelect user's guide entitled SureSelect Target Enrichment System Illumina Single-End Sequencing Platform Library Prep Protocol Version 1.2, April 2009, which is incorporated herein by reference with respect to same.

### EXAMPLES

The following examples are provided by way of illustration only and not by way of limitation. Those of skill in the art will readily recognize a variety of non-critical parameters that could be changed or modified to yield essentially the same or similar results.

### Example 1

### Yeast

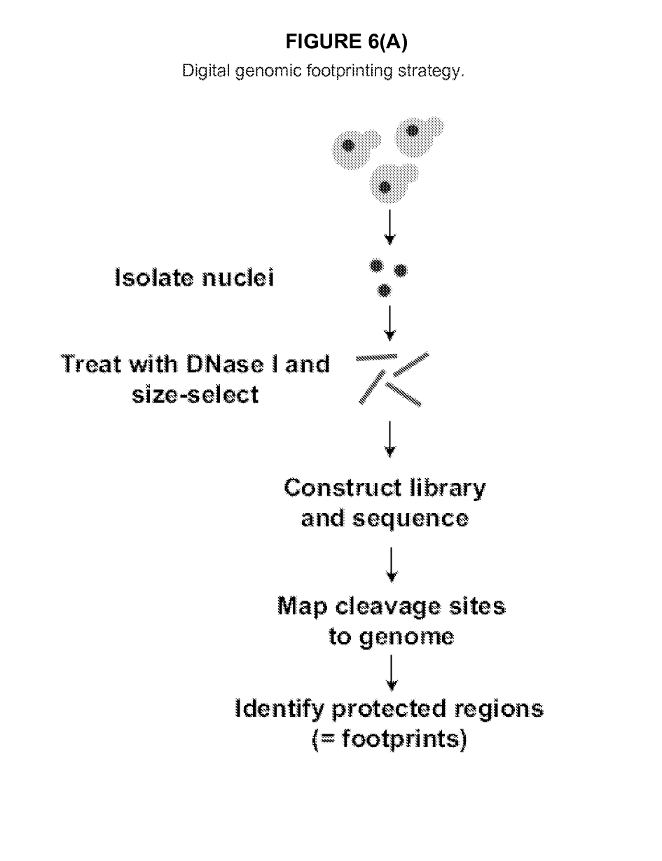

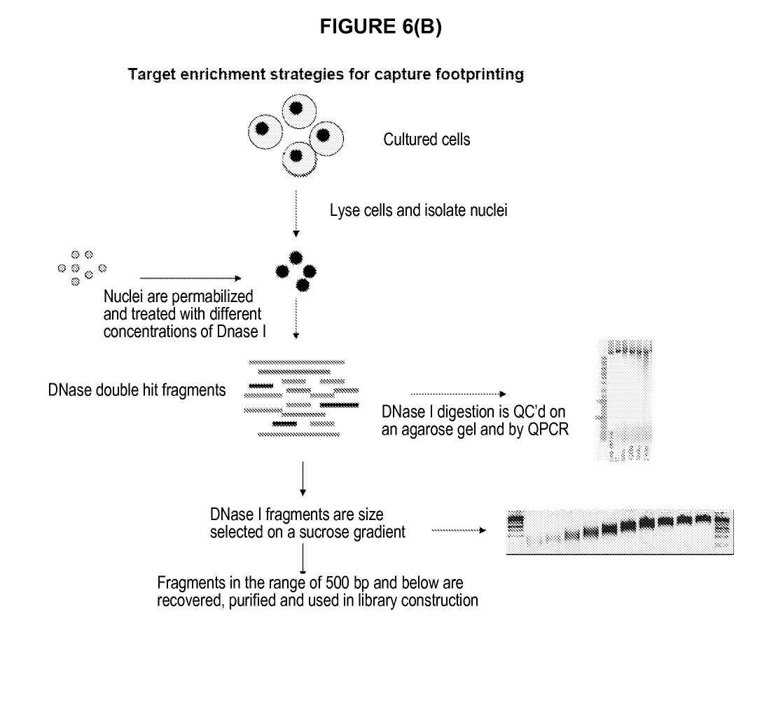

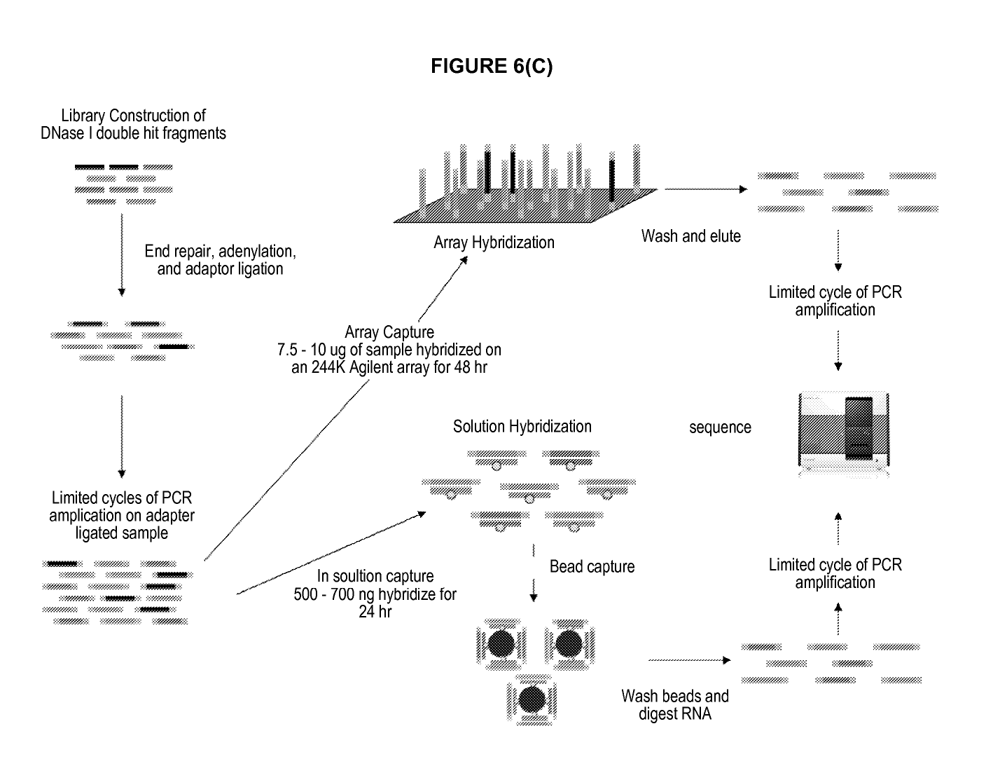

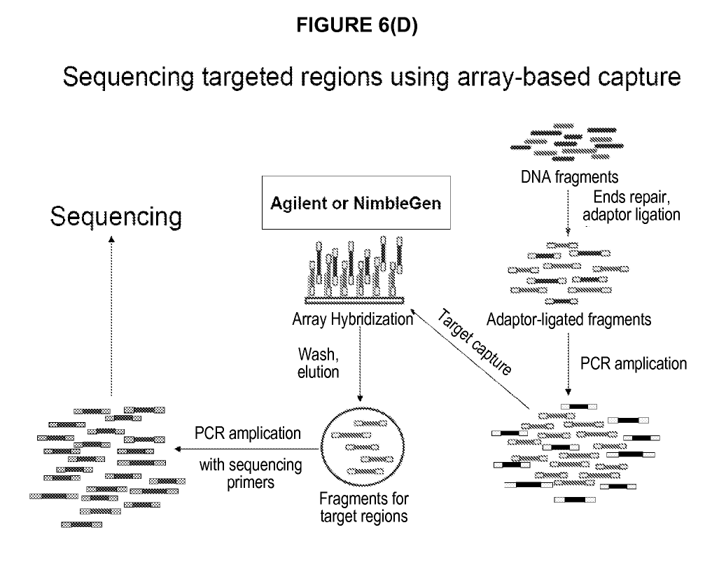

The digital genomic footprinting strategy. To visualize regulatory protein occupancy across the genome of Saccharomyces cerevisiae, the inventor coupled DNase I digestion of yeast nuclei with massively parallel DNA sequencing to create a dense whole-genome map of DNA template accessibility at nucleotide-level. The inventor analyzed a single well-studied environmental condition, yeast a cells treated with the pheromone α-factor, which synchronizes cells in the G1 phase of the cell cycle. The inventor isolated yeast nuclei and treated them with a DNase I concentration sufficient to release short (<300 bp) DNA fragments while maintaining the bulk of the sample in high molecular weight species (FIG. 6). These small fragments derive from two DNase I “hits” in close proximity, and therefore their isolation minimizes contamination by single fragment ends derived from random shearing⁸. Because each end of the released DNase I ‘double-hit’ fragments represents an in vivo DNase I cleavage site, the sequence and hence genomic location of these sites can be readily determined by sequencing (Methods, below).

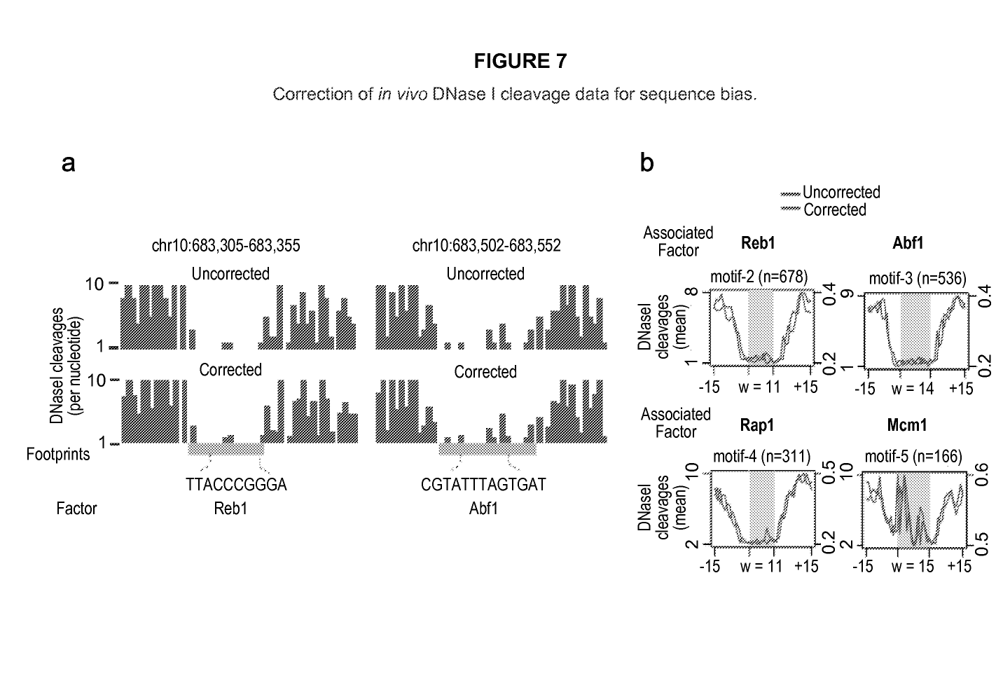

Using an Illumina Genome Analyzer, the inventor obtained 23.8 million high-quality 27 bp end-sequence reads that could be localized uniquely within the S. cerevisiae genome following filtering for duplicated sequences such as telomeric regions, transposable elements, tRNA genes, rDNA genes, and other paralogous elements (see, Methods below). The DNase I cleavages mapped by these 23.8 million sequences were confined to 6.4 million unique positions within the yeast genome. The inventor computed both the density of DNase I cleavage sites across the genome using a 50 bp sliding window, as well as the number of times that individual nucleotide positions had been cleaved by DNase I (per nucleotide cleavage). To control for possible DNase I cleavage bias at particular nucleotide combinations, the inventor carried out a parallel experiment with naked DNA from the same cells digested to yield an equivalent fragment size distribution. 3.27 million DNase I cleavages were mapped to distinct genomic positions, from which background cleavage rates for all possible dinucleotide pairs flanking (i.e., tetranucleotides straddling) the DNase I cleavage sites were computed (Table 1). These background propensities were then used to normalize the per nucleotide cleavage counts obtained from in vivo DNase I treatment (FIG. 7, Methods).

TABLE 1
Dinucleotide cleavage biases. Relative cleavage between all
possible dinucleotide pairs computed from DNase I
treatment of naked DNA.

| Dinucleotide | Correction |
|---|---|
| AA/TT | 1.27381 |
| TA | 1.23985 |
| AT | 1.08111 |
| CA/TG | 1.01544 |
| AG/CT | 0.997834 |
| AC/GT | 0.913321 |
| GA/TC | 0.874718 |
| CG | 0.713588 |
| GC | 0.575804 |
| CC/GG | 0.52281 |

Systematic identification of DNase I footprints. Data from an exemplary 100 kb region (FIG. 1a) showed that regional peaks in DNase I cleavage density concentrate in yeast intergenic regions (FIG. 1b), where they coincide with contiguous stretches of individual nucleotides that had been struck repeatedly by DNase I (FIG. 1c). Within the upstream regions of yeast genes, individual nucleotide positions were cleaved tens to hundreds of times.

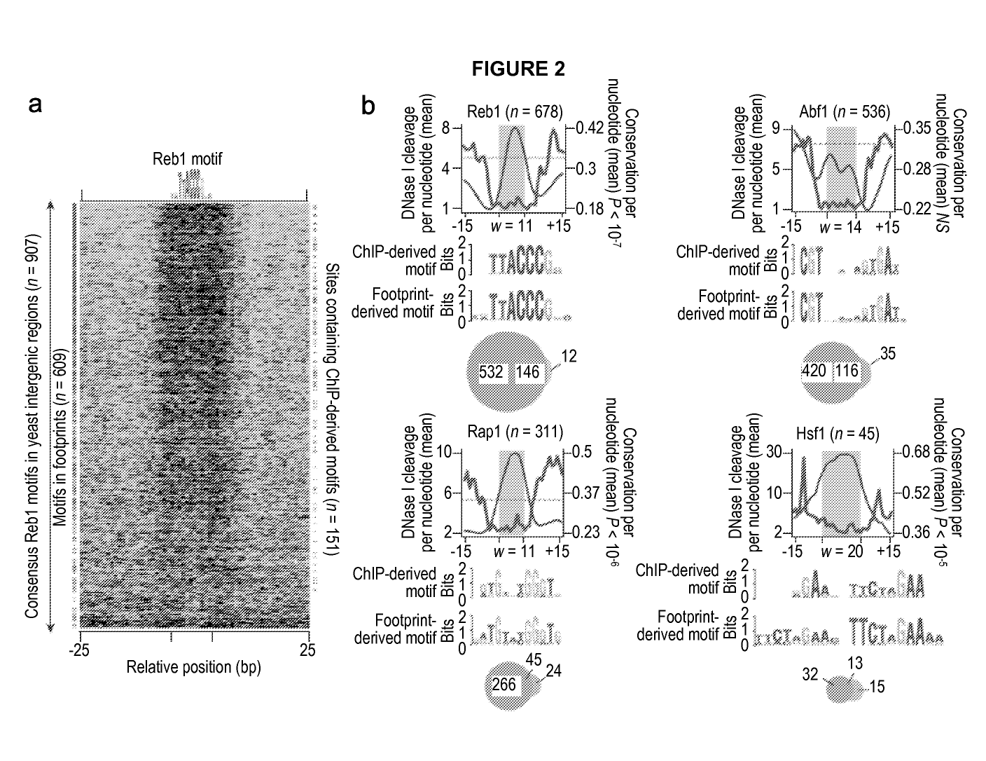

On close inspection, the inventor observed that DNase I cleavage patterns upstream of transcriptional start sites (TS Ss) were punctuated by short stretches of protected nucleotides consistent with the footprints of DNA-binding proteins, and that in many cases individual footprints could be matched to known DNA-binding motifs (FIG. 1d). The inventor also examined the degree to which computationally predicted factor binding sites within yeast intergenic regions exhibited DNase I protection. For any given factor, computational predictions are expected to contain a mixture of true- and false-positive sites. FIG. 2a shows the DNase I cleavage patterns surrounding 907 computationally-predicted⁹ Reb1 binding sites (+/−25 bp) within yeast intergenic regions, ranked by the ratio of DNase I cleavage flanking the motif to that within the motif. This analysis showed that a significant proportion of predicted Reb1 sites exhibited DNase I protection consistent with protein binding in vivo and, moreover, that the DNase I protection patterns were specifically localized to the motif region. Analogous patterns for other motifs were observed, with considerable variation in the fraction of computationally predicted motif instances that evidenced DNase I protection (data not shown), commensurate with the expectation that many (if not most) binding sites predicted from motif scans alone are not actuated in vivo.

To detect footprints systematically across the yeast genome, the inventor developed a computational algorithm to identify short regions (between 8 and 30 bp) over which the DNase I cleavage density was significantly reduced compared with the immediately flanking regions (Methods). To assess statistical significance and compute a false discovery rate (FDR) for footprint predictions, predictions were compared with a randomly shuffled local background distribution (Methods). Using this approach, 4,384 footprints were identified within the intergenic regions of the yeast genome at a false discovery rate of 5% (FDR=0.05, not shown). At least one FDR=0.05 footprint was identified in the proximal promoter region of 1,778 genes, with 630 genes harboring two or more footprints. At a false discovery rate of 10%, the inventor identified 6,056 footprints distributed across 2,929 gene promoters, with 1,048 of them evincing >2 footprints.

Identification of sequence motifs in DNase I footprints. The 4,384 FDR=0.05 footprints were categorized by deriving sequence motifs de novo using MEME⁹, and comparing the results with previously-described factor-binding motifs. The predicted numbers of in vivo binding sites across the yeast genome for different regulators vary by nearly two orders of magnitude¹⁰. However, MEME readily recovered high-quality motifs corresponding to many important yeast regulators including Reb1, Abf1, Hsf1, Rap1, Mcm1, and Cbf1 (Table 2 and Methods).

TABLE 2
Motif matches to major regulators. TOMTOM comparison of motifs
discovered de novo with previously annotated factor binding
motifs. Columns correspond to footprint-derived motif; the
associated transcription factor; the E-value (Bonferroni
corrected); the factor consensus from ChIP data; the factor
consensus from footprint data; and the corresponding matching
strand (i.e. the footprint-derived motif is a reverse complement
for minus-strand matches).

| | Associated | Corrected | | | |
|---|---|---|---|---|---|
| Motif ID | Factor | E-value | Factor Motif | Footprint Motif | Strand |
| motif-6 | ABF1 | 2.44E−12 | CGTATAAAGTGATA | TCGTGCATAGTGATA | − |
| motif-4 | SFP1 | 2.03E−08 | GATGTATGGGTG | ATGTACGGGT | + |
| motif-4 | RAP1 | 1.32E−07 | GATGTATGGGTG | GTGTATGGGTGT | − |
| motif-7 | MCM1 | 7.79E−07 | TTCCCAAAAAGGAAA | TTTCCCAATCGGGAAA | − |
| motif-10 | HSF1 | 1.72E−06 | TTTTCTAGAATGTTCT | TTCTAGAACGTTCC | − |
| | | | AGAA | | |
| motif-2 | REB1 | 7.03E−06 | TGTTACCCGGA | TTACCCGG | + |
| motif-4 | FHL1 | 2.86E−05 | GATGTATGGGTG | ATGTACGGGT | + |
| motif-7 | YOX1 | 3.07E−05 | TTCCCAAAAAGGAAA | CATTACGTTTCCTAAAA | + |
| | | | | GGG | |
| motif-26 | CBF1 | 0.000120748 | GATCACGTGAC | CACGTGAC | − |
| motif-18 | PDR3 | 0.00155217 | TTTCCGCGGAA | TCCGCGGA | + |
| motif-16 | UME6 | 0.00225848 | AGCCGCCGAAG | TAGCCGCCGA | + |

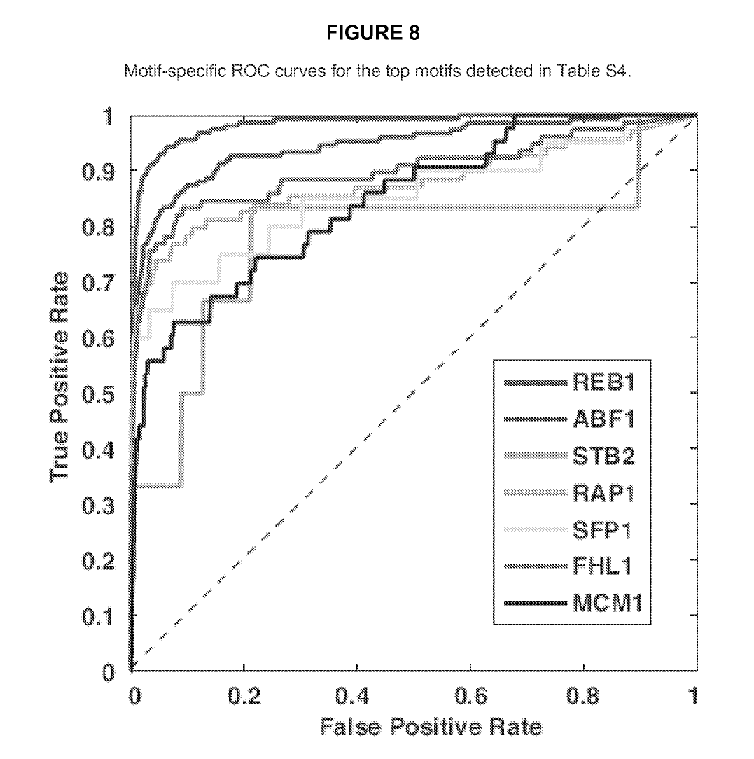

Beyond the factor binding sequences recovered de novo using relatively stringent thresholds, footprints were significantly enriched (vs. yeast intergenic regions generally) for a broad range of regulators (Table 3), indicating that the footprinted space was densely populated with previously recognized protein binding sites. Collectively, 35.2% of the FDR=0.05 footprints overlapped an occurrence of a conserved factor binding site inferred from ChIP data¹⁰. To assess the effect of stringently thresholded footprint detection, the inventor computed factor motif-specific receiver-operator characteristic (ROC) curves for a variety of regulators (FIG. 8). All curves were well above the diagonal, indicating strong enrichment of previously-recognized factor binding sites near the P<0.05 threshold. This observation implies that many additional real sites exist in the data and simply do not meet the selected detection threshold.

TABLE 3
Numbers of occurrences of ChIP-defined motifs in
the identified footprints. Each row lists the
name a known TF binding motif, the number of its
occurrences in the footprints, the number of
footprints in which that motif appears, as well
as the enrichment of the motif in the footprints
with respect to the yeast intergenic regions. The
motif occurrences are identified with a q-value
threshold 0.05.

| | | Number of | |
|---|---|---|---|
| | | footprints | |
| | Occurs | in which | |
| Transcription | within | motif | |
| Factors | footprints | appears | Enrichment |
| REB1 | 591 | 573 | 13.36 |
| ABF1 | 533 | 516 | 10.98 |
| STB2 | 452 | 445 | 15.51 |
| RAP1 | 286 | 259 | 7.29 |
| SFP1 | 223 | 203 | 13.41 |
| FHL1 | 204 | 187 | 11.23 |
| MCM1 | 129 | 82 | 5.3 |
| YRR1 | 56 | 56 | 8.15 |
| AZF1 | 48 | 47 | 1.2 |
| TYE7 | 30 | 22 | 4.1 |
| CBF1 | 30 | 22 | 4.27 |
| HSF1 | 28 | 21 | 4.76 |
| PDR3 | 24 | 11 | 4.84 |
| SNF1 | 20 | 18 | 2.11 |
| STP1 | 14 | 13 | 3.32 |
| GAL80 | 14 | 7 | 1.51 |
| STP4 | 12 | 11 | 2.62 |
| ASH1 | 12 | 11 | 4.12 |
| UME6 | 11 | 11 | 1.27 |
| SNT2 | 11 | 11 | 1.51 |
| YOX1 | 10 | 9 | 3.04 |
| UGA3 | 10 | 5 | 3.47 |
| PUT3 | 8 | 8 | 2.55 |
| YDR520C | 6 | 5 | 2.66 |
| RGT1 | 6 | 6 | 1.69 |
| SKN7 | 5 | 5 | 2.52 |
| RFX1 | 5 | 4 | 1.54 |
| LEU3 | 5 | 3 | 4.28 |
| DAL81 | 5 | 5 | 3.45 |
| HAP4 | 4 | 4 | 1.26 |
| GAL4 | 4 | 3 | 1.22 |
| IXR1 | 3 | 3 | 2.31 |
| ARO80 | 2 | 1 | 1.66 |

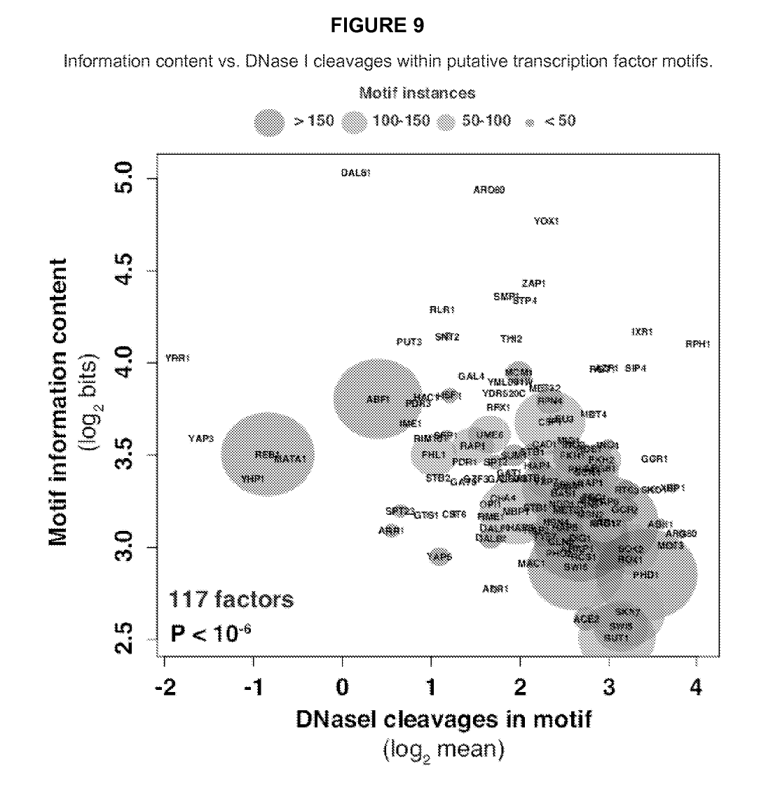

Since footprints identified at the FDR=0.05 level are well-distinguished from their local background, it was speculated that these might be generally enriched in factors with strong binding specificities, while many more weakly binding factors might not have yet achieved requisite coverage depth for detection using our algorithm. In both cases, it was predicted that protection of the underlying DNA sequence from nuclease attack should be roughly inversely proportional to the binding affinity of the overlying regulatory factors. To test this, the inventor compared the information content (a measure of the size and complexity of the predicted binding site¹⁰) of 117 known factor motifs with the level of DNase I protection within all predicted matches of each motif genome-wide, and found them to be significantly anticorrelated (P<10⁻¹⁶; FIG. 9). This result suggested that high information content of a binding site was a good predictor of the affinity of a factor for its cognate DNA sequences, and consequently its propensity to generate footprints detectable at the FDR=0.05 level given the current depth of sequence sampling. The result also indicates that weaker motifs should be progressively recovered at deeper levels of DNase I cleavage sampling whereupon their cognate footprints may become reliably distinguished from the background.

To visualize consensus nucleotide-level DNase I protection patterns for motifs corresponding to the most abundant footprints, the inventor computed aggregate per-nucleotide DNase I cleavage and evolutionary conservation (PhastCons¹¹) across all instances of each motif (FIG. 2b,c). This showed that several footprint-derived consensus sequences were more information-rich than prior predictions based on inference from ChIP and conservation data alone (FIG. 2b,c)^{10,12}. For example, the previously-characterized motif weight matrix for Reb1 spans 8 nucleotides¹⁰, whereas the footprint-derived consensus fine-tunes the motif core and extends it an additional 3 nucleotides (FIG. 2b). Similarly, the de novo-derived motif for Cbf1 contains two additional nucleotides 5′ of the E-Box core (FIG. 3b), supporting results from protein-binding microarrays¹³. In some cases, such as Hsf1, the de novo footprint-derived motif is substantially more complex than previous predictions (FIG. 2c).

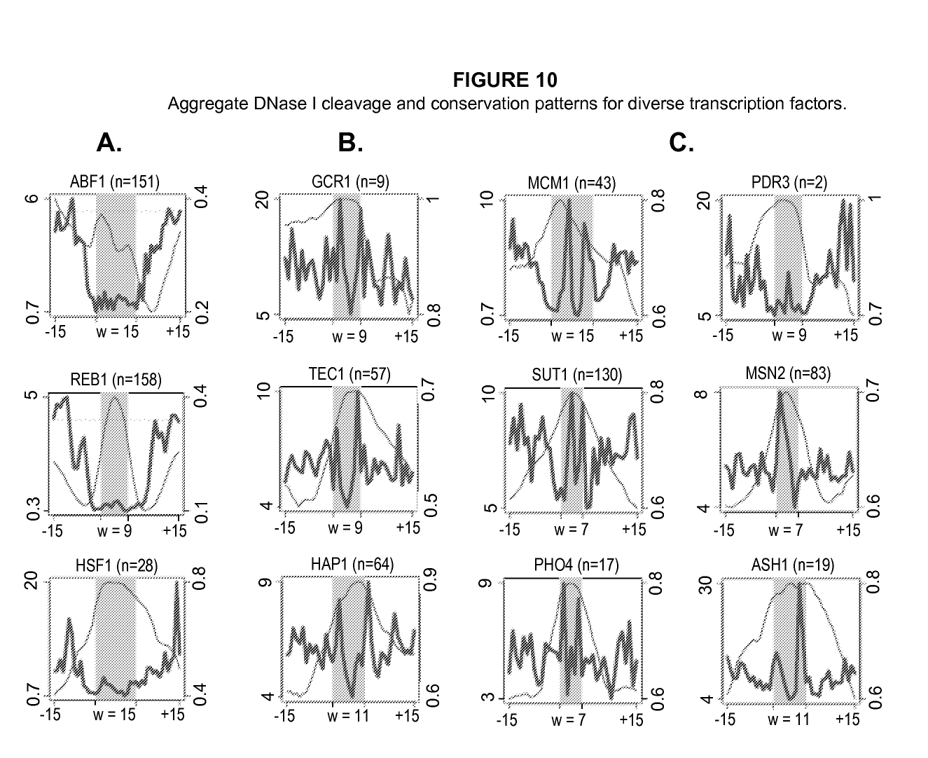

It was observed that nucleotide-level DNase I protection closely parallels evolutionary conservation for virtually all factors, further attesting to the significance of the footprints and their derived cognate motifs (FIG. 2a,b,c). The width of the conserved region is typically broader than the span of previously-derived consensus sequence, but matches closely the footprint-derived consensus. To assess the significance of the aggregate conservation patterns for each motif, the inventor used a permutation approach to compare the observed patterns to random samples from yeast intergenic regions (FIG. 2b,c and Methods). These calculations confirmed the significance of the patterns seen for factors such as Reb1, Rap1, Mcm1 and others (FIG. 10), paralleling previous results from analyses of factor binding sites across yeast species^{14,15.} Although the majority of individual footprints genome-wide were well-conserved, many lacked significant conservation, consistent with the known potential for some sites to undergo rapid evolutionary turnover¹⁶.

In comparison with binding site catalogues based on ChIP and conservation data'°, digital footprinting revealed 678 Reb1 sites vs. the 158 previously predicted; 536 vs. 151 Abf1 sites; and 311 Rap1 footprints vs. 42 previously predicted¹⁰ (FIG. 2b,c). These discrepancies are partly a reflection of the statistical significance thresholds applied both to earlier and the present data, though they suggest an important contribution of condition-specific binding.

DNA ‘structural motifs’ parallel protein-DNA interactions. A striking feature of the DNase I cleavage and protection profiles for many factors is the presence of complex patterns within and surrounding the derived consensus motif sequence. For example, Mcm1 sites display a characteristic multi-phasic cleavage pattern, with three short protected regions alternating with two accessible regions (FIG. 3a). Analogously, Cbf1 sites evince a broad protected region with a central zone of accessibility (FIG. 3b). It was surmised that these and other stereotypical ‘structural motifs’ reflected patterns of interaction of each factor with the DNA helix. To examine this in detail, the inventor aligned the nucleotide-level DNase I accessibility motifs, the corresponding sequence motifs, and co-crystal structures of Mcm1¹⁷ and a Cbf1 homolog¹⁸ (FIG. 3a,b), This revealed striking correspondence between mean nucleotide-level DNase I accessibility and the pattern of protein:DNA contacts. Mcm1 is a MADS box factor that binds DNA through long α-helices that make numerous contacts along the major groove¹⁷. Mcm1 binding introduces significant bends into the DNA helix, which distort the opposing minor grooves, rendering them more susceptible to nuclease attack¹⁹. These effects are evident in the nucleotide-level cleavage patterns which show a concentration of nuclease attack opposite the Mcm1 alpha helices (FIG. 3a). Similarly, in the case of the helix-loop-helix protein Cbf1, alignment of the DNase I cleavage profile to the crystal structure of the human homologue (which shares the same DNA-binding residues) reveals protection of nucleotides by the opposite alpha helices, separated by a central region of increased accessibility (FIG. 3b). Taken together, these data suggest that the mean nucleotide-level DNA accessibility patterns derived from digital genomic footprinting of specific factors represent structural motifs that parallel protein:DNA interactions in vivo.

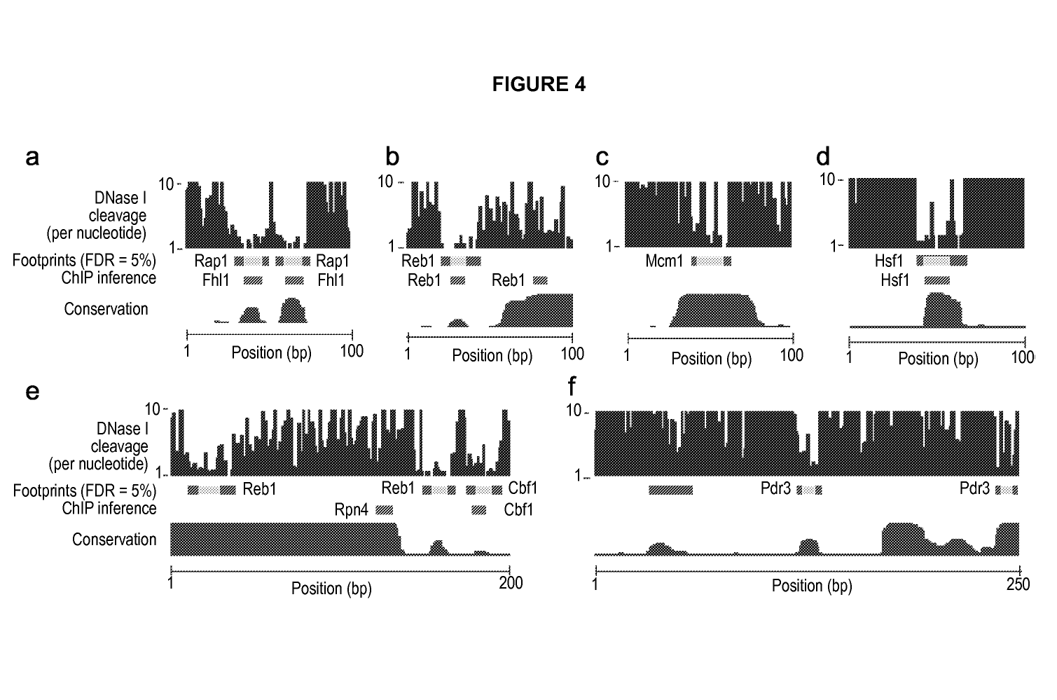

Footprints in individual regulatory regions. Digital genomic footprinting data are sufficiently dense to enable analysis of regulatory factor occupancy patterns at the level of individual regulatory regions. The examples in FIG. 4a-j provide snapshots of a diverse population of regulators and binding site contexts. In many cases, high-confidence footprints agree with previous predictions for specific regulators (FIG. 4a,b,d,e,g). However, the inventor also observed numerous examples of discordance (FIG. 4c,e), possibly reflecting condition-specific binding. For example, at the REB1 promoter (FIG. 4e), footprints were detected at two previously-identified evolutionarily-conserved Reb1 binding sites²⁰, neither of which were identified under conditions used in prior ChIP experiments. Conversely, ChIP data annotated a nearby Rpn4 site that does not fall within an FDR=0.05 footprint.

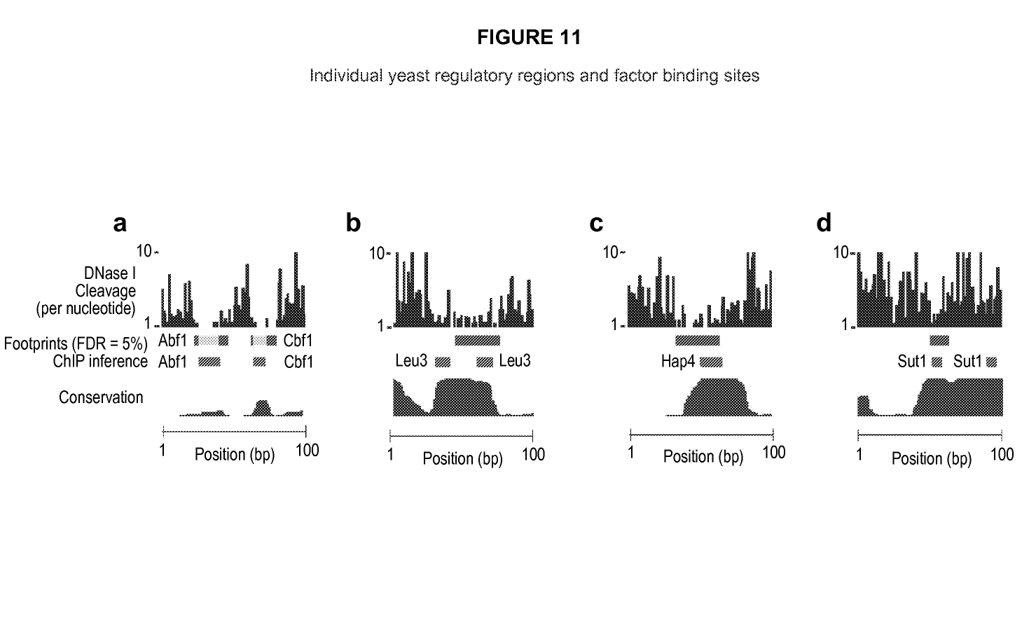

The data also illustrate considerable variability in the degree to which a given regulator protects different cognate recognition sites (compare pairs of Rap1, Reb1, and Pdr3 sites in FIG. 4a,e, and f, respectively). In some cases, the identification of footprints matching characterized regulators could be used to revise gene annotations. For example, the inventor identified a Rap1 site upstream of RPS30B that is situated within the hypothetical open reading frame for FYV12. However, the marked DNase I sensitivity and general lack of evolutionary conservation within this region suggest that FYV12 is not a gene but rather the promoter of the neighboring RPS30B (FIG. 11).

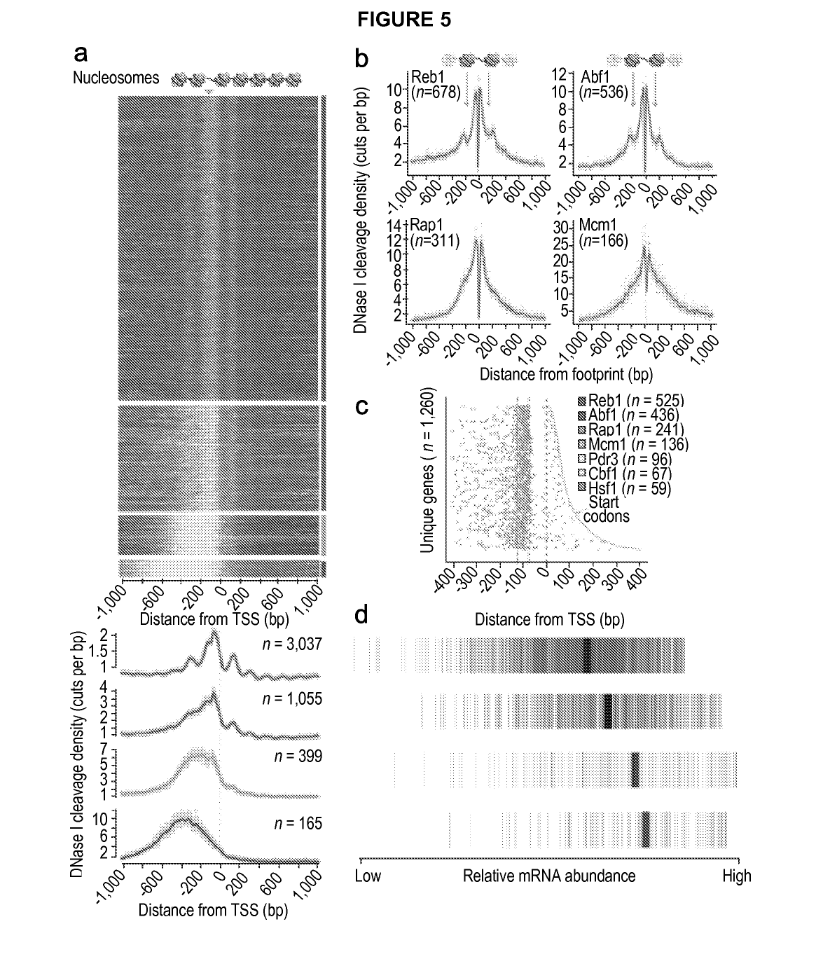

High-resolution mapping of chromatin architecture. The inventor next sought to visualize patterns of DNase I cleavage and protection at the level of extended promoter domains. The inventor extracted DNase I cleavage data from −1 kb to +1 kb intervals around the TSSs of ˜5,000 yeast genes and performed hierarchical clustering (FIG. 5a). This revealed that that 93% of yeast genes could be organized into four distinct clusters, ranging from low (red cluster) to high (purple) mean chromatin accessibility (FIG. 5a). For genes in the red cluster, chromatin accessibility was maximal over the −100 region, visualized in FIG. 5a as a prominent central vertical yellow stripe. Even at this resolution, a ˜10 bp footprint centrally positioned within the −100 region could be discerned at a surprising proportion of genes (FIG. 5a). A prominent feature of the DNase I cleavage patterns is the presence of regular undulations in accessibility, with a period of ˜175 bp symmetrically flanking the central high-accessibility zone (FIG. 5a). This pattern is consistent with the presence of phased nucleosomes. It was further observed that the periodic pattern emanated from the boundaries of the central high-accessibility region, even though this region varied in size between the four clusters. This observation suggested that phased nucleosomes were in fact distributed relative to central sites occupied by factors. To explore further the relationship between nucleosome-level features and factor occupancy, the inventor examined the long-range distribution of DNase I cleavages surrounding footprints of individual regulators across the genome. The distribution of DNase I cleavages relative to footprints for Reb1 and Abf1 revealed periodic undulations, consistent with phased nucleosome arrays symmetrically distributed relative to the factor-binding sites. However, Rap1 and Mcm1 exhibited less prominent patterns (FIG. 5c), suggesting that some factors (e.g. Reb1 and Abf1) have a more determinative role in establishing chromatin architecture at promoters²¹. Collectively, these data are consistent with statistical positioning of nucleosomes relative to factor binding-induced ‘barrier’ events^{22,23}.

It was also observed that the binding of many factors appears to be positionally constrained relative to transcriptional start sites. For six factors (Reb1, Abf1, Rap1, Mcm1, Cbf1, and Pdr3), footprints exhibit tight clustering into a ˜50 bp zone centered ˜100 bp upstream of the TSS (FIG. 5b). Furthermore, the region immediately 3′ to the −100 region is generally depleted of footprints (FIG. 5b), consistent with the presence of a positioned nucleosome. These results are compatible with the existence of a common focal point for the organization of promoter architecture of a substantial fraction of yeast genes^{23,24}.

High-resolution chromatin architecture and gene expression. The inventor next asked whether the four chromatin structural clusters (FIG. 5a) were correlated with expression of their constituent genes. It was found that the average expression level of genes from each cluster increases monotonically with the extent of chromatin disruption upstream of the TSS (FIG. 5d). This organization is most readily explained by the size of the domain over which factor binding takes place. For the genes in the red cluster, factor binding is largely restricted to the −100 region, with a prominent −1 nucleosome around −200. By contrast, for genes in the blue cluster, the accessible factor-binding region extends from the TSS to approximately −360, with a 5′ shift in the −1 nucleosome. For genes in the green and purple clusters, the factor-binding region extends to −450 bp and −750, respectively. Taken together, these observations suggest that, rather than simple gain or loss of an upstream nucleosome²⁴⁻²⁷, high expression of yeast genes may involve increases in both the number and longitudinal extent of regulatory factors bound in the upstream region. Conversely, many genes expressed at a low level nonetheless exhibited high chromatin accessibility across their promoter regions, with attendant footprints indicative of factor binding. The existence of such promoters parallels reports of binding by well-described regulators such as Heat Shock Factor (Hsf1), Ga14, Abf1 and Pdr1/Pdr3 under conditions in which they do not activate transcription²⁸. These results emphasize the heterogeneous nature of factor binding and consequent control of gene expression, requiring gene-level analyses of factor occupancy.

### METHODS

Detection of Footprints within Digital DNase I Data

Footprints were identified using a computational algorithm that evaluates short regions (between 8 and 30 bp) over which the DNase I cleavage density was significantly reduced compared with the immediately flanking regions (Methods). FDR thresholds were assigned by comparing p-values obtained from real and shuffled cleavage data.

### Yeast Strain and Culture Conditions

S. cerevisiae R276 (MATa ura3Δ0 leu2Δ0 his3Δ1met15Δ0 bar1ΔΔ::KanMX) (C. Boone, University of Toronto; S288c background derived from BY4741), was cultured overnight in 50 ml rich medium (YPD) at 30° C., diluted into 500 ml fresh YPD to an OD₆₆₀ of ˜0.8, and treated with yeast α-factor (Sigma-Aldrich) at a final concentration of 50 ng/ml. The culture was incubated at 30° C. with shaking for 3 hours (final OD₆₆₀ ˜1). After this treatment, approximately 90% of the cells had formed mating projections when checked by light microscopy.

### Yeast Nuclei Extraction

The yeast nuclei extraction protocol was adapted from a previous method with minor modifications (Kizer, K. O., Xiao, T. & Strahl, B. D. Accelerated nuclei preparation and methods for analysis of histone modifications in yeast. Methods 40, 296-302 (2006)). Briefly, yeast cells were harvested by centrifugation for 5 minutes at 3,000×g and washed once with cold deionized water. The cell pellet was resuspended in 4.5 ml spheroplasting buffer (SB: 1 M sorbitol, 50 mM potassium phosphate (pH 6.5), 0.018% β-mercaptoethanol). Cells were pelleted by centrifugation, and the pellet was washed once more with cold SB. The cell pellet was then resuspended in 4.5 ml pre-warmed SB with Zymolyase 20T (MP Biomedical) at 40 U/ml and incubated at 30° C. for 45 minutes with occasional mixing. After Zymolyase treatment, the cells were pelleted and washed once with 10 ml cold SB. This cell pellet was resuspended in 25 ml lysis buffer (LB: 18% Ficoll 400, 20 mM potassium phosphate (pH 6.8), 1 mM CaCl₂, 0.5 mM EDTA (pH 8.0), 3 mM DTT, 1 mM PMSF, 2 mM Benzamidine, 0.5 μg/ml Leupeptin, and 1.5 μg/ml Pepstatin). Cells were lysed on ice with 20 strokes of a Dounce homogenizer using pestle A. Lysed cells were centrifuged at 3,000×g for 10 minutes at 4° C. The supernatant was collected into a clean centrifuge tube and pelleted at 6,700×g for 10 minutes. The supernatant was collected once again and centrifuged at 50,000×g for 35 minutes at 4° C. The supernatant was carefully removed and the pellet, consisting of mainly yeast nuclei, was used for further analysis.

### DNase I Digestion of Yeast Chromatin

The DNase I digestion protocol was adapted from a previous study (Sabo, P. J. et al. Genome-scale mapping of DNase I sensitivity in vivo using tiling DNA microarrays. Nat Methods 3, 511-8 (2006)). Freshly made yeast nuclei were carefully resuspended in 2.5 ml cold Buffer A (15 mM Tris-HCl (pH 8.0), 15 mM NaCl, 60 mM KCl, 1 mM EDTA (pH 8.0), 0.5 mM EGTA, 0.5 mM spermidine and 11% sucrose) by gentle swirling and agitation. Nuclei were counted by light microscopy and the yield in a typical experiment was estimated to be 2×10⁹ nuclei per preparation. Ten 250 μL aliquots of nuclei were then distributed into eppendorf tubes. For each DNase I reaction, the nuclei suspension was pre-warmed at 37° C. for 1 minute, then quickly mixed with 250 μl pre-warmed 2× reaction buffer (Buffer A with 12 mM CaCl₂, 150 mM NaCl) and diluted DNase I (Roche Applied Science, Catalog #04716728001) to attain final concentrations of DNase I at 20, 15, 10, 7.5, 5, 3.75, 2.5, 1.875 and 0 U/ml. The reaction was incubated at 37° C. in water bath for 3 minutes, and then terminated by the addition of 500 μl stop solution (50 mM Tris-HCl (pH 8.0), 100 mM NaCl, 0.1% SDS, 100 mM EDTA (pH 8.0), 10 μg/ml Ribonuclease A, 1 mM spermidine, 0.3 mM spermine). Proteinase K as added to 20 μg/mL and the reaction was incubated at 55° C. overnight. Aliquots (10 μl) of the digested samples were run on 1% agarose gels (Argarose LE) to check digestion quality and determine the DNase I concentration at which a very small portion of genomic DNA was digested and a smear under the major high molecular weight band just began to appear. A concentration of 20 U/mL DNase I was chosen to proceed with size fractionation and library construction for sequencing.

### Size Fractionation of DNase I Double-Hit Fragments

Samples were size fractionated by sucrose gradient centrifugation to obtain fragments that were cleaved on both ends by DNase I, also referred to as DNase I double-hit fragments (DDHF). To accomplish this, the protocol described by Sabo et al. (2006) was used with minor modification. Fragments of 100-500 bp in length were recovered by sucrose fractionation and purified using micro spin columns (Qiagen). Fragments were quantified using PicoGreen stain (Invitrogen, Carlsbad, Calif.) and a Nanoprop 3300 fluorospectrometer (Thermo Scientific, Waltham, Mass.).

### Construction of Digital DNase I Libraries for Sequencing

Digital DNase I libraries were constructed according to Illumina's genomic prep kit protocol with minor modifications. 50 ng of purified DNase double-hit fragments (100-500 bp) were subjected to end repair by combining fractionated DNA, 1× T4 DNA ligase buffer (containing 0.1 mM ATP), 0.4 mM dNTP mix, 15 U T4 DNA polymerase, 5 U DNA polymerase (Klenow, large fragment) and 50 U T4 polynucleotide kinase (all from New England Biolabs, Ipswich, Mass.). The reaction mixture was incubated at 20° C. for 30 minutes and purified using a MinElute micro spin column (Qiagen). Following end-repair, non-templated adenines were added to the 3′ ends of purified fragments with 1 mM dATP and 5 U Klenow fragment (3′-5′ exo-) (NEB) and incubated at 37° C. for 30 minutes. After column purification, Illumina adapters were ligated to the ends of DNA fragments in a 50 uL reaction by combining 17.5 μL ‘A’-tailed fragments, 25 ul 2× Quick DNA ligase buffer (NEB), 2.5 μL adapter oligo mix (Illumina, Hayward, Calif.) and 5 uL Quick DNA ligase (NEB) and incubating the mixture for 15 minutes at room temperature. Ligations were purified with MinElute columns (Qiagen).

Adapter-ligated DNA fragments were enriched by amplification. 50 uL reactions consisting of 5 ul adapter-ligated DNA, 25 ul 2× Phusion High-Fidelity PCR Master Mix (NEB), 0.5 ul each of primer 1.1 and 2.1 (Illumina, Hayward, Calif.) and 19 uL nuclease-free water were assembled and cycled with the following thermal profile: 98° C. for 30 min., followed by 16 cycles of 98° C. for 10 min, 65° C. for 30 min. and 72° C. for 30 minutes with a final extension at 72° C. for 5 minutes. Amplified libraries were purified with a MinElute micro spin column (Qiagen) and quantified using PicoGreen stain (Invitrogen) and a Nanoprop 3300 fluorospectrometer (Thermo Scientific, Waltham, Mass.).

### Sequencing of Digital DNase I Libraries

DDHF libraries were sequenced by the University of Washington High-Throughput Genomics Unit to produce 27 bp reads according to standard sequencing-by-synthesis methodology on an Illumina Genome Analyzer (GA1). Resulting sequence data were evaluated and aligned to the reference genome using the ELAND aligner (Illumina, Hayward, Calif.). A stringent quality filter was applied, and only high-quality uniquely mapping reads were used in the analysis. To facilitate visualization of our data, the inventor mapped processed reads to the October 2003 build of the S. cerevisiae genome, which is the current version available in the UCSC Genome Browser (Karolchik, D. et al. The UCSC Genome Browser Database: 2008 update. Nucleic Acids Res 36, D773-9 (2008)).

### Computation of Uniquely Mappable Nucleotide Positions in the Yeast Genome

To exclude false-positive footprint identification due to aggregations of non-uniquely mapping bases, a suffix array approach was used to generate a genome-wide map of uniquely mappable 27 bp DNA segments, as previously described (Mann, T. P. & Noble, W. S. Efficient identification of DNA hybridization partners in a sequence database. Bioinformatics 22, e350-8 (2006)). First, the inventor inspected each 27 bp sequence in the reference yeast genome sequence. If the sequence only occurred once in the genome, the 27 corresponding bases were flagged as unique. The entire genome was traversed in this manner, and all constituent overlapping 27 bp segments were accumulated. This output resulted in a genome-wide ‘map’ of scores ranging from 0 to 27, with a score of 0 meaning a location was not occupied by any unique 27 bp segment, and 27 was a location occupied by 27 unique and overlapping 27 bp segments. These data were used to determine appropriate local background statistics for identification of footprints (see below).

Total RNA Preparation and mRNA Expression Analysis

Total RNA from alpha-factor treated cells was isolated using hot acidic phenol (Schmitt, M. E., Brown, T. A. & Trumpower, B. L. A rapid and simple method for preparation of RNA from Saccharomyces cerevisiae. Nucleic Acids Res 18, 3091-2 (1990). 50 μg of total RNA was treated with Turbo DNase (Ambion), and checked for integrity using a Bioanalyzer 2100 (Agilent). Total RNA was labeled according to the manufacturer's protocol and applied to Affymetrix Yeast 2.0 arrays. Data were analyzed using the “affy” package from Bioconductor (Gautier, L., Cope, L., Bolstad, B. M. & Irizarry, R. A. affy—analysis of Affymetrix GeneChip data at the probe level. Bioinformatics 20, 307-15 (2004)). Data from these experiments are available from the NCBI GEO⁷ under accession GSE11412 (Barrett, T. & Edgar, R. Gene expression omnibus: microarray data storage, submission, retrieval, and analysis. Methods Enzymol 411, 352-69 (2006)).

### Purification and DNase I Digestion of Naked DNA

High molecular weight yeast DNA was purified by transferring the 0 unit DNase I control sample to a phase lock tube (Eppendorf). An equal volume of Tris buffer saturated phenol, pH 8.0 was added to the sample and mixed by gently inverting for 5 minutes. The sample was centrifuged for 5 minutes at 12,000×g to separate the phases. An equal volume of chloroform was added to sample and the sample was again mixed by inverting for 5 minutes and centrifuged for 5 minutes at 12,000×g. The sample was transferred to a clean tube and the DNA precipitated by adding 1/0th volume of 3 M NaOAc and 2 volumes of ethanol. The DNA pellet was washed with 70% ethanol and dried in a speed vac. 200 ul of TE pH 8.0 was added to the pellet and the DNA was allowed to re-suspend for several days at 4 C. A serial dilution of DNase I, Roche Molecular, was setup in 2× DNase I buffer, (12 mM CaCl, 165 mM NaCl, 60 mM KCl, 15 mM Tris-Cl pH 8.0, 1 mM EDTA, 0.5 mM EGTA, 0.5 mM Spermidine). The DNase I concentration ranged from 100 units/ml to 1.56 units/ml. An equal volume of the 2× DNase I was added to purified DNA (˜50 ng/μl). The sample was digested for 3 minutes at 37 C and the reaction stopped by adding 1/10th volume of 50 mM EDTA. The sample was run out on a 2% TAE agarose gel to identify the DNase I concentration that would result in DNA fragments ranging from ˜0.1 to 10 kb. That concentration was found to be 12.5 units/ml. That reaction was scaled up to 200 μA and the repeated. The digested sample from that prep was run on a 9% sucrose gradient identical to that used to purify the DNA fragments in the DNase I chromatin prep. The fraction containing fragments 500 bp and smaller were cleaned up and made into libraries for Solexa sequencing. Sequences were aligned to the October 2003 build of the S. cerevisiae genome and filtered for non-uniquely mapping reads and for duplicate tags, providing a total of 3,268,943 unique cleavage positions distributed across the genome.

### Computing DNase I Dinucleotide Cleavage Bias

In order to correct for potential weak sequence-based biases in DNase I cleavage, the inventor analyzed the aforementioned 3.27 million cleavage positions from naked S. cerevisiae DNA. Individual sites of DNase I cleavage were determined by inspecting the six bases comprising the three 5′-most bases of the sequencing read, in addition to the 3 bases upstream of the read. The bond between the dinucleotide at the center of this 6-mer (i.e. the 5′-most base of the read and the base 5′ of the read) was selected as the site of DNase I cleavage. Frequencies for all dinucleotides were calculated and compared to the genomic dinucleotide frequences to derive relative cleavage propensity factors (Table 1). These factors were used to correct the observed levels of cleavage from DNase I-treated chromatin samples for the specific dinucleotide sequence combinations flanking each cleavage site.

Detection of Footprints within Digital DNase I Data

Footprints were identified using the following algorithm. The inventor took as input the locations of all uniquely mapping 27 bp tags relative to the reference genome, and assigned the element Fᵢ to indicate the number of tags that occur at genomic position i. In addition, a parallel vector f of Booleans were received. The entry fᵢ indicates whether the tag beginning at the ith position is uniquely mappable. No tags occur at positions that are not uniquely mappable; i.e., if fᵢ=0, then Fᵢ=0. In addition to the DNase I tag data, the inventor received as input a collection of intergenic regions. Finally, the inventor also received as input two parameters, kₘᵢₙ and kₘₐₓ, which specified the size range of the footprints to be returned by the algorithm.

Given these inputs, the inventor searched for footprints of sizes 8-30 bp. The goal of the algorithm was to return a ranked list of non-overlapping footprints, with each associated with a statistical confidence score. For the score, the q value was used, which is defined as the minimal false discovery rate threshold at which a footprint would be deemed significant (Storey, J. D. & Tibshirani, R. Statistical significance for genomewide studies. Proc Natl Acad Sci USA 100, 9440-5 (2003)).

In outline, the inventor's approach consisted of three phases. In the first phase, the inventor considered every possible window of width kₘᵢₙ through kₘₐₓ that was contained within one of the specified target regions, and then computed a depletion score for each of these regions. In the second phase, the inventor selected high-scoring windows using a greedy algorithm, eliminating from consideration any window that overlapped a window with a higher score. Finally, in a third phase, the inventor shuffled the input data independently within each target region and repeated the entire procedure, using the resulting scores to estimate q values. The three steps are described in more detail below.

The depletion scoring routine considered all window sizes within the specified range and all genomic positions lying within the specified target regions. For a given window, if x tags were observed within the window, then the inventor computed the probability of observing x or fewer tags, assuming that the tags were drawn at random from a uniform background distribution. The parameters of this background distribution were estimated from a fixed-width window of 150 bp around the current position. This approach can be expressed intuitively as follows: “Given that we observed B tags within a target region of width b, if we assume that the tags are uniformly distributed, then what is the probability that a window of size a within the target region will contain x or fewer tags.” This probability was computed using a binomial distribution as follows:

$$Pr ( S \leq x \vert {H}_{0} ) = {\sum }_{t = 0}^{x} ( \begin{matrix}B \\ t\end{matrix} ) {( \frac{a}{b} )}^{t} {( 1 - \frac{a}{b} )}^{B - t}$$

where a is the effective window size, b is the effective background window size, and B is the number of tags in the background window. Here, “effective window size” is defined as the specified window size minus the total number of unmappable positions within the window. In practice, the tag data are distributed quite non-uniformly; therefore, in order to reduce the “spikiness” in the data and to normalize for variations in overall tag density, the inventor first rank-transformed the tag counts within each 150 bp window, ignoring non-uniquely mappable positions, and then computed x, a, b and B.

The depletion scoring routine assigned scores to overlapping windows. Therefore, the inventor subsequently applied a greedy selection procedure to choose a non-overlapping set of high-scoring windows. The greedy selection procedure comprised two sequential components: (1) sorting of all depletion scores in increasing order (i.e., most significant to least significant), and (2) traversing the sorted list, accepting scored windows that did not overlap a previously accepted window. This procedure returned a ranked list of scored, non-overlapping windows.

To associate a q value with each of the depletion scores reported by our algorithm, the inventor proceeded as follows. Superficially, the binomial scores are p values, which in principle might render conversion to q values straightforward using established statistical methods. However, the greedy selection procedure induces a bias, resulting in p values that are not uniform with respect to the null model. Indeed, because of the relatively ad hoc nature of the greedy selection procedure, it is not obvious how to compute p values analytically. The inventor therefore utilized an empirical null model, created by shuffling the DNase I tag data and then repeating the depletion scoring and greedy selection procedure on the shuffled data. This enabled direct conversion of any depletion score x to a corresponding FDR by dividing the number of scores better than x in the shuffled data by the number of scores better than x in the real data. This calculation also included a multiplicative correction for the number of greedily selected windows identified in the real and shuffled data sets.

A further complicating factor was that the rate of DNase I cleavage varies from one genomic region to another. Therefore, as mentioned previously, when the inventor created the shuffled null, tags were shuffled only within a given enclosing locus. Notably, the shuffling was carried out at the level of genomic positions, rather than with respect to individual tags.

In other words, if 57 tags were observed at one position in the real data, then after shuffling those 57 tags were observed at some other position. Software and data used for this analysis are available at http://noble.gs.washington.edu/proj/footprinting/.

De Novo Discovery and Matching of Motifs from DNase I Footprints

The inventor used FDR 5% footprints (n=4,384) for de novo motif discovery. Prior to discovery, the boundaries of the start and stop coordinates were increased by 10 bp up- and downstream, in order to include potentially overlapping motifs at the footprint boundaries. The inventor then used MEME (Bailey, T. L. & Elkan, C. Fitting a mixture model by expectation maximization to discover motifs in biopolymers. Proc Int Conf Intell Syst Mol Biol 2, 28-36 (1994)) to identify 100 overrepresented motifs in this set of sequences. Using FIMO (from the MEME package), the motifs reported by MEME were then used to search the original set of sequences, in order to identify all motif instances within the sequences. In order to avoid including motif instances falling outside of the initial footprint boundaries, the inventor post-processed the motif instances by eliminating those for which more than half of the motif width was found in the 10 bp up- and downstream that the inventor initially added to the sequences. Motifs discovered de novo were assigned to putative factors using TOMTOM (Gupta, S., Stamatoyannopoulos, J. A., Bailey, T. L. & Noble, W. S. Quantifying similarity between motifs. Genome Biol 8, R24 (2007)), searching against a set of 117 previously defined motifs based on a combination of chromatin immunoprecipitation and evolutionary conservatio n data (MacIsaac, K. D. et al., An improved map of conserved regulatory sites for Saccharomyces cerevisiae. BMC Bioinformatics 7, 113 (2006)). The results of this comparison are available in Table 2.

### Computing Significance of Per Nucleotide Conservation Profiles

The inventor tested the hypothesis that the mean (aggregated) phastCon conservation score profile of an observed motif differed significantly from the null mean, calculated from the background of randomly-selected pseudo-motif instances across intergenic regions of the yeast genome. The inventor did not make assumptions about the conservation score distributions, and therefore applied a non-parametric permutation test. An application (permTest) was developed to perform an approximate, one-sided Fisher's exact permutation test on the distributions of “control” (random background) and “treatment” (observed motif) conservation scores. In addition, a second hypothesis test was conducted that the variances of the motif and random background regions differed significantly, through an empirical calculation derived by the same permutation events.

Difference of means. For a given observed factor (represented as a set of coordinates across a given genome; for example, BED coordinates derived from fimo runs on footprint calls), the inventor:
1. Calculated the mean value of phastCon conservation scores across each of n observed coordinate pairs (μ_{O1}, μ_{O2}, . . . , μ_{On})
2. Generated m random coordinate pairs, sampled from the genome (or a subset of it; here, intergenic regions).
3. Calculated the mean value of phastCon conservation scores across each of m randomly generated coordinate pairs (μ_{R1}, μ_{R2}, . . . , μ_{Rm})
4. Calculated μₙ and μₘ, the means of observed and random phastCon scores, respectively.
5. Calculated θₙᵤₗₗ=μₙ−μₘ
6. Combined the n and m observations into one ordered, labeled set S.

The following testing procedure was then repeated B times on set S:
1. Permute set S, shuffling the n and m labels while leaving the values in the same initial order
2. Given the new labeling, calculate a new μₙ* and μₘ*
3. Calculate θ_{shuffled}=μₙ*−μₘ*

These B permutations generated θ_{shuffled1}, θ_{shuffled2}, . . . , θ_{shuffledB}. Our approximate p-value pₐₚₚᵣₒₓ is the fraction of θ_{shuffled} greater than or equal to θₙᵤₗₗ:

pₐₚₚᵣₒₓ=[#{θshuffledb}≧θₙᵤₗₗ]/B

The value pₐₚₚᵣₒₓ is the probability of observing θₙᵤₗₗ or greater when the null hypothesis is true. For T number of transcription factors being tested, the inventor calculated a Bonferroni-corrected α_{corrected}=α/T. If pₐₚₚᵣₒₓ≦α_{corrected}, then rejected the null hypothesis and concluded that the given factor's conservation score is significantly different from the background.

Ratio of variances. For a given factor, the inventor calculated the observed test statistic for motif (n) and random (m) sequences:

vₙᵤₗₗ=log(σ² ₙ/σ²ₘ)

Using the same shuffling mechanism as for the difference of means (see above), the inventor permuted the order of the set S and derive a new v_{shuffledb} for f b=1 . . . B permutations. The inventor derived the p-value for this variance test as the fraction of v_{shuffledb} that is greater than or equal to vₙᵤₗₗ. If this p-value was less than or equal to α_{corrected}, it was then concluded that the variances of the motif scores differed significantly from the background score variance.

Analysis of ChIP Motif Enrichment within Footprints

The inventor searched the FDR=0.05 (n=4,384) footprints for sequences that match the factor binding motifs identified by MacIsaac et al. using the motif scanning tool FIMO. At a q-value threshold of 0.05, 35.2% of the 4,384 footprints overlap by >50% an occurrence of a MacIsaac motif. Table 3 lists the number of occurrences of each MacIsaac motif and the number of footprints that contain the motif. Table 3 also lists the enrichment of each motif in the footprints relative to the yeast intergenic regions. For this analysis, the footprints and the yeast intergenic regions were scanned respectively against the MacIsaac motifs at a p value threshold of 10⁻⁵. The enrichment of a motif is defined as the ratio between the average number (per base pair) of occurrences of the motif in the footprints and that in the intergenic regions. Notably, all motifs in the table show an enrichment greater than 1.0. Furthermore, some motifs, including STB2, SFP1, REB1, FHL1, and ABF1, have more than 10-fold enrichments. These enrichment results indicate that the footprints are densely populated with protein binding motifs.

### Analysis of DNase I Cleavage Density Relative to Transcription Start Sites

Transcription start sites (n=5,016) derived from tiling array experiments (David, L. et al., A high-resolution map of transcription in the yeast genome. Proc Natl Acad Sci USA 103, 5320-5 (2006)) were downloaded from the supplement to reference (Lee, W. et al. A high-resolution atlas of nucleosome occupancy in yeast. Nat Genet. 39, 1235-44 (2007)), and the coordinates of these segments were mapped onto the October 2003 build of the S. cerevisiae genome; the inventor was able to successfully map 5,006 of the original segments. The number of DNase I cleavage events were then calculated for 1000 bp up- and downstream of these start sites, ignoring non-uniquely mappable positions. These data were clustered using Cluster (de Hoon, M. J., Imoto, S., Nolan, J. & Miyano, S. Open source clustering software. Bioinformatics 20, 1453-4 (2004)), employing k-means clustering with cluster size 10 and 40 repetitions. Clustered data were visualized using Java Treeview (Saldanha, A. J. Java Treeview—extensible visualization of microarray data. Bioinformatics 20, 3246-8 (2004)). The four major clusters contain 93% of the input genes.

### Example 2

### Human

Method for Agilent Array Capture (Based on K₅₆₂ Globin Array Experiments) Isolation of DNase I fragments

Isolation of double hit DNase I fragments was carried out through a sucrose step gradient set up by a Biomek (Beckman Coulter, Inc.). 9 mls of a 40% sucrose solution (20 mm Tris-Cl (ph 8.0), 5 mM EDTA, 1 M NaCl) was dispensed slowly (˜9.7 ul/s) into the bottom of the tube, followed by 9 mls of a 30, 20 and 10% sucrose solution for each successive layer in a 25×89 mm Beckman, Ultra-Clear Tubes (Beckman Coulter Inc.,).

In vivo DNase I treated K562 DNA (8 million nuclei) was layered onto the sucrose step gradient and ultracentrifuged for 24 h at 25,000 r.p.m. at 16 C in a SW21 swinging bucket rotor Beckman LE-80 Ultracentrifuge 77,002 g. Fractionation was performed using a Biomek. Successive 1 ml fractions were removed from the top at ˜9.7 ul/s and dispensed into a 96 deep well plate. DNA fragment size in the fraction was determine by combining 8 ul from each fraction with 2 ul of loading dye and 2 ul of a 1:1,000 dilution of SYBR Green (Invitrogen, Carlsbad, Calif.) and loaded on to a 1% Tris acetate EDTA (TAE) agarose gel, and run at 5 V/cm for 60 minutes. The gel was placed on to a Typhoon 9200 imager (Amersham Biosciences) and imaged. Fractions that contained fragments less than 500 bp were pooled and cleaned using Microcon column according to the manufacturer's protocol (Millipore Corp., Billericar, Mass.). Samples were eluted in 15 ul and quantified using a Qubit following manufacture recommendations (Invitrogen).

### Library Construction

Libraries were constructed as previously described following Ilumina's protocol except for few minor modifications. A total of 500 ng of pool fragments ranging from 100-350 bp were combined with 1× T4 DNA ligase buffer (0.1 mM ATP) (NEB, New England Biolabs, Ipswich, Mass.), 0.4 mM dNTP mix, 5 U E coli DNA polymerase I Kenow fragment (NEB), and 50 U T4 polynucleotide kinase (NEB). To repair blunt and phosphorylate the ends the reaction was incubated at 20 C for 30 minutes and DNA was recovered using the MinElute micro spin column (Qiagen Inc., Valencia, Calif.). The repaired DNA fragments were subjected to adenylation by adding non-templated adenines to the 3′ ends using 1 mM dATP (Sigma) and 5 U klenow fragment (3′-5′ exo-) (NEB) and incubated at 37 C for 30 minutes. After eluting the adenylated DNA through a MinElute column, Illumina adapters were ligated to the ends of the fragments in a 50 uL reactions comprising of 25 ul 2× Quick DNA ligase buffer (NEB), 17.5 ul adenylated DNA fragments, 2.5 ul adapter oligo mix (Illumina, Hayward, Calif.) and 5 ul Quick DNA ligase (NEB). Ligated Fragments were eluted from a MinElute column (Qiagen) after 15 minute incubation at 20 C.

The adapter-ligated DNA was PCR enriched in a 50 ul reaction containing 15 ul adapter-ligated DNA, 25 ul 2× Phusion High-Fidelity PCR Master Mix (NEB), 8 ul of nuclease free water (Ambion, Austin, Tex.), and the addition of 1 ul of each Illumina primers 1.1 and 1.2 (Illumina, Hayward, Calif.). Several reactions were performed in parallel under the following thermal cycle profile: 98 C for 30 seconds, 9 cycles of 98 C for 15 seconds, 65 C for 30 seconds and 72 C for 30 seconds followed by 72 C with an extension of 5 minutes. Enriched libraries were quantified using a Qubit (Invitrogen) after purification with a MiniElute micro spin column (Qiagen).

### Hybridization and Elution

Samples were hybridized to an Agilent 244K custom microarray following Agilent aCGH protocol with several modifications. 7.5 ug of sample was dried down in conjunction with 10 ug of Cot-1 DNA (mgl/ml) (Invitrogen) in a speedVac, 30 ul of 2× Agilent aCGH/Chip HI-RPM Hybridization Buffer (Agilent, Santa Clara), 7.5 ul of 10× aCGH Blocking Buffer (Agilent™, Santa Clara), 12.0 ul Formamide (Sigma-Aldrich, St. Louis, Mo.) and the addition of 1 ul Illumina blocking oligonucleotides (IDT, Coralville, Iowa.) (400 uM\ 1 ul) and 23.5 ul molecular grade water (Ambion).

Hybridization mixture was denatured for 3 minutes at 95 C and incubated at 37 C for 30 minutes and placed in a 55 C MAUI heat block (Biomicro, Salt Lake City, Utah) for an additional 10 minutes. Hybridization mixture was transferred and loaded onto a MAUI LC Mixer following Biomicro manufacture protocol (Biomicro). The LC mixer-slide assembly with hybridization mixture was incubated at 55 C for 50 hours on a MAUI Hybridization Station (Biomicro). After hybridization the LC mixer-slide assembly was immediately dissembled and washed for 5 minutes at 20 C in CGH Buffer #1 (Agilent, Santa Clara) and proceeded for a 1:30 minute wash at 37 C in aCGH Wash Buffer #2 (24 hour pre-warmed at 37 C) (Agilent, Santa Clara). Slides were dried by centrifugation for 30 seconds and Secure-Seal SA2260 (GRACE Bio-Labs, Bend, Oreg.) was secured to the active side of the array following Secure-Seal recommendation (GRACE Bio-Labs,). Slide-Secure-Seal assembly was incubated with 850 ul nuclease-free water (Ambion) for 5 minutes at 95 C in a Nimblgen elution station and eluted. The 5 minute incubation and elution was repeated one more time followed by an additional 1 minute incubation and elution. Eluted samples were dried in a speedVac and resuspended in 10 ul of nuclease-free water (Ambion).

The array eluted material was amplified in 50 ul reactions comprising of 20 ul eluted material, 25 ul 2× Phusion High-Fidelity PCR Master Mix (NEB), 3 ul of nuclease free water, and the addition of 1 ul of each Illumina primers 1.1 and 1.2 (Illumina, Hayward, Calif.). Reactions were performed under the following thermal cycle profile: 98 C for 30 seconds, 12 cycles of 98 C for 15 seconds, 65 C for 30 seconds and 72 C for 30 seconds followed by 72 C with an extension of 5 minutes. Enriched libraries were quantified using a qubit (Invitrogen) after purification with a MiniElute micro spin column (Qiagen).

### Example 3

TABLE 4
No. footprints detected in five human cell lines as accomplished by deep-
sequencing of hotspots. Core footprints are disjoint and the following statistic was optimized
at each base.

Footprint Statistic = (C + 1)/L + (C + 1)/R
C = mean tag counts in core footprint
L = mean tag counts in left flanking region
R = mean tag counts in right flanking region
For these analyses:
Each of L and R has a range of 3-10 bps
C has a range of 6-40 bps

Tag Levels were:

| | |
|---|---|
| GM06990.DS7748 | 148,665,129 |
| HepG2.DS7764 | 165,417,704 |
| K562.DS9767 | 158,355,647 |
| SKNSH.DS8482 | 187,549,355 |
| TH1.DS7840 | 175,837,038 |

FDR Method Randomly shuffle tags within each hotspot.
FDR = E(FP/(FP + TP))~E(FP)/E(FP + TP)~(#randoms/#observes)

| No. Footprints Detected | FDR.0p001 | FDR.0p005 | FDR.0p01 | FDR.0p05 |
|---|---|---|---|---|
| GM06990.DS7748 | 282,214 | 398,864 | 406,722 | 631,300 |
| HepG2.DS7764 | 302,723 | 404,148 | 459,937 | 611,400 |
| K562.DS9767 | 353,808 | 491,785 | 569,195 | 790,064 |
| SKNSH.DS8482 | 364,464 | 501,704 | 571,101 | 764,049 |
| TH1.DS7840 | 309,045 | 439,849 | 513,318 | 715,579 |
| FDR vs. Statistic | FDR.0p001 | FDR.0p005 | FDR.0p01 | FDR.0p05 |
| GM06990.DS7748 | 0.77775 | 0.89130 | 0.94790 | 1.09995 |
| HepG2.DS7764 | 0.78405 | 0.89010 | 0.94640 | 1.09770 |
| K562.DS9767 | 0.78745 | 0.89995 | 0.95725 | 1.11695 |
| SKNSH.DS8482 | 0.78785 | 0.90325 | 0.95890 | 1.11075 |
| TH1.DS7840 | 0.77030 | 0.87965 | 0.93715 | 1.08820 |

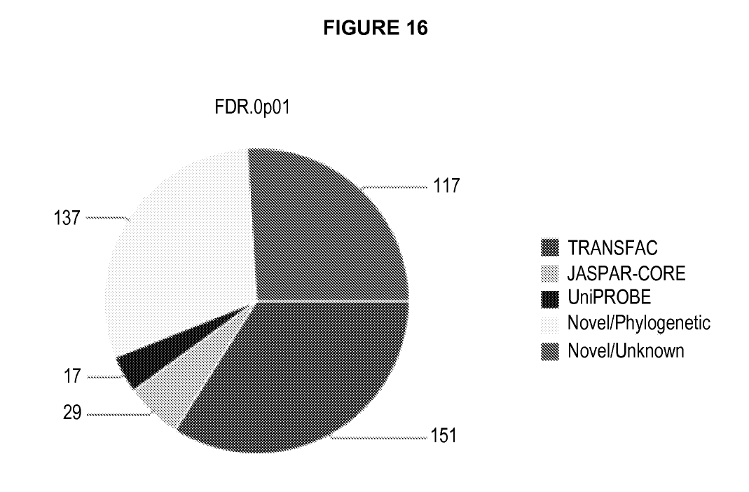

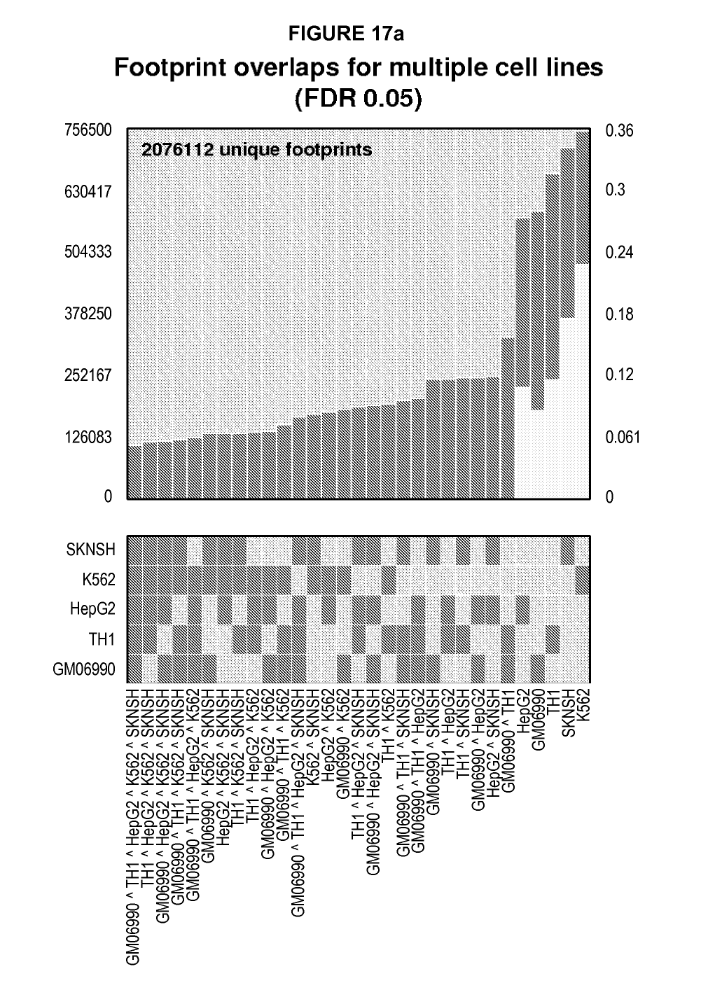

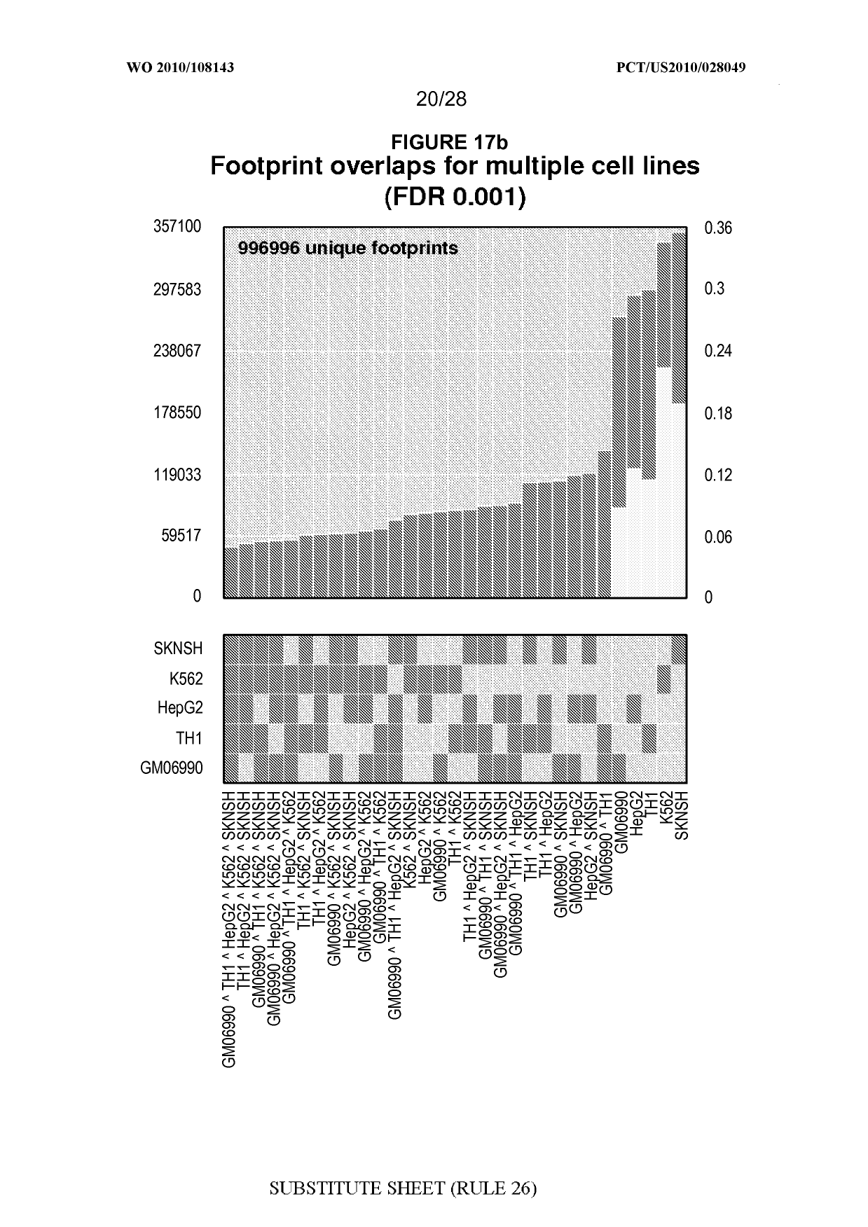

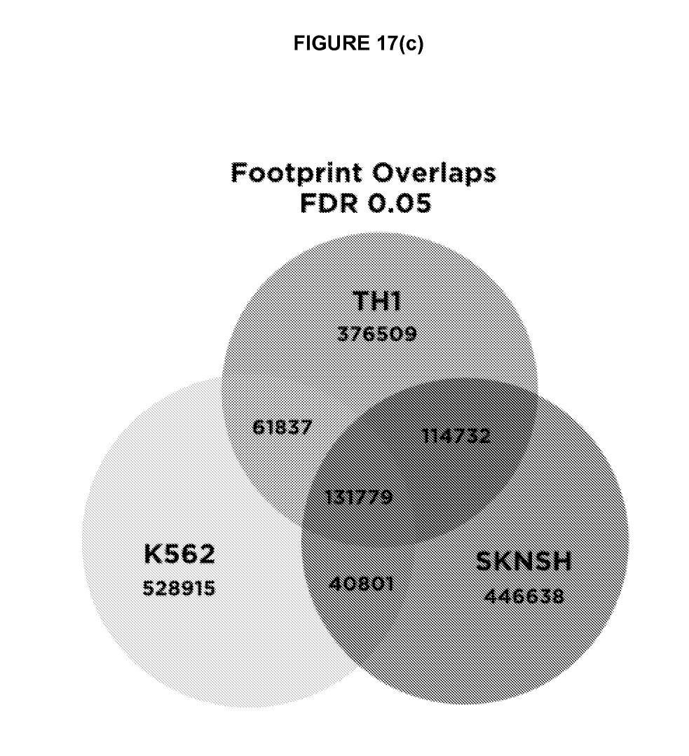

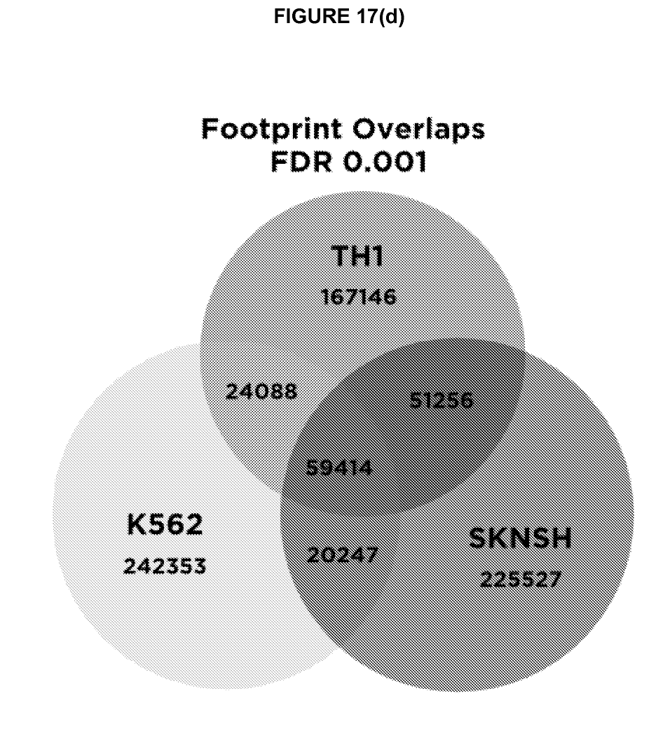

FIG. 16 illustrates the relative number of the known and novel footprints. FIG. 17 demonstrate the numbers and relative frequency of overlapping hotspots between cell types.

Table 5 provides and accounting of distal and promoter footprints for single cell types:

| | | |
|---|---|---|
| Promoter | Distal | Non-promoter |

FDR.0p001

| | | | |
|---|---|---|---|
| K562.DS9767 | 85,227 | 182,893 | 268,581 |
| SKnSH.DS8482 | 115,832 | 155,515 | 248,632 |
| TH1.DS7840 | 110,524 | 106,797 | 198,521 |
| GM06990.DS7748 | 110,476 | 84,693 | 171,738 |
| HepG2.DS7764 | 112,355 | 99,882 | 190,368 |

FDR.0p005

| | | | |
|---|---|---|---|
| K562.DS9767 | 113,149 | 256,868 | 378,636 |
| SKnSH.DS8482 | 151,615 | 215,090 | 350,089 |
| TH1.DS7840 | 148,513 | 154,269 | 291,336 |
| GM06990.DS7748 | 147,486 | 123,027 | 251,378 |
| HepG2.DS7764 | 143,699 | 134,673 | 260,449 |

FDR.0p01

| | | | |
|---|---|---|---|
| K562.DS9767 | 127,822 | 299,002 | 441,373 |
| SKnSH.DS8482 | 168,667 | 245,427 | 402,434 |
| TH1.DS7840 | 168,816 | 181,620 | 344,502 |
| GM06990.DS7748 | 165,484 | 144,189 | 295,238 |
| HepG2.DS7764 | 160,117 | 154,117 | 299,820 |

FDR.0p05

| | | | |
|---|---|---|---|
| K562.DS9767 | 167,131 | 420,320 | 622,933 |
| SKnSH.DS8482 | 212,528 | 332,366 | 551,521 |
| TH1.DS7840 | 220,001 | 259,452 | 495,578 |
| GM06990.DS7748 | 211,452 | 205,954 | 419,848 |
| HepG2.DS7764 | 201,733 | 208,721 | 409,667 |

Promoter: TSS + 2 kb upstream only
Distal: >=10 kb from TSS, either direction
Non-promoter: Anything not in promoter definition

Table 6 provides an accounting of DHS vs. Footprint as the average number FPs per DHS:

| Cell-Type | FDR.0p001 | FDR.0p005 | FDR.0p01 | FDR.0p05 |
|---|---|---|---|---|
| K562.DS9767 | 3.5 | 4.0 | 4.2 | 4.7 |
| SKnSH.DS8482 | 3.4 | 3.8 | 4.0 | 4.5 |
| TH1.DS7840 | 3.2 | 3.7 | 3.9 | 4.4 |
| GM06990.DS7748 | 3.2 | 3.6 | 3.8 | 4.2 |
| HepG2.DS7764 | 3.4 | 3.8 | 4.0 | 4.3 |

1. Count DHS's with 1 or more footprints in them
2. Count Footprints that occur in a DHS
3. Calculate average number FPs per DHS using 1.and 2. above

Table 7 sets forth the presence of footprints in DHSs as a function of coverage. When sampling half of the global tags in a cell type, at what DHS tag level do X % of those DHSs have at least 1 fp? Using all global tags and choosing DHSs not chosen in the first step that now achieve the appropriate tag level. Identify the percent of these having at least 1 fp. Tags were looked at in increments of 50. >500 below means 500<x<=550. The percentage in parenthesis indicates the percentage of new peaks at the indicated tag level that have at least 1 footprint. These peaks do not include those identified in the first (half tags) step. single-cell-line peaks were used at the FDR 0.5% level for this analysis.

TABLE 7

| Cell-Type | Threshold | 99th |
|---|---|---|
| GM06990.DS7748 | FDR 0.1% | >400 (97.5%) |
| | FDR 0.5% | >250 (97.7%) |
| | FDR 1% | >250 (98.8%) |
| | FDR 5% | >150 (98.1%) |
| HepG2.DS7764 | FDR 0.1% | >350 (97.5%) |
| | FDR 0.5% | >250 (97.8%) |
| | FDR 1% | >200 (97.2%) |
| | FDR 5% | >150 (97.7%) |
| K562.DS9767 | FDR 0.1% | >300 (98.3%) |
| | FDR 0.5% | >250 (99.0%) |
| | FDR 1% | >200 (98.7%) |
| | FDR 5% | >150 (98.9%) |
| SKnSH.DS8482 | FDR 0.1% | >400 (98.3%) |
| | FDR 0.5% | >250 (98.3%) |
| | FDR 1% | >200 (98.0%) |
| | FDR 5% | >150 (98.6%) |
| TH1.DS7840 | FDR 0.1% | >450 (97.4%) |
| | FDR 0.5% | >300 (98.2%) |
| | FDR 1% | >250 (98.2%) |
| | FDR 5% | >150 (97.2%) |

Table 8 shows the proportion of hotspots having at least 1 footprint. Links show hotspot coordinates with no footprint calls, after FDR thresholding is performed for a deep sequencing strict set of hotspots:

| FDR | TH1 | SKnSH | K562 | HepG2 | GM06990. |
|---|---|---|---|---|---|
| 0p001 | 35% | 40% | 31% | 36% | 31% |
| 0p005 | 40% | 46% | 36% | 41% | 36% |
| 0p01 | 43% | 49% | 39% | 44% | 39% |
| 0p05 | 50% | 57% | 46% | 51% | 46% |

### Example 4

### Murine Cell Lines and Culture Conditions and Preparation of Nuclei and DNase I Digestion

The 3134 cell line was derived by transformation of C127, originally isolated from a mammary adenocacinoma tumor of the RIII mouse. The AtT-20 cell line is an anterior pituitary corticotroph of murine origin (ATCC). Both cell lines were maintained in Dulbecco's Modified Eagle Medium (DMEM) (Invitrogen, Carlsbad, Calif.) supplemented with 10% fetal bovine serum (Gemini, Woodland, Calif.), 2 mM L-glutamine, 1 mM sodium pyruvate, 0.1 mM non-essential amino acids, 5 mg/ml penicillin-streptomycin (Invitrogen, Carlsbad, Calif.) and kept at 37° C. incubator with 5% CO₂. Cells were transferred to 10% charcoal-dextran-treated, heat-inactivated fetal bovine serum for 48 hrs prior to hormone treatment (1 hr with 100 nM dexamethasone).

3134 and AtT-20 cells were grown as described above. 1×10⁸ cells were pelleted and washed with cold phosphate-buffered saline. We resuspended cell pellets in Buffer A (15 mM Tris-Cl (pH 8.0), 15 mM NaCl, 60 mM KCl, 1 mM EDTA (pH 8.0), 0.5 mM EGTA (pH 8.0), 0.5 mM spermidine, 0.15 mM spermine) to a final concentration of 2×10⁶ cells/ml. Nuclei were obtained by dropwise addition of an equal volume of Buffer A containing 0.04% NP-40 to the cells, followed by incubation on ice for 10 min. Nuclei were centrifuged at 1,000 g for 5 min, and then resuspended and washed with 25 ml of cold Buffer A. Nuclei were resuspended in 2 ml of Buffer A at a final concentration of 1×10⁷ nuclei/ml. We performed DNase I (Roche, 10-80 U/ml) digests for 3 min at 37° C. in 2 ml volumes of DNase I buffer (60 mM CaCl₂, 750 mM NaCl). Reactions were terminated by adding an equal volume (2 ml) of stop buffer (1 M Tris-Cl (pH 8.0), 5 M NaCl, 20% SDS, 0.5 M EDTA (pH 8.0), 10 ^{μ}g/ml RNase A, Roche) and incubated at 55° C. After 15 min, we added Proteinase K (25 μg/ml final concentration) to each digest reaction and incubated them overnight at 55° C. After DNase I treatments, careful phenol-chloroform extractions were performed. Control (untreated) samples were processed as above except for the omission of DNase I.

### Example 5

### Illumina Single-End Library Construction for capture with SureSelect Target Enrichment system

Initial DNA preparation: DNase I treated nuclei samples, selected for library construction, can be cleaned with phenol-chloroform and size fractionated in Sucrose Gradient. Select fractions of 100-350 bp. Samples can be cleaned with Microcon 30 (Millipore) and sizes checked with an Agilent 2100 Bioanalyzer). DNA concentrations can be checked with a Qubit fluorometer (Invitrogen).

### End-Repair:

Materials: DNA (0.5-2.0 mg); Water; T4 DNA ligase buffer with 10 mM ATP (NEB #B0202S)dNTP mix, 10 mM each (NEB #N₀₄₄₇₅); T4 DNA polymerase, 3 U/ul (NEB #M0203L); Klenow DNA polymerase, 5 U/ul (NEB #M0210L); T4 PNK, 10 U/ul (NEB #M0201L); QIAquick PCR purification kit. The following reaction mix can be used:

| | | |
|---|---|---|
| DNA | 45 | ul |
| 10× T4 DNA ligase buffer with 10 mM ATP | 10 | ul |
| 10 mM dNTP mix | 4 | ul |
| T4 DNA polymerase | 5 | ul |
| Klenow DNA polymerase | 1 | ul |
| T4 PNK | 5 | ul |
| Water | 30 | ul |
| Total Volume | 100 | ul |

Incubate for 30 min at room temperature and clean up using QIAquick PCR column. Elute in 32 ul of Buffer EB.

### Addition of ‘A’ Bases to the 3′ End of the DNA Fragments:

Materials: DNA from last step; 10× Klenow buffer (use NEB Buffer 2 that comes with Klenow exo⁻); dATP, 1 mM (Fermentas #R0141); Klenow exo⁻ (3′ to 5′ exo minus), 5 U/ul (NEB #M0212L); QIAGEN QIAquick PCR purification kit.

Prepare the following reaction mix as follows:

| | | |
|---|---|---|
| DNA from last step | 32 | ul |
| 10× Klenow buffer | 5 | ul |
| 1 mM dATP | 10 | ul |
| Klenow exo⁻ (3′ to 5′ exo minus) | 3 | ul |
| Total Volume | 50 | ul |

Incubate for 30 min at 37° C. and purify using QIAquick column. Then, elute in 35 ul of Buffer EB.

### Ligation of SE Adaptors to DNA Fragments

Materials: DNA from last step; 2× Quick Ligation buffer (from NEB Quick Ligation kit); SE Adapter oligo mix (from Illumina); Quick T4 DNA ligase (from NEB Quick Ligation kit); QIAquick PCR purification kit; Low-bind tubes (Fisher #13-6987-91)

Prepare the following reaction mix:

| | | |
|---|---|---|
| DNA from last step | 35 | ul |
| 2× DNA ligase buffer | 50 | ul |
| SE Adapter oligo mix | 10 | ul |
| DNA ligase | 5 | ul |
| Total Volume | 100 | ul |

Incubate for 15 min at room temperature and purify using Agencourt AMPure beads. Then, add 180 ul of Agencourt AMPure beads to the sample and incubate for 5 min at room temperature on a rotator. Follow the protocol for purification with Agencourt AMPure beads. Elute in 50 ul of 10 mM Tris pH 8.0

Check DNA library quantity with Qubit fluorometer. A minimum of 500 ng library is required for single hybridization reaction. If more DNA is needed, can amplify prepped library with PCR.

Determination of Optimal Number of PCR Cycles by qPCR

Materials: DNA from last step; PCR grade water; 2× Phusion High-Fidelity PCR Master Mix; SE PCR primer 1.1 (from Illumina); SE PCR primer 2.1 (from Illumina)
1. Set up 20 ul PCR reaction to run on LightCycler 480:

| | | |
|---|---|---|
| DNA from last step (1:8 dilution) | 1 | ul |
| PCR primer 1.1 (1:2 dilution) | 1 | ul |
| PCR primer 2.1 (1;2 dilution) | 1 | ul |
| 2× Phusion HF PCR Master mix | 10 | ul |
| Water | 6 | ul |
| SYBR Green Dye (1:1000 dilution) | 1 | ul |

2. Run the following PCR protocol on LightCycler 480:
   a. 30 s at 98° C.
   b. [10 s at 98° C., 30 s at 65° C., 30 s at 72° C.] for 30 cycles
   c. Cool Down
3. When the run finished, check the cycle number when fluorescence began to plateau.
4. Calculate how many cycles needs to be run with 8/16/32 ul ligated DNA in 80 ul PCR reaction to get to the plateau. The amount of ligated DNA input in PCR depends on how much DNA you need at the end (for single hybridization or for several hybridizations). You can set up one PCR reaction using all ligated DNA or several PCR reactions using divided portions of ligated DNA and then combine all PCR reactions at the end.

### Enrichment of the SE Adaptor-Modified DNA Fragments by PCR

Materials: DNA from ligation step; PCR grade water; Phusion High-Fidelity PCR Master Mix; SE PCR primer 1.1 (from Illumina); SE PCR primer 2.1 (from Illumina)
1. Prepare PCR reaction mix with 8 ul ligated library (as an example):

| | | |
|---|---|---|
| DNA | 8 | ul |
| Phusion DNA polymerase | 40 | ul |
| PCR primer 1.1 | 2 | ul |
| PCR primer 2.1 | 2 | ul |
| Water | 28 | ul |
| Total Volume | 80 | ul |

2. Amplify using the following PCR protocol in MJ PCR cycler:
   30 s at 98° C.
   [10 s at 98° C., 30 s at 65° C., 30 s at 72° C.] for “X” cycles (determined by qPCR and calculated for 8 ul ligated DNA in 80 ul reaction)
   5 min at 72° C.
   Hold at 4° C.
3. Clean up using QIAquick PCR columns and measure DNA concentration using Qubit. A minimum of 500 ng of library is required for single hybridization.
   II. HYBRIDIZATION with SureSelect Target Enrichment System.

Step 1. Hybridize the Library as Follows
1. If prepped library concentration is below 147 ng/μL, use a vacuum concentrator to concentrate the sample.
2. Mix the components at room temperature to prepare the hybridization buffer.

| | | |
|---|---|---|
| SureSelect Hyb #1 | 25 | ul |
| SureSelect Hyb #2(red cap) | 1 | ul |
| SureSelect Hyb #3(yellow cap) | 10 | ul |
| SureSelect Hyb #4 | 13 | ul |
| Total | 49 | ul |

3. If precipitate forms, warm the hybridization buffer at 65° C. for 5 minutes.
4. Load 40 μL, of hybridization buffer per well into the “A” row of the PCR plate.
5. In a PCR plate, prepare prepped library for target enrichment:
   A Adjust prepped library concentration to 500 ng in 3.4 μL, and add this to the “B” row in the PCR plate. Place each sample into a separate well.
   B Add 2.5 μL, of SureSelect Block #1 (green cap) to row B.
   C Add 2.5 μL of SureSelect Block #2 (blue cap) to row B.
   D Add 0.6 μL of SureSelect Block #3 (brown cap) to row B.
   E Mix by pipetting.
   F Seal the wells of rows “A” and “B” with caps and place the PCR plate in the thermocycler.
   G Run the following thermocycler program in Table 16.
   H Incubate the prepped library and blockers at 95° C. for 5 minutes.
   I Use a heated lid on the thermocycler at 105° C. to hold the temperature of the plate on the thermocycler at 65° C.
Make sure that the plate is at 65° C. for a minimum of 5 minutes before you get to step 7.

PCR Program

| Step | Temperature | Time |
|---|---|---|
| Step 1 | 95 C. | 5 min |
| Step 2 | 65 C. | forever |

6. In a separate PCR plate, strip tubes, or tubes, prepare SureSelect Oligo Capture Library Mix for target enrichment:
   A Add 5 μL, of SureSelect Oligo Capture Library.
   B Add 1 μL of nuclease-free water to the Capture Library.
   C Use nuclease-free water to prepare a 1:1 dilution of the RNase Block (purple cap).
   D Add 1 μL of diluted RNase Block to each Capture Library, and mix by pipetting.
   E Add the Capture Library mix to the “C” row in the PCR plate.
   F For multiple samples, use a multi-channel pipette to load the Capture Library samples into the “C” row in the PCR plate (see FIG. 7 for positions). Keep the plate at 65° C. during this time.
   G Seal the wells with strip caps. Use a capping tool to make sure the fit is tight.
   H Incubate the samples at 65° C. for 2 minutes.
7. Maintain the plate at 65° C. while you use a multi-channel pipette to add 7 μL of each prepped library mix in row “B” to the hybridization solution in row “C”. Mix well by pipetting up and down 8 to 10 times.
8. Maintain the plate at 65° C. while you use a multi-channel pipette to take 13 μL of Hybridization Buffer from . the “A” row and add it to the SureSelect Capture Library Mix contained in row “C” of the PCR plate for each sample.
9. Maintain the plate at 65° C. while you use a multi-channel pipette to add 7 μL of each prepped library mix in row “B” to the hybridization solution in row “C”. Mix well by pipetting up and down 8 to 10 times.
10. Seal the wells with strip caps. Make sure all wells are completely sealed. The hybridization mixture is now 27 μL.
11. Incubate the hybridization mixture for 24 hours at 65° C. with a heated lid at 105° C.

Step 2. Prepare magnetic beads as follows: Prewarm SureSelect Wash Buffer #2 at 65° C. in a circulating water bath for use in “Step 3. Select hybrid capture with SureSelect”. Vigorously resuspend the Dynal (Invitrogen) magnetic beads on a vortex mixer. Dynal beads settle during storage. For each hybridization, add 50 μL Dynal magnetic beads to a 1.5 mL microfuge tube. Wash the beads as follows: by adding 200 μL SureSelect Binding buffer, mixing the beads on a vortex mixer for 5 seconds., putting the tubes into a magnetic device, such as the Dynal magnetic separator (Invitrogen), removing and discarding the supernatant, repeating the wash steps for a total of 3 washes. Then resuspend the beads in 200 μL of SureSelect Binding buffer.

Step 3. Select Hybrid Capture with SureSelect as Follows:

Add the hybridization mixture directly from the thermocycler to the bead solution, and invert the tube to mix 3 to 5 times; incubate the hybrid-capture/bead solution on a Nutator for 30 minutes at room temperature. Make sure the sample is properly mixing in the tube. Separate the beads and buffer on a Dynal magnetic separator and remove the supernatant. Resuspend the beads in 500 μL, SureSelect Wash Buffer #1 bp mixing on a vortex mixer for 5 seconds. Incubate the samples for 15 minutes at room temperature. Wash the beads as follows:
A Separate the beads and buffer on a Dynal magnetic separator and remove the supernatant.
B Mix the beads in prewarmed 500 μL, SureSelect Wash Buffer #2 on a vortex mixer for 5 seconds to resuspend the beads.
C Incubate the samples for 10 minutes at 65° C.
D Invert the tube to mix. (The beads may have settled.)
E Repeat entire step a through step d for a total of 3 washes. Make sure all of the wash buffer has been removed.
   Then, mix the beads in 50 μL, SureSelect Elution Buffer on a vortex mixer for 5 seconds to resuspend the beads, incubate the samples for 10 minutes at room temperature, separate the beads and buffer on a Dynal magnetic separator, use a pipette to move the supernatant to a new 1.5 mL microcentrifuge tube, and add 50 μL, of SureSelect Neutralization Buffer.

### Step 4. Desalt Capture Solution

Allow the MinElute columns (stored at 4° C.) to come to room temperature. Add 500 μL, of PB to the sample and mix well by pipetting. If pH indicator I was added to the PB buffer, check for the yellow color to make sure buffer PB pH is correct. Place a MinElute spin column in a 2 mL collection tube. Transfer the 600 μL sample to the MinElute column. Spin the sample in a centrifuge for 60 seconds at 17,900×g (13,000 rpm). Discard the flow-through. Add 750 μL, of buffer PE to the column. Spin the sample in a centrifuge for 60 seconds at 17,900×g (13,000 rpm). Discard the flow-through. Place the MinElute column back in the 2 mL collection tube and spin in a centrifuge for 60 seconds at 17,900×g (13,000 rpm). Transfer the MinElute column to a new 1.5 mL collection tube to elute the cleaned sample. Add 34 μL, buffer EB directly onto the MinElute filter membrane. Wait 60 seconds, then spin in a centrifuge for 60 seconds at 17,900×g (13,000 rpm). Collect the eluate (captured library), which can be stored at −20° C. In this step you desalt the capture solution with a Qiagen minElute PCR purification column.

### III. Post-Hybridization Amplification

Determination of Optimal Number of PCR Cycles by qPCR

Materials: DNA from last step; PCR grade water; Phusion High-Fidelity PCR Master Mix; SE PCR primer 1.1 (from Illumina); SE PCR primer 2.1 (from Illumina). Set up 20 ul PCR reaction to run on LightCycler 480:

| | | |
|---|---|---|
| DNA from last step (1:8 dilution) | 1 | ul |
| PCR primer 1.1 (1:4 dilution) | 1 | ul |
| PCR primer 2.1 (1;4 dilution) | 1 | ul |
| 2× Phusion HF PCR Master mix | 10 | ul |
| Water | 6 | ul |
| SYBR Green Dye (1:1000 dilution) | 1 | ul |

Run the following PCR protocol on LightCycler 480: 30 s at 98° C.-[10 s at 98° C., 30 s at 65° C., 30 s at 72° C.] for 30 cycles-Cool Down. When the run finished, check the cycle number when fluorescence began to plateau. Calculate how many cycles needs to be run with 32 ul eluted and concentrated DNA in 80 ul PCR reaction to get to the plateau.

### Full Size PCR Amplification.

Materials: DNA from elution/concentration step; PCR grade water; 2× Phusion High-Fidelity PCR Master Mix; SE PCR primer 1.1 (from Illumina); SE PCR primer 2.1 (from Illumina). Prepare PCR reaction mix:

| | | |
|---|---|---|
| DNA | 32 | ul |
| 2× Phusion HF PCR Master Mix | 40 | ul |
| PCR primer 1.1 | 1 | ul |
| PCR primer 2.1 | 1 | ul |
| Water | 6 | ul |
| Total Volume | 80 | ul |

Amplify using the following PCR protocol in MJ PCR cycler: 30 s at 98° C.-[10 s at 98° C., 30 s at 65° C., 30 s at 72° C.] for “X” cycles (determined by qPCR)-5 min at 72° C.-Hold at 4° C. Then, clean up using MiniElute PCR column and measure the DNA concentration using Qubit before sequencing on Illumina instrument.

Regarding the solution hybridization procedures, these can also be found in the Agilent SureSelect user's guide entitled SureSelect Target Enrichment System Illumina Single-End Sequencing Platform Library Prep Protocol Version 1.2, April 2009

### LIST OF REFERENCES

1. Maniatis, T. & Ptashne, M. Structure of the lambda operators. Nature 246, 133-6 (1973).
2. Gilbert, W. in Polymerization in Biological Systems 245-259 (Elsevier, North-Holland, Amsterdam, 1972).
3. Galas, D. J. & Schmitz, A. DNAse footprinting: a simple method for the detection of protein-DNA binding specificity. Nucleic Acids Res 5, 3157-70 (1978).
4. Ren, B. et al. Genome-wide location and function of DNA binding proteins. Science 290, 2306-9 (2000).
5. Johnson, D. S., Mortazavi, A., Myers, R. M. & Wold, B. Genome-wide mapping of in vivo protein-DNA interactions. Science 316, 1497-502 (2007).
6. Wei, C. L. et al. A global map of p53 transcription-factor binding sites in the human genome. Cell 124, 207-19 (2006).
7. Gross, D. S. & Garrard, W. T. Nuclease hypersensitive sites in chromatin. Annu Rev Biochem 57, 159-97 (1988).
8. Sabo, P. J. et al. Genome-scale mapping of DNase I sensitivity in vivo using tiling DNA microarrays. Nat Methods 3, 511-8 (2006).
9. Bailey, T. L. & Elkan, C. Fitting a mixture model by expectation maximization to discover motifs in biopolymers. Proc Int Conf Intell Syst Mol Biol 2, 28-36 (1994).
10. MacIsaac, K. D. et al. An improved map of conserved regulatory sites for Saccharomyces cerevisiae. BMC Bioinformatics 7, 113 (2006).
11. Siepel, A. et al. Evolutionarily conserved elements in vertebrate, insect, worm, and yeast genomes. Genome Res 15, 1034-50 (2005).
12. Harbison, C. T. et al. Transcriptional regulatory code of a eukaryotic genome. Nature 431, 99-104 (2004).
13. Berger, M. F. et al. Compact, universal DNA microarrays to comprehensively determine transcription-factor binding site specificities. Nat Biotechnol 24, 1429-35 (2006).
14. Cliften, P. et al. Finding functional features in Saccharomyces genomes by phylogenetic footprinting. Science 301, 71-6 (2003).
15. Kellis, M., Patterson, N., Endrizzi, M., Birren, B. & Lander, E. S. Sequencing and comparison of yeast species to identify genes and regulatory elements. Nature 423, 241-54 (2003).
16. Borneman, A. R. et al. Divergence of transcription factor binding sites across related yeast species. Science 317, 815-9 (2007).
17. Tan, S. & Richmond, T. J. Crystal structure of the yeast MATalpha2/MCM1/DNA ternary complex. Nature 391, 660-6 (1998).
18. Ferre-D'Amare, A. R., Pognonec, P., Roeder, R. G. & Burley, S. K. Structure and function of the b/HLH/Z domain of USF. Embo J 13, 180-9 (1994).
19. Acton, T. B., Zhong, H. & Vershon, A. K. DNA-binding specificity of Mcm1: operator mutations that alter DNA-bending and transcriptional activities by a MADS box protein. Mol Cell Biol 17, 1881-9 (1997).
20. Wang, K. L. & Warner, J. R. Positive and negative autoregulation of REB1 transcription in Saccharomyces cerevisiae. Mol Cell Biol 18, 4368-76 (1998).
21. Planta, R. J., Goncalves, P. M. & Mager, W. H. Global regulators of ribosome biosynthesis in yeast. Biochem Cell Biol 73, 825-34 (1995).
22. Boeger, H., Griesenbeck, J. & Kornberg, R. D. Nucleosome retention and the stochastic nature of promoter chromatin remodeling for transcription. Cell 133, 716-26 (2008).
23. Mavrich, T. N. et al. A barrier nucleosome model for statistical positioning of nucleosomes throughout the yeast genome. Genome Res 18, 1073-83 (2008).
24. Lee, W. et al. A high-resolution atlas of nucleosome occupancy in yeast. Nat Genet. 39, 1235-44 (2007).
25. Shivaswamy, S. et al. Dynamic remodeling of individual nucleosomes across a eukaryotic genome in response to transcriptional perturbation. PLoS Biol 6, e65 (2008).
26. Yuan, G. C. et al. Genome-scale identification of nucleosome positions in S. cerevisiae. Science 309, 626-30 (2005).
27. Raisner, R. M. et al. H1stone variant H2A.Z marks the 5′ ends of both active and inactive genes in euchromatin. Cell 123, 233-48 (2005).
28. Jakobsen, B. K. & Pelham, H. R. Constitutive binding of yeast heat shock factor to DNA in vivo. Mol Cell Biol 8, 5040-2 (1988).
29. Strauss, E. C. & Orkin, S. H. In vivo protein-DNA interactions at hypersensitive site 3 of the human beta-globin locus control region. Proc Natl Acad Sci USA 89, 5809-13 (1992).
30. David, L. et al. A high-resolution map of transcription in the yeast genome. Proc Natl Acad Sci USA 103, 5320-5 (2006).

All patents, patent applications, and other publications, including GenBank Accession Numbers, cited in this application are incorporated by reference in the entirety for all purposes.

1. A method for determining a protein-binding pattern of a genomic DNA of known sequence, comprising: (1) digesting the genomic DNA in the presence of its binding proteins with a DNA-cleaving agent to generate a plurality of DNA fragments; (2) determining the nucleotide sequence of at least some of the plurality of DNA fragments, the nucleotides at the ends of the DNA fragments indicating the DNA cleavage sites in the genomic DNA; and (3) determining the frequency of DNA cleavage throughout the length of the genomic DNA sequence, a segment of the genomic DNA sequence having lower than average frequency indicating a protein-binding site, thereby determining the protein-binding pattern of the genomic DNA.

2. The method of claim 1, wherein the DNA-cleaving agent is a nuclease.

3. The method of claim 2, wherein the nuclease is a DNase.

4. (canceled)

5. The method of claim 1, wherein the genomic DNA is the entire genome of a species.

6. The method of claim 1, wherein the genomic DNA is human genomic DNA.

7. (canceled)

8. The method of claim 1, wherein step (1) is carried out by digesting the nucleus of a cell.

9. The method of claim 1, wherein step (1) is carried out by digesting an entire cell.

10. The method of claim 1, wherein a segment of the genomic DNA sequence having lower than average frequency and having higher than average frequency in its immediate flanking regions indicates a protein-binding site.

11. The method of claim 1, wherein the plurality of DNA fragments are no more than 500 nucleotides in length.

12. (canceled)

13. The method of claim 1, wherein the segment of the genomic DNA is 50 nucleotides in length.

14. The method of claim 1, wherein the plurality of DNA fragments comprises at least 10⁷ fragments.

15. The method of claim 14, wherein the nucleotide sequence of at least 10⁶ fragments is determined in step (2).

16. (canceled)

17. The method of claim 1 wherein the genomic protein:DNA contacts for a protein are determined.

18. The method of claim 1, wherein a regulatory factor signature is determined.

19. A method for identifying a structural class of a regulatory factor, the method comprising:
determining a footprint signature for the regulatory factor and
comparing the footprint signature of the regulatory factor to one or more archetype signatures, thereby identifying the structural class of the regulatory factor,
wherein the footprint signature and archetype signatures are determined using the steps of: (1) digesting a genomic DNA in the presence of its binding proteins with a DNA-cleaving agent to generate a plurality of DNA fragments; (2) determining the nucleotide sequence of at least some of the plurality of DNA fragments, the nucleotides at the ends of the DNA fragments indicating the DNA cleavage sites in the genomic DNA; and (3) determining the frequency of DNA cleavage throughout the length of the genomic DNA sequence, a segment of the genomic DNA sequence having lower than average frequency indicating a protein-binding site that is the footprint signature or an archetype signature, thereby determining the footprint signature or archetype signatures.

20. The method of claim 1, wherein the genome comprises the locus of a gene and all the regulatory factor footprints within an entire locus are identified.

21. The method of claim 1, wherein the genome comprises a functional genetic variation within the nucleic acid sequence of a regulatory factor footprint and the variation is identified according to an altered occupancy of the footprint by the regulatory factor.

22. (canceled)

23. The method of claim 1, wherein the footprint of the binding site is determined.

24. A computer program product comprising a computer readable medium encoded with a plurality of instructions for controlling a computing system to perform an operation for determining protein-binding pattern of a genomic DNA of known sequence, the operation comprising the steps of: receiving data from sequencing reactions a plurality of DNA fragments generated from DNase digestion of the genomic DNA in the presence of its binding proteins, wherein the data comprise the identity of all nucleotides in at least some of the plurality of DNA fragments; locating the first and last nucleotide of each DNA fragment sequenced in the genomic DNA sequence; and calculating the frequency of the first or last nucleotide appearing in consecutive segments of the genomic DNA sequence, thereby deriving a map of protein-binding for the genomic DNA.

25. A microarray comprising a plurality of DNA sequences immobilized on a solid support, each of the plurality of DNA sequences comprising the nucleotide sequence of a unique protein-binding site in a genomic DNA as determined by the method of claim 1.


SEQUENCE LISTING (50 sequences)

SEQ ID NO: 1 - DNA, 10 bp, Artificial Sequence
  synthetic motif for yeast regulatory factor Rap1
aacccaaaca

SEQ ID NO: 2 - DNA, 10 bp, Artificial Sequence
  synthetic motif for yeast regulatory factor Reb1
tattacccgg

SEQ ID NO: 3 - DNA, 13 bp, Artificial Sequence
  synthetic motif for yeast regulatory factor Abf1
cgtatttagtgat

SEQ ID NO: 4 - DNA, 17 bp, Artificial Sequence
  synthetic motif for yeast regulatory factors Abf1 and Rap1
aatcattgtgtacggat

SEQ ID NO: 5 - DNA, 10 bp, Artificial Sequence
  synthetic motif for yeast regulatory factor Cbf1
agatcacgtg

SEQ ID NO: 6 - DNA, 11 bp, Artificial Sequence
  synthetic footprint-derived motif for Reb1
tgttacccgga

SEQ ID NO: 7 - DNA, 11 bp, Artificial Sequence
  synthetic chromatin immunoprecipitation (ChIP)-derived motif for Rap1
gtgtgtgggtg

SEQ ID NO: 8 - DNA, 12 bp, Artificial Sequence
  synthetic footprint-derived motif for Rap1
gatgtatgggtg

SEQ ID NO: 9 - DNA, 13 bp, Artificial Sequence
  synthetic chromatin immunoprecipitation (ChIP)-derived motif for Abf1
cgtnnanagtgat

SEQ ID NO: 10 - DNA, 14 bp, Artificial Sequence
  synthetic footprint-derived motif for Abf1
cgtgcaaagtgata

SEQ ID NO: 11 - DNA, 14 bp, Artificial Sequence
  synthetic chromatin immunoprecipitation (ChIP)-derived motif for Hsf1
ggaatnttctagaa

SEQ ID NO: 12 - DNA, 20 bp, Artificial Sequence
  synthetic footprint-derived motif for Hsf1
ttctagaacnttctagaaaa

SEQ ID NO: 13 - DNA, 15 bp, Artificial Sequence
  synthetic footprint-derived DNA recognition site motif for Mcm1
ttccnaaaanggaaa

SEQ ID NO: 14 - DNA, 11 bp, Artificial Sequence
  synthetic footprint-derived motif for Cbf1 human homolog
gatcacgtgac

SEQ ID NO: 15 - DNA, 10 bp, Artificial Sequence
  synthetic footprint-derived corrected motif for Reb1
ttacccggga

SEQ ID NO: 16 - DNA, 14 bp, Artificial Sequence
  synthetic known regulatory motif for NF1 in DNaseI hotspot footprint
ctggnnnnnngcca

SEQ ID NO: 17 - DNA, 12 bp, Artificial Sequence
  synthetic known regulatory motif for CTCF in DNaseI hotspot footprint
ccannagnnggc

SEQ ID NO: 18 - DNA, 10 bp, Artificial Sequence
  synthetic novel regulatory motif in DNaseI hotspot footprint
ccanncccag

SEQ ID NO: 19 - DNA, 10 bp, Artificial Sequence
  synthetic novel regulatory motif in DNaseI hotspot footprint
cagnncctgg

SEQ ID NO: 20 - DNA, 15 bp, Artificial Sequence
  synthetic novel regulatory motif in DNaseI hotspot footprint
agncacnnnnccnng

SEQ ID NO: 21 - DNA, 10 bp, Artificial Sequence
  synthetic SKnSH (neuronal) cell-type specific RP58 regulatory factor footprint
tccagatgtt

SEQ ID NO: 22 - DNA, 15 bp, Artificial Sequence
  synthetic SKnSH (neuronal) cell-type specific ZNF589 regulatory factor footprint
ccagggtatcagcng

SEQ ID NO: 23 - DNA, 10 bp, Artificial Sequence
  synthetic SKnSH (neuronal) cell-type specific LHX3 regulatory factor footprint
ttaattaatt

SEQ ID NO: 24 - DNA, 14 bp, Artificial Sequence
  synthetic SKnSH (neuronal) cell-type specific PAX6 regulatory factor footprint
gagttccaggtcag

SEQ ID NO: 25 - DNA, 10 bp, Artificial Sequence
  synthetic SKnSH (neuronal) cell-type specific HAND1E47 regulatory factor footprint
gngtctggca

SEQ ID NO: 26 - DNA, 12 bp, Artificial Sequence
  synthetic HepG2 (liver) cell-type specific HNF4 regulatory factor footprint
ggncaaagttca

SEQ ID NO: 27 - DNA, 17 bp, Artificial Sequence
  synthetic HepG2 (liver) cell-type specific PPARG regulatory factor footprint
aggggtcaaaggtcatc

SEQ ID NO: 28 - DNA, 10 bp, Artificial Sequence
  synthetic HepG2 (liver) cell-type specific HNF3 regulatory factor footprint
aaaacaaaca

SEQ ID NO: 29 - DNA, 11 bp, Artificial Sequence
  synthetic HepG2 (liver) cell-type specific FREAC3 regulatory factor footprint
tgtttatttac

SEQ ID NO: 30 - DNA, 13 bp, Artificial Sequence
  synthetic HepG2 (liver) cell-type specific FOXJ2 regulatory factor footprint
aaaatattattat

SEQ ID NO: 31 - DNA, 14 bp, Artificial Sequence
  synthetic binding motif for CTCF
ccgctagggggcag

SEQ ID NO: 32 - DNA, 16 bp, Artificial Sequence
  synthetic 8-mer target sequence with intervening N′s
ancngntnannnncgt

SEQ ID NO: 33 - DNA, 14 bp, Artificial Sequence
  synthetic footprint-derived motif-6 transcription factor ABF1 consensus from chromatin immunoprecipitation (ChIP) data
cgtataaagtgata

SEQ ID NO: 34 - DNA, 15 bp, Artificial Sequence
  synthetic footprint-derived motif-4 transcription factor SFP1 consensus from chromatin immunoprecipitation (ChIP) data
tcgtgcatagtgata

SEQ ID NO: 35 - DNA, 12 bp, Artificial Sequence
  synthetic footprint-derived motif-4 transcription factor SFP1 and RAP1 consensus from chromatin immunoprecipitation (ChIP) data
gatgtatgggtg

SEQ ID NO: 36 - DNA, 10 bp, Artificial Sequence
  synthetic footprint-derived motif-4 transcription factor SFP1 consensus from footprint data
atgtacgggt

SEQ ID NO: 37 - DNA, 12 bp, Artificial Sequence
  synthetic footprint-derived motif-4 transcription factor RAP1 consensus from footprint data
gtgtatgggtgt

SEQ ID NO: 38 - DNA, 15 bp, Artificial Sequence
  synthetic footprint-derived motif-7 transcription factor MCM1 consensus from chromatin immunoprecipitation (ChIP) data
ttcccaaaaaggaaa

SEQ ID NO: 39 - DNA, 16 bp, Artificial Sequence
  synthetic footprint-derived motif-7 transcription factor MCM1 consensus from footprint data
tttcccaatcgggaaa

SEQ ID NO: 40 - DNA, 20 bp, Artificial Sequence
  synthetic footprint-derived motif-10 transcription factor HSF1 consensus from chromatin immunoprecipitation (ChIP) data
ttttctagaatgttctagaa

SEQ ID NO: 41 - DNA, 14 bp, Artificial Sequence
  synthetic footprint-derived motif-10 transcription factor HSF1 consensus from footprint data
ttctagaacgttcc

SEQ ID NO: 42 - DNA, 11 bp, Artificial Sequence
  synthetic footprint-derived motif-2 transcription factor REB1 consensus from chromatin immunoprecipitation (ChIP) data
tgttacccgga

SEQ ID NO: 43 - DNA, 12 bp, Artificial Sequence
  synthetic footprint-derived motif-4 transcription factor FHL1 consensus from chromatin immunoprecipitation (ChIP) data
gatgtatgggtg

SEQ ID NO: 44 - DNA, 10 bp, Artificial Sequence
  synthetic footprint-derived motif-4 transcription factor FHL1 consensus from footprint data
atgtacgggt

SEQ ID NO: 45 - DNA, 15 bp, Artificial Sequence
  synthetic footprint-derived motif-7 transcription factor YOX1 consensus from chromatin immunoprecipitation (ChIP) data
ttcccaaaaaggaaa

SEQ ID NO: 46 - DNA, 20 bp, Artificial Sequence
  synthetic footprint-derived motif-7 transcription factor YOX1 consensus from footprint data
cattacgtttcctaaaaggg

SEQ ID NO: 47 - DNA, 11 bp, Artificial Sequence
  synthetic footprint-derived motif-26 transcription factor CBF1 consensus from chromatin immunoprecipitation (ChIP) data
gatcacgtgac

SEQ ID NO: 48 - DNA, 11 bp, Artificial Sequence
  synthetic footprint-derived motif-18 transcription factor PDR3 consensus from chromatin immunoprecipitation (ChIP) data
tttccgcggaa

SEQ ID NO: 49 - DNA, 11 bp, Artificial Sequence
  synthetic footprint-derived motif-16 transcription factor UME6 consensus from chromatin immunoprecipitation (ChIP) data
agccgccgaag

SEQ ID NO: 50 - DNA, 10 bp, Artificial Sequence
  synthetic footprint-derived motif-16 transcription factor UME6 consensus from footprint data
tagccgccga